(19) United States
(12) Patent Application Publication
(10) Pub. No.: US 2024/0419902 A1
(43) Pub. Date: Dec. 19, 2024

(54) USING LARGE LANGUAGE MODELS TO UPDATE DATA IN MAPPING SYSTEMS AND APPLICATIONS

(71) Applicant: Nvidia Corporation, Santa Clara, CA (US)

(72) Inventors: Shuang Wu, Fremont, CA (US); Denis Laprise, Palo Alto, CA (US); Mark Wheeler, Saratoga, CA (US)

(21) Appl. No.: 18/417,105

(22) Filed: Jan. 19, 2024

Related U.S. Application Data
(60) Provisional application No. 63/521,627, filed on Jun. 16, 2023.

(51) Int. Cl. G06F 40/284; G01C 21/00

(52) U.S. Cl. CPC G06F 40/284; G01C 21/3859

(57) ABSTRACT

Approaches presented herein provide for the identification of differences between local map data, for a region of a physical environment, and observation or perception data generated by one or more machines or other such sources. In at least one embodiment, sensors on an ego machine can capture sensor data for a region in which the ego machine is located, and a language model on the ego machine can compare this sensor data, or perception data generated using the sensor data, against the local map data. The language model can generate a tokenized description of identified differences, in a domain-specific language. The tokenized description can be transmitted to a map management service that can compare these differences against differences identified by other machines, for example, to determine whether to update and redistribute at least a portion of the map data.

### CROSS-REFERENCE TO RELATED APPLICATIONS

This application claims priority to and the benefit of U.S. Provisional Patent Application No. 63/521,627, filed Jun. 16, 2023, entitled “USING LANGUAGE MODELS FOR MAPPING IN AUTONOMOUS SYSTEMS AND APPLICATIONS,” the full disclosure of which is hereby incorporated in its entirety for all purposes.

### BACKGROUND

There are various operations—such as may relate to autonomous or semi-autonomous navigation and robotic simulation—where it can be desirable to generate or reconstruct a realistic digital and/or virtual environment that complies with real-world rules and constraints. As an example, maps—such as high definition (HD) maps—are widely relied upon for semi-autonomous and autonomous operations. Autonomous and semi-autonomous vehicles and machines may rely on these maps, as well as real time sensor data, for navigation, localization, path or route planning, and/or other operations. In order to ensure that the maps are accurate and updated to account for any changes, map management systems can collect data captured by sensors of various vehicles driving along various routes and can analyze that data to attempt to determine whether a change to the map data might be warranted. Such a process is typically time consuming and complicated, as different vehicles can provide data in different formats, of different types, and/or with different accuracies, precisions, or confidence levels. This can result in the map data taking a sufficiently long time to update, which may be undesirable for operations such as autonomous vehicle navigation. Further, such an approach can require the collection and processing of a significant amount of high-precision data, which can be expensive in terms of computing and network resources.

### BRIEF DESCRIPTION OF THE DRAWINGS

Various embodiments in accordance with the present disclosure will be described with reference to the drawings, in which:

FIG. 1 illustrates example data produced at stages of an environment reconstruction process, according to at least one embodiment;

FIGS. 2A and 2B illustrates an example environment reconstruction pipeline, along with an example tokenized description generated using such a pipeline, according to at least one embodiment;

FIG. 3A illustrates an example pipeline for generating a tokenized description of differences identified between sensor data and map data for at least a portion of an environment, and determining whether to update the map data based in part on those differences, according to at least one embodiment;

FIG. 3B illustrates an example set of components of a machine for identifying differences between local map and perception data, according to at least one embodiment;

FIG. 3C illustrates an example set of components of a machine for identifying differences between local map and sensor data using a trained language model, according to at least one embodiment;

FIG. 3D illustrates an example network-based system to determine whether to update map data based in part upon difference information received from multiple machines, according to at least one embodiment;

FIG. 4A illustrates an example process for generating tokenized descriptions for differences identified between local map data and perception data, according to at least one embodiment;

FIG. 4B illustrates an example process for generating tokenized descriptions for differences identified between local map data and a set of observations using a trained language model, according to at least one embodiment;

FIG. 4C illustrates an example process to determine whether to update map data based in part upon differences identified by multiple machines or other such sources, according to at least one embodiment;

FIG. 5A illustrates an example map graph, according to at least one embodiment;

FIG. 5B illustrates an example landmark analysis system, according to at least one embodiment;

FIG. 5C illustrates an example tokenized text string, according to at least one embodiment;

FIG. 5D illustrates an example lane graph, according to at least one embodiment;

FIG. 5E illustrates an example architecture for determining an output state, according to at least one embodiment;

FIG. 5F illustrates an example image of an intersection in an example map, according to at least one embodiment;

FIG. 5G illustrates an example process for generating a text string representation of an environment, according to at least one embodiment;

FIG. 5H illustrates an example process for generating a tokenized text string representation of a physical environment, according to at least one embodiment

FIG. 6 illustrates components of a distributed system that can be used to update map data based in part on a tokenized description generated for an environment, according to at least one embodiment;

FIG. 7A illustrates inference and/or training logic, according to at least one embodiment;

FIG. 7B illustrates inference and/or training logic, according to at least one embodiment;

FIG. 8 illustrates an example data center system, according to at least one embodiment;

FIG. 9 illustrates a computer system, according to at least one embodiment;

FIG. 10 illustrates a computer system, according to at least one embodiment;

FIG. 11 illustrates at least portions of a graphics processor, according to one or more embodiments;

FIG. 12 illustrates at least portions of a graphics processor, according to one or more embodiments;

FIG. 13 is an example data flow diagram for an advanced computing pipeline, in accordance with at least one embodiment;

FIG. 14 is a system diagram for an example system for training, adapting, instantiating and deploying machine learning models in an advanced computing pipeline, in accordance with at least one embodiment;

FIGS. 15A and 15B illustrate a data flow diagram for a process to train a machine learning model, as well as client-server architecture to enhance annotation tools with pre-trained annotation models, in accordance with at least one embodiment;

FIG. 16A illustrates an example of an autonomous vehicle, according to at least one embodiment;

FIG. 16B illustrates an example of camera locations and fields of view for the autonomous vehicle of FIG. 16A, according to at least one embodiment;

FIG. 16C is a block diagram illustrating an example system architecture for the autonomous vehicle of FIG. 16A, according to at least one embodiment; and

FIG. 16D is a diagram illustrating a system for communication between cloud-based server(s) and the autonomous vehicle of FIG. 16A, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles or machines, semi-autonomous or autonomous vehicles or machines (e.g., in one or more advanced driver assistance systems (ADAS), one or more in-vehicle infotainment systems, one or more emergency vehicle detection systems), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, generative Al, model training or updating, perception, augmented reality, virtual reality, mixed reality, robotics, security and surveillance, simulation and digital twinning, autonomous or semi-autonomous machine applications, deep learning, environment simulation, data center processing, conversational Al, light transport simulation (e.g., ray-tracing, path tracing, etc.), collaborative content creation for 3D assets, generative Al, cloud computing, and/or any other suitable applications.

Disclosed embodiments may be comprised in a variety of different systems such as automotive systems (e.g., an in-vehicle infotainment system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational Al operations, systems implementing one or more language models—such as large language models (LLMs), systems for performing generative Al operations (e.g., using one or more language models), systems for performing light transport simulation, systems for performing collaborative content creation for 3D assets, systems implemented at least partially using cloud computing resources, and/or other types of systems.

Approaches in accordance with various illustrative embodiments provide for the generation of tokenized representations of one or more regions or domains within a physical environment. In particular, various embodiments can use a large language model (LLM), or other generative artificial intelligence (AI)-based approach, to generate a tokenized description (or other text-based representation) of a region or domain. A language model can be trained to represent a region based on not only low-level primitives determinable from captured sensor data, for example, but also aspects such as the semantics, topology, and geometry related to those primitives, as well as the relationships between objects determinable using those primitives. These tokenized representations can correspond to, or be used to generate, feature vectors, embeddings, or points in a latent space, among other such options, representative of the respective regions or domains. The feature vectors in aggregate can be used to represent an entire environment or set of regions.

In at least one embodiment, a language model can be used to identify differences between the local map data, for a region of a physical environment, and observation or perception data obtained for the region, such as may be obtained or generated in real time by an ego machine (such as an ego vehicle). A set of observations can be obtained for an environment, where those observations may correspond to sensor data captured by one or more sensors of similar or different types. In at least one embodiment, the observations can be analyzed by a perception module to generate a set of perception data, where the perception data may relate to objects identified in the environment, as well as determined or inferred aspects of those objects. A current and/or reference location in the environment can also be determined, which can be used to identify local map data relevant to that location. The localized mapping data can be analyzed together with the observations (e.g., sensor data or perception data) so that corresponding objects or features in the map data and observations are identified and correlated. A trained language model can analyze the objects and/or features (e.g., embeddings or feature vectors) in the map data and observation data to attempt to identify differences that may warrant updates to the map data. This may include identifying any or all such differences, or differences that satisfy at least one selection criterion, among other such options. A language model can attempt to generate a single, fused representation of the environment based at least in part on the map data and the perception data, where that representation or another tokenized representation can include tokens that include information about the identified differences. The model can use its domain-specific learning, as well as semantic, relationship, topology, geometry, and other information provided with, or determinable from, the map and perception data, to attempt to infer a consistent representation of the environment and then identify differences or inconsistencies in that representation. The tokenized description of at least the identified differences can correspond to a string of text-based tokens written in a domain-specific language. The tokenized description can be a compact and discrete representation of the environment, which is lightweight enough to be processed in real time or near real time but robust enough to include the necessary information for making decisions relevant to the target operation(s). The compactness of the tokenized description can be improved in at least one embodiment by training the language model to generate tokens only differences for those objects, or relevant aspects of those objects, that are determined to be important for a given task, operation, or domain. The ability to infer a consistent representation from map and perception data allows for useful tokenized descriptions to be generated even where the map and/or perception data may be unavailable, incomplete, inaccurate, or otherwise unreliable. In at least one embodiment, tokenized differences identified by multiple machines (e.g., vehicles or other such sources) can be transmitted to a map management service or other such recipient, which may be hosted across at least one network, as may use a set of cloud-based resources. The map management service can attempt to aggregate and correlate this difference data, and attempt to come to a consensus, with at least a minimum level of confidence, as to whether one or more updates should be performed with respect to the map data. If an update is to be performed, that update can be performed and then the updated map data, or information about the updates to the map, can be propagated or otherwise made available to at least the relevant machines or other such recipients.

The updates or updated map data may also be provided using at least one tokenized representation, which may be in the same domain-specific language relevant to a specific type of operation.

In at least one embodiment, a language model can be used to generate representations of operational design domains (ODDs)—such as intersections—using a tokenized representation, written in a language such as Road Topology Language (RTL). An embedding can be generated for each such ODD, allowing each ODD to be represented by, for example, a point in an n-dimensional latent space. Similar ODDs, such as similar intersections, will have similar embeddings. Generated embeddings can capture semantic, geometric, topological, and/or other information for the ODDs.

In at least one embodiment such a language model can generate a representation of an environment that complies with real world rules and constructs, and that accounts for omissions or errors in the input data to be used to generate the representation. Objects in an environment can be represented using individual tokens or token sequences, optionally with token descriptors providing semantics and other information related to these tokens. A text-based representation can be a one-dimensional string of these tokens and token descriptors, which can encapsulate the important spatial information and semantics of an environment. An advantage of such a text-based description is that it can be discrete and compact, allowing for quick processing, search, updating, and other such operations. A generated text-based representation of an environment can be used to generate a number of other types of representations useful for various operations or tasks, such as may include birds-eye view maps, high definition (HD) maps, or 3D virtual environments, among other such options.

In at least one embodiment, generative Al can be used to provide a semantic understanding of an environment based at least in part on sensor data captured for an environment. This sensor data can be processed and fed to a trained generative Al model (such as a large language model or “LLM”), for example, which can output a textual description of an environment in a structured textual format, such as in a Road Topology Language (RTL). A text string in RTL can provide a tokenized representation of a map or graph of an environment. The generative Al can be trained in such a way as to be able to fill in gaps or correct errors in the sensor data based on a semantic understanding of the objects or elements in the environment. The language model can receive input including semantic, location, and/or geometric information determined for an environment, such as by processing sensor data (e.g., image or LIDAR data) captured for an environment, and can update the textual representation of a scene as the environment changes due to movement or other such occurrences. The language model may also take other inputs as well, such as prior maps or context information (indicating things like weather, time of day, season, urban/rural region, geographic location, etc.). The input data can be represented by embeddings, feature vectors, or points in a latent space, which allows for relatively simple searching for similar environments. In this way, quick determinations of actions to be taken in an environment can be made by determining which actions were taken in similar environments, particularly when there may be insufficient data available for a current environment or situation to make a high confidence decision as to an action to be taken. The ability to determine what others have done in similar environments can help a system to function in a way similar to how a human uses “intuition” in a given situation even when there may be data missing, such as where snow may have obscured the lines along a road but the human can infer where to drive based on other information available in the environment. Such an approach can be used for a wide variety of geospatial information processing and autonomous driving tasks (such as map building, map editing, map-based navigation, planning and driving) by representing those tasks as document manipulation tasks. A generative Al once trained can also be used to generate realistic simulation environments that comply with real world rules, such as may be useful for testing autonomous vehicles or robots, or other such machines. A machine as used herein can include any appropriate physical (or at least partially virtual) device, system, or component that is able to process data to perform one or more actions, such as may include one or more physical actions in a real world environment. Such an approach can also be used to correct or update noisy or partial environment graphs or maps. The generative Al model might take the sensor data directly as input or might receive input that is generated from the sensor data in one or more stages of a pipeline, such as stages to extract features and generate embeddings of those features in a latent space that can be provided as input to the generative model.

Approaches in accordance with various illustrative embodiments can provide for the use of language models for mapping in autonomous or semi-autonomous systems and applications. Systems and methods are disclosed that use one or more language models (e.g., LLMs) to perform various mapping operations—such as map building, map editing, map-based navigation, routing, planning, and perception, error checking, data cleaning, and data validation, among others. For example, a deep learning model—such as an LLM—may encapsulate domain knowledge about how road networks and/or objects are structured. By training an LLM to predict structure and attributes of a graph described in a domain specific language (DSL)—such as RTL—the LLM learns to establish correct relationships among objects on the road. The RTL may express road, object, and/or other map-related information (e.g., by modeling relationships among lane elements and other map features) using language, such that the LLM learns to interpret the RTL—in addition to natural or conversational language—to generate outputs. An automated process may be implemented to convert existing map information to the RTL, and to convert outputs of the LLM from RTL to a suitable map format (e.g., a format for an HD map deployed in a production vehicle). Such an LLM may be used to solve various challenging problems related to mapping—such as identifying or correcting mistakes or gaps in maps, creating maps from a photo or video stream of road data, creating maps from aerial or satellite images, and/or creating maps from text descriptions. Once created, the maps can be used for various tasks, such as for autonomous vehicles (AV) or autonomous systems, semi-autonomous vehicles or systems (e.g., for advanced driver assistance systems (ADAS)), simulation systems (e.g., for developing or testing/validating AV/ADAS algorithms or for creating training data for AV/ADAS perception), and/or the like.

Variations of this and other such functionality can be used as well within the scope of the various embodiments as would be apparent to one of ordinary skill in the art in light of the teachings and suggestions contained herein.

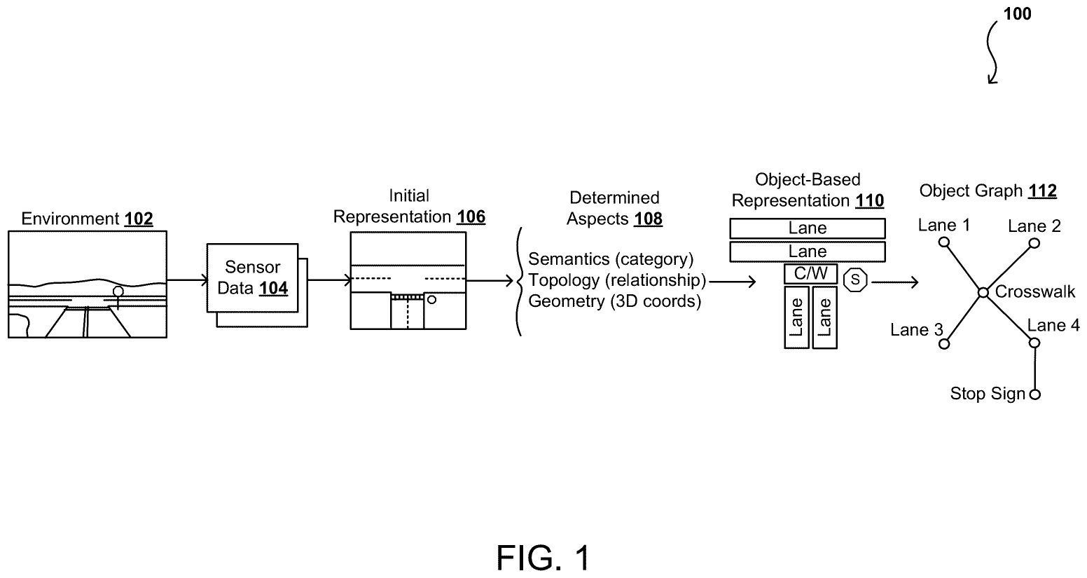

FIG. 1 illustrates an example data processing flow that can be implemented in an environment representation and/or reconstruction system in accordance with at least one embodiment. In this example, sensor data 104 (or other raw data captured or representative of an environment) is obtained with respect to a specific environment 102. The environment can be any appropriate physical environment, such as an indoor or outdoor environment that may include any number of different types of objects or elements. The sensor data can include data captured or obtained using any of a number of different types of sensors, as may include cameras, LIDAR systems, radars, sonic sensors, distance sensors, and the like. Additional data may be obtained that relates to the environment 102 as well in various embodiments, as may relate to basic map data, contextual data, motion data, or other such data, which may also be obtained for virtual, augmented, or enhanced environments. In this example, the sensor data 104 (and any other available and useful data) can be used to generate an initial representation 106 of the environment 102. In at least one embodiment, this may include a point cloud representation of the environment 102 generated by analyzing and aggregating the sensor data 104 that may have been captured by multiple sensors in order to generate a single, n-dimensional (e.g., 2D, 3D, or 4D) representation of the environment. Other initial representations can be generated as well, as may depend at least in part upon the type of sensor data provided. If image data is provided, the image data may be analyzed to attempt to determine feature and depth information, which can be combined from multiple images from different viewpoints to attempt to generate at least a 3D representation of the environment 102, or at least objects and shapes within that environment.

This initial representation 106 of the environment 102 can be analyzed to attempt to determine specific aspects 108 of the environment. For example, a point cloud can be analyzed to attempt to determine the categories (or types) of objects represented in the environment, as may relate to roadways, traffic signs, sidewalks, buildings, and the like. The representation can also be analyzed to attempt to determine the locations of these objects in the environment, as may be defined using a set of 3D coordinates relative to a determined origin location. The initial representation 106 can also be analyzed to attempt to determine various relationships between these objects, such as where a crosswalk crosses specific lanes or where a stop sign is associated with a specific lane and indicates an expected behavior. Once these determined aspects 108 are obtained, these aspects can be used to generate an object-based representation 110 of the environment 102. Various other types of representations can be generated as well within the scope of various embodiments. As illustrated, the object-based representation 110 will not be a comprehensive description of the environment 102 in this example, but will instead focus on the types of objects or features of the environment that are potentially relevant to a particular task. For autonomous driving, for example, the object-based representation may include objects such as road lanes, crosswalks, intersections, and the like, but may not include objects that may not be directly relevant to driving, as may include buildings, billboards, mailboxes, and other such objects, except to the extent those objects may be relevant to a specific operation or task. In this example, the object-based representation 110 also does not include vehicles, pedestrians, or other movable objects that will only be in specific locations in the environment 102 at specific times, but any or all of these and other such objects could be included in the representation as well within the scope of various embodiments.

From this object-based representation, an object graph 112 can be generated that provides a different representation of the environment 102. An advantage of the object graph 112 is that it is relatively lightweight, and can be used to compactly describe aspects of the environment 102 that are important for a particular task or operation. For example, such an object graph 112 could be provided to a map generator in order to generate an HD map (or other such map or representation) that can be provided to an autonomous vehicle to make navigation decisions. Such an object graph 112 can also be provided as input to an environment generator that can generate a realistic 3D virtual environment that can be used for tasks such as robotic simulation or digital world recreation. A large number of object graphs can be stored to represent a number of different environments, which can require significantly less memory or storage capacity than sensor data, such as a large number of high resolution images. Such object graphs can also be analyzed quickly to allow for real-time operations, such as autonomous navigation or control.

A challenge with existing approaches to generate such representations is that there is a limited ability to perform automated geospatial information processing, particularly using an algorithm framework that is sufficiently generic to support a wide variety of use cases. Existing solutions typically have task-specific designs that cannot easily adapt to new task requirements, contain built-in assumptions that might not always hold in real-world situations, and do not make effective use of available data and human input. Existing approaches are also limited in their ability to learn from large amounts of diverse data that can be relevant to these different tasks or use cases. Many existing solutions depend heavily on domain expertise and manually-designed logic or rules in various steps of the processing pipeline. These attempted solutions are difficult to accurately complete and improve, and require manual effort to moderate the results and make them correct. Improvements in these systems are costly and generally offer smaller and smaller performance gains for the effort spent.

Approaches in accordance with at least one embodiment can provide a versatile approach to processing information about such an environment 102, as may include geospatial and semantic information. In at least one embodiment, a deep learning model can be used that encapsulates domain-specific (or agnostic) knowledge about how objects in an environment are structured and related. An example deep learning model is a large language model (LLM) that can be trained to generate a textual description of an environment that retains semantic understanding of an environment in addition to providing information about the categories and locations of objects in the environment. In at least one embodiment, an LLM can generate a tokenized text string as a representation of an environment, where objects in the environment are represented as tokens in the string. There can also be a set of token descriptors in the string, and associated with specific tokens, that provide semantic and/or relationship information with respect to the various tokens of the string. In addition to generating a compact yet thorough representation of an environment, for example, an advantage of using a model such as an LLM is that the LLM can fill in gaps in the sensor data or otherwise make corrections where needed to provide a more accurate representation of the environment. For example, training an LLM to predict the next token in the text string (corresponding to a next object in an object graph, for example) can help the LLM to learn to establish correct relationships between objects in the environment. This can include, for example, identifying or correcting mistakes or gaps in environment representations, creating environment representations (e.g., maps or object graphs) from a photo or video stream of environment data, creating environment representations from aerial or satellite images, and creating environment descriptions from textual descriptions, among other such tasks.

In at least one embodiment, a language model-based approach can be used that can allow model training on large-scale existing environment representations, such as maps, making data-driven performance improvements easier and more scalable with respect to domain expertise. A training approach can be used that can specifically teach the LLM to identify the next token in the graph. In at least one embodiment, an LLM can generate a deep underlying representation of how objects and/or networks in the environment are connected or related, as well as a model of the graph data already presented as input to the LLM. In at least one embodiment, various tasks in geospatial information processing can be unified under a shared formulation, such that the same algorithmic models can be re-used without extra engineering effort. Processing efficiency can be further improved through replacing manual labor with machine learning model-based automation. A large language model can be trained on vast amounts of environment data so that it can automate various tasks such as missing element detection, inaccurate element correction, and inference of relationships among elements, among other such tasks. Each of these can be achieved without heavily depending on human expertise to explicitly design for, and can be improved continuously with additional training data. Such a model can leverage existing environment (e.g., map) data without requiring additional data curation and labeling cost. The model can be trained in a task-agnostic way so that the model can be extended to other use cases without significant additional effort. These representations can include, or be used to generate, high quality maps useful for tasks such as those related to an advanced driver assistance system (ADAS), autonomous vehicle (AV), unmanned aerial vehicle (UAV) or simulation system, such as may be useful for developing or testing/validating AV/ADAS/UAV algorithms or creating training data for AV/ADAS/UAV perception.

Approaches in accordance with at least one embodiment attempt to improve, optimize, or at least control the way in which an environment is perceived. In various existing systems, perception of an environment is relatively primitive and based around rules for detected objects. For example, an existing system might analyze a captured image to identify the location of roadway lanes and lane markers, but do not have any concept of what the lines on the roadways mean, or how those lines relate to nearby road signs or traffic lights. An existing system might recognize the objects and use the locations of those objects to generate a map reflecting those objects. The system might attempt to determine relationships and apply rules to these objects to ensure the placement makes sense and determine any relationships, but this is typically done during post-processing when most other data has already been discarded. Applying rules based on detected objects means that it can be difficult to detect gaps, errors, or omissions that might otherwise be detected if the relationships and semantic meanings of various objects in a seen were known and used in the process of generating the representation of the environment.

Further, a rules-based approach is harder to scale in many instances.

An approach in accordance with at least one embodiment can obtain and apply such knowledge earlier in the process. As mentioned, a large language model can take input relating to the semantics, location, and relationship between various objects in an environment, and can use this information to determine based on its learning how to generate a realistic environment representation based on this input that can make up for the fact that the input data may be somewhat incomplete or erroneous. By representing the environment through text, a language model can apply its learnings to determine how to structure the representation to ensure realism and completeness, and fill in gaps in the input data based on what it has learned from similar situations. A language model has the advantage of taking text as input, rather than images or other large instances of sensor data, which can be processed relatively quickly during training. This allows a generative model to be trained using millions or even billions of such documents, with self-supervision, which provides for better understanding of behavior and relationships, as well as which behavior and/or relationships apply to a given environment or situation. By converting an object- or feature-based representation into a language representation, for example, this text-based representation can be used to train a language model to understand the various correlations between categories of objects and their relative locations, including ways that may be difficult to enumerate comprehensively. Attempting to capture all the relevant real-world correlations, relationships, and other semantic aspects would be extremely difficult to do using only explicit rules as would be required for various existing systems.

In the example of FIG. 1, a language model could take as input an object-based representation 110 and generate what is essentially a tokenized text string representation of the object graph 112. In other embodiments, the language model might be able to take other inputs that would allow for at least some steps in this generation pipeline to be eliminated as separate steps performed by separate processes or components. For example, an LLM could be trained to take in a set of determined aspects 108 (e.g., semantics, topology, or geometry information for an environment or objects in that environment) in text format and generate a tokenized text string representative of the object graph 112 without ever having to generate an object-based representation. Similarly, in some embodiments an LLM can take as input the internal representation 106, or even the sensor data 104, without the need for separate intermediate representations. For example, a model (as part of the LLM or a separate model) can analyze the sensor data 104 for the environment and encode features of the sensor data into a latent space (or other embedding). The LLM can then take a feature vector as input that is a function of these individual latent space encodings, and can directly generate the tokenized text string representation of the environment. The features extracted can include semantic, relationship, and geometry features, among other such options. Encoding such features in a latent space can prevent this information from being discarded early in the generation process, and allow for more accurate representations or reconstructions to be generated.

In at least one embodiment, the tokenized text string can include a sequence of tokens, where each token represents an object in the environment. The string also can include a set of “token descriptors” that provide some semantic context or other useful information for a given token. The tokens can also be in a specific sequence, which not only can be useful in generating an object graph from the text string, but also allows semantic learning to be applied to the sequence of tokens as an LLM might typically do for the words of a sentence. A number of languages can be used to represent such an environment, as long as the language is able to provide the representation as a sequential notation of discrete tokens. In at least one embodiment, a custom language might be used that includes specific tokens and token descriptors that can accurately and compactly represent a specific type of environment. For example, a road topology language (RTL) might be used that includes terminology and syntax useful for representing map data for environments including roadways. A unified, sequential, tokenized text representation can be used to model an object graph, and an object graph can be quickly generated from such a sequential tokenized text string in a way that is consistently repeatable. A language model can be trained to understand and “speak” in at least one specific language, such as RTL. As a trained LLM will know how to manipulate or fill in a sentence in natural language, so can an LLM learn to fill in a text string in a structured representation language. The LLM can also infer relationships between objects based on its understanding of the language. The LLM can then generate a unified text representation of an environment that can include information that was not present or determinable from the input alone but that allows the environment to be more realistic and to comply with real world rules and/or constraints. These may include, for example, local traffic rules or ordinances, customs, and abilities of objects in the environment, among other such options. The language model can be trained to learn the semantics and syntax of the language, as well as the reasoning behind the semantics and syntax, including the physical concepts behind various object relationships. Instead of considering lane boundaries as lines in space, an LLM can consider the boundaries as associated with lanes of a roadway that come with various requirements, traffic rule or behaviors, and associated objects.

A language model trained to generate a representation using such a language can be used in at least one embodiment to describe the physical layout of an environment, such as may be useful for generating high quality maps. A model can generate text to describe other aspects of an environment as well, as may include characters, animals, vehicles, or other objects and elements that might move or change position or pose over time, and that might only be in an environment for a limited period of time. For example, a text string might be generated that provides a representation including a map view that illustrates where a vehicle can navigate, and also including representations of pedestrians, other vehicles, buildings, or other types of objects or entities that may be important for navigation or other such tasks. If a language model is able to generate a presentation that accurately describes aspects of the environment including nearby vehicles and pedestrians, for example, then navigation decisions may be able to be made using this representation without a separate need to identify such objects and provide that as additional input to a navigation or control system. An example perception map or representation can be generated that may include anything or everything in an environment that can be perceived using the available sensor data (or other such data) along with understanding of the physical rules or relationships for such an environment.

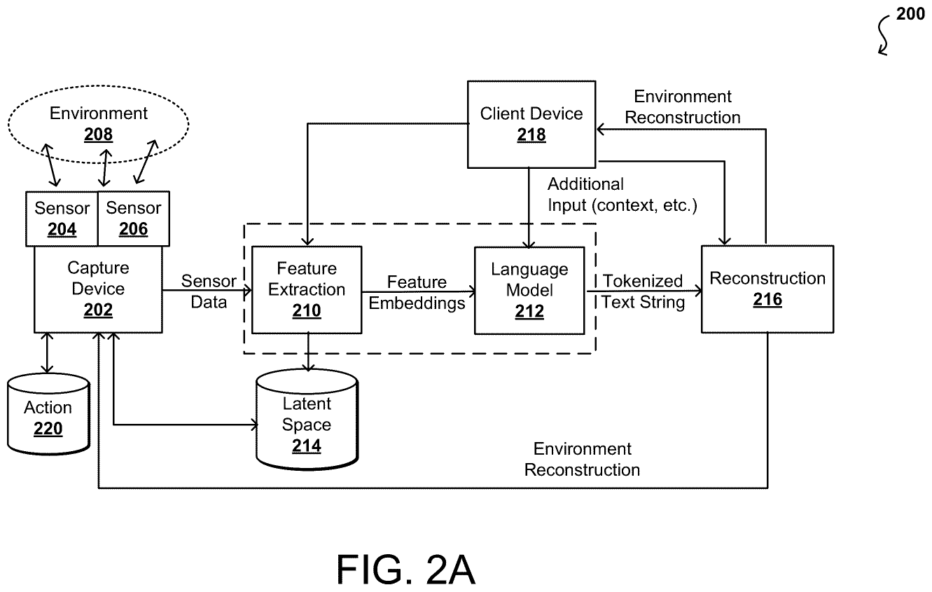

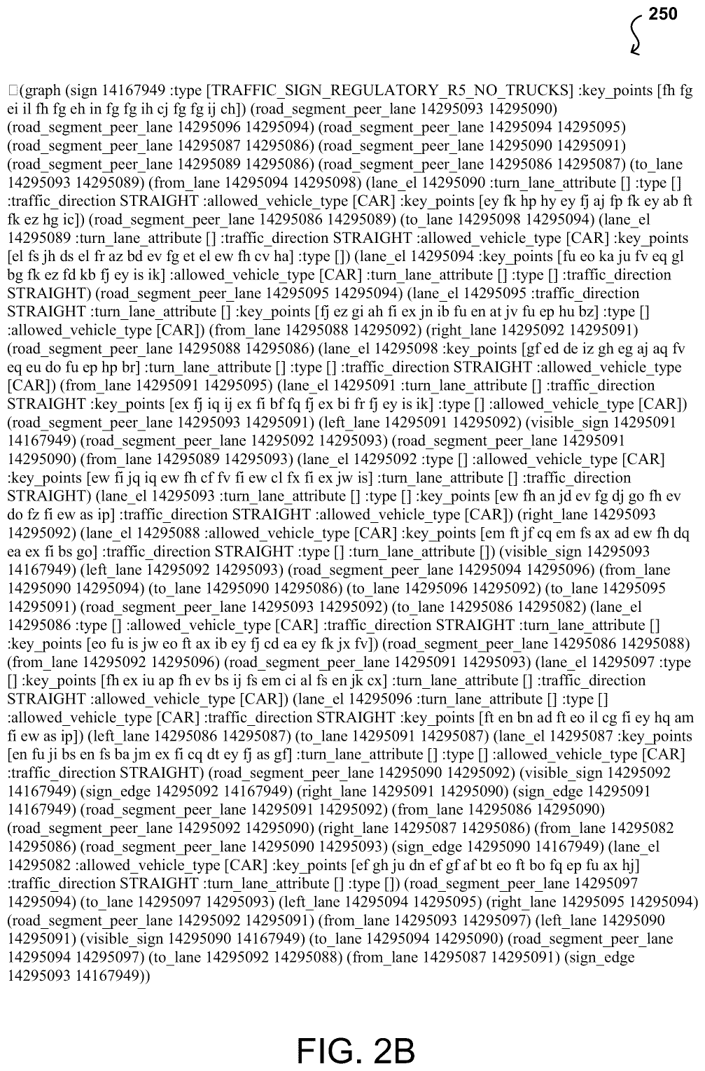

FIG. 2A illustrates an example pipeline 200 that can be used to generate a text-based representation of an environment in accordance with at least one embodiment. Rather than requiring at least some amount of manual interaction, such an approach can automatically generate a representation from a variety of different types of input data. In this example, a capture device 202 can include, or be associated with, one or more sensors 204, 206 that can capture or generate information about an environment 208. The capture device can include any device, system, or component that is able to obtain sensor data from one or more sensors and either process that sensor data or transmit that sensor data for processing, as may include a desktop computer, a smart phone, a vehicle with data processing capability, or a robotic assembly, among other such options. The sensors can include any appropriate type of sensor that is able to capture or generate useful information about an environment, including sensors such as cameras, infrared (IR) sensors, ultrasonic sensors, depth sensors, LIDAR systems, radar systems, or other such sensors or data capture elements. The environment 208 can include an environment in which the capture device 202 is located, or that is within a capture distance of one or more sensors 204, 206.

In this example, the capture device 202 can provide the sensor data to be analyzed by a feature extraction module 210. As mentioned, the feature extraction can be performed as part of a large language model 212 or by a separate model or algorithm, among other such options. In this example, the feature extraction module 210 can include an encoder that can extract features from the various instances of sensor data and encode those features as embeddings or points in a latent space 214. The environment 208 in at least one embodiment can be represented by a set of embeddings or points in latent space, which may then be represented by one or more feature vectors corresponding to those individual embeddings. The latent space 214 may be an n-dimensional latent space, where each environment (or state of an environment) can correspond to a point (or vector) in the n-dimensional latent space.

In this example, at least one feature vector representing the point in the n-dimensional space can be provided as input to a large language model 212. Various other types of embeddings or representations can be used as well within the scope of various embodiments. In at least one embodiment, each object in the environment can be represented by a token in a text string to be generated, as well as an embedding, feature vector, or point in an n-dimensional latent space, as discussed previously. Such a feature vector or embedding can specify not only the type of object, but can also represent various features of that object that can help to encode, for example, semantic, geographic, and/or topological information for that object.

The language model can use this input to generate a tokenized text string that is representative of the environment. In this example, the language model might receive other input as well that may help to generate a more accurate representation. For example, the language might receive a prior or partial map or environment representation, or prior tokenized text string (e.g., for a prior time point or nearby location) to which the language model can refer, and which can help with consistency of representations over time, such as where the environment is being reconstructed for a vehicle moving through an environment and comparing the inferences for each time point can help to improve accuracy by reducing noise or removing false positives (or at least flagging inferences that do not make sense based on a prior determination, such as where an object type has changed or suddenly appeared out of nowhere). Various other types of input can be provided as well. For example, a user might use a client device 218, such as a desktop computer or notebook computer, to provide input that can guide the generation of the tokenized text string. For example, the client device might provide contextual information that can help to guide the generation. Contextual information might include, for example, a type of environment, such as indication of an urban or rural setting, which can help the model to apply the appropriate set of rules. As an example, some of the relationships between road objects may be quite different in downtown Manhattan than they are in rural Montana, although various other relationships may be quite similar. The contextual information might indicate the state or country in which the sensor data was captured, as different states or countries often have different traffic or behavior rules, such as which lanes vehicles are allows to turn into at an intersection. The contextual information might include information about the weather or time of day, as sensor data for a snowy, rainy, or night time environment might lack data for objects that might otherwise be observed during a sunny daytime capture period. Further, different behavior or rules might be appropriate at night or other situations where visibility may be limited. As discussed later herein, where a simulation environment is to be generated based upon embeddings in a latent space 214, for example, the additional input from a client device 218 can help to determine aspects of the simulation environment to be generated.

Tokenized text strings generated by a large language model 212 can be provided to various components for various tasks. In some embodiments, a reconstruction of the environment 208 might be performed by a reconstruction module 216 or system, such as to generate a high definition map or 3D digital model of the environment 208. In some embodiments, a text string and/or reconstruction might be provided to a control or navigation system for an autonomous vehicle or robot to allow decisions to be make about how to move or interact with respect to objects in the environment. In this example, the initial capture device 202 might be on or part of a vehicle, or may in some embodiments be the vehicle (or robot, etc.) itself. The reconstruction of the environment can be provided back to the capture device for use in performing specific tasks. For example, if the capture device is an autonomous vehicle or driver assistance system, the reconstruction (or in some embodiments the tokenized text string) can be provided back to the capture device—which captured the initial sensor data using associated sensors 204, 206—to perform operations such as to make navigation or operation decisions based in part on the reconstruction.

In at least one embodiment, the reconstruction can be provided to a client device 218 for presentation or analysis, which may be the same client device that instructed the reconstruction. The client device 218 can analyze the reconstructed environment for accuracy and completeness in some embodiments, or can perform various operations or simulations with respect to the environment. The client device 218 may also provide additional information, such as context, to the reconstruction module to use to generate the environment. For example, the client device might instruct the reconstruction module 216 to generate multiple reconstructions of the same environment 208 using the same tokenized text string, but under different conditions. This may include, for example, versions of the same environment in summer during the day, winter at night, in Europe versus Asia (which can impact the language and style used), and so forth. During model training, the tokenized text string and/or environment reconstruction can be compared against appropriate ground truth data in order to determine a loss value and update the parameters for the appropriate model.

In this example, the feature extraction and language generation operations may be part of the same or separate models. For example, a first model (e.g., an encoder) might take the sensor data as input and output a set of embeddings or latent feature vectors as output that can then be provided as input to a generative model (e.g., a large language model). In another embodiment, a generative model may include feature extraction or analysis capability, and can generate a tokenized text string as output without any intermediate or other steps to process or analyze the input sensor data. Referring back to the description of FIG. 1, a language model can be trained to take input from any of various stages of a representation generation pipeline. For example, a language model can take the raw sensor data as input, or can take as input an initial representation (e.g., a point cloud) generated by analyzing that sensor data using a separate module, system, component, model, algorithm, or process. Similarly, the model might take in determined aspects or information as may relate to the semantics, topology, or geometry of an environment, or might take as input an object-based representation generated for the environment, among other such options. In at least some embodiments, the type of input to be used may depend at least in part upon the system in which the language model to be used, as different systems may already provide specific outputs to be used. In at least one embodiment, a language model might take the raw sensor data and such an intermediate representation as input, in order to attempt to provide more accurate or consistent representations. In some embodiments, multiple language models may be used. For example, a language model might be used to determine the semantics, topology, and geometry of an environment that are then to be fed as input to another language model.

In some instances, the tokenized text string and/or reconstruction generated for an environment may be incomplete for any of a number of reasons. For example, it might be snowing and some of the lane markers may not be visible or accurately represented in the sensor data. In other instances, a stop sign may have been damaged and not visible, or there may be an object obstructing part of the environment. In such situations, it may be difficult for an operation or task to be completed accurately or successfully based on the lack of complete information. Using a system such as that illustrated in FIG. 2A, however, decisions can be made based on other decisions that were made in similar situations and environments. For example, during the feature extraction and encoding stage a point can have been determined in an n-dimensional latent space that represents the extracted features. While the set of features will not be complete due to the incomplete sensor data, a search can be performed in the latent space 214 for nearby points, which would represent very similar environments. This could include, for example, similar intersections in different locations, or even previously-generated embeddings for the same general environment. Other types of feature- or embedding-based searches can be performed as well within the scope of various embodiments. Once similar environment(s) have been determined through such a search, a database 220 of actions taken in those environments can be analyzed to attempt to determine, with at least minimal probability or confidence, an action to be taken in the present environment 208. For example, a lane marker or traffic signal may not be visible, but based upon what other vehicles (or even the same vehicle) in other environments have done in similar situations, a determination can be made as to the correct action to be taken in the current environment 208. Such an approach can allow a vehicle navigation system to function similar to human intuition, where a decision can be made as to the most appropriate action to be taken based on the information available and what has worked properly in similar situations in the past. For example, such an approach could allow an autonomous vehicle to operate in the snow even when lane markers are not visible based on the locations of objects such as road signs, traffic signals, other vehicles, and so on, where an appropriate location and action of the vehicle can be determined based upon what other vehicles have done in similar situations. In these similar situations the lane markers would likely often have been visible, so the data should be reliable. Such an approach can help to further fill in gaps or omissions in the input data.

A search process based at least in part on features, embeddings, or tokenized text strings can be relatively fast and lightweight, which can be important for tasks such as real time vehicle navigation or automation control. The search can also help to provide additional information for generating more accurate text strings or reconstructions. For example, when a set of feature embeddings is determined for an environment, a search can be performed to identify other environments that are very similar to the current environment or the same environment at a past point in time. Once determined, information about these similar environments can be analyzed to attempt to provide additional information, such as contextual information that may be able to help the text string or reconstruction to be more accurate. For example, the locations and relative spacings of various road signs may help to indicate the country or region in which the environment is located, the weather, a language in which signs are likely to be presented, and so forth. In some embodiments, embeddings or feature points from these similar environments can be provided as input to a language model to attempt to provide a more accurate tokenized text string, or better understand the relationships between objects detected from the sensor data.

The ability to compare a current situation to similar situations in similar environments can help with other tasks as well. For example, the prior observed behavior of people and vehicles in similar environments can be used to predict what similar objects are likely to do in the present environment, which can help make better decisions on the best course of action to take at the current time in the present environment. For example, where and when people are allowed to cross a street, as well as the likelihood of a person crossing the street, may vary in different locations, and understanding the likely actions in a given location based on past observations for similar environments can help to avoid collisions or other undesired occurrences. Such an approach can help to provide a semantic “understanding” of an environment at a specific point in time, and can help to generate various types of representations or determine various actions to take based at least in part on that understanding, as well as what is known about similar environments.

Referring again to the description of FIG. 1, a tokenized text string can effectively provide a different representation of an object graph. This can allow such an approach to be used with existing systems or processes that expect such a graph as input. Approaches presented herein can provide accurate object graph representations in the form of tokenized text strings, for example, which can be generated quickly, accurately, and automatically without human intervention in most cases. As mentioned, such a process can also help to fill in gaps or make corrections in the object graph that might not have been determinable from the sensor data or related input. In at least one embodiment, particularly where a language model undergoes continued learning, the model may learn new relationships or object types that may help to build more robust object graph representations, and can infer additional semantics or relationships which can help these object graph representations to become more accurate over time. The syntax of the relevant description language can be updated over time to more accurately capture or reflect these additional learnings. In at least some embodiments, a tokenized text string can be equivalent to an object graph, just in different form. In other embodiments, a tokenized text string may include additional information that provides more context, understanding, or insight than might be available using a conventional object graph, and may include relationships that might not be indicated using such an object graph, including relationships that might not be easily explainable using natural human language.

As mentioned, a language model can apply learned rules to an environment similar to how a language model would have applied language rules to natural language text. Similar to how a model learns correct sentence structure, the model can learn correct environment structure, such as how lanes and roadways interrelate and are permitted to be designed. This can prevent the language model from generating a text string that indicates that lanes cross each other outside intersections, that certain intersections can be free of traffic signals or stop signs, that onramps can end short of the connecting highway lane, and so forth. The semantic understanding of these relationships can help to fill in this information even where the sensor data did not include sufficient data to otherwise provide this information, or was otherwise unclear as to how it should be interpreted. The language model can use its learning and semantic understanding to properly interpret the data that is available, and can refer to data for similar environments in at least some embodiments when it is appropriate or necessary. In some situations, there may be an object observed that cannot be identified with a sufficient level of confidence—such as where the object is partially obscured or damaged, or is of a type or style that has not been previously encountered. The language model can rely upon its learnings to make a more accurate and/or confident determination of the type of object based on, for example, the other objects in that environment and the types of objects which typically have relationships to those objects. For example, an intersection will typically have a stop sign or traffic signal, while a highway will not and may be more likely to have an express lane or a mile marker. The ability to know what type of objects to expect for a given environment and/or context, as well as where those types of objects would typically be in that context, a language model can improve aspects such as object recognition even for objects that were not previously encountered or are at least partially obscured.

In some embodiments, such as where an environment is to be generated for simulation that complies with real world rules, a user might augment sensor data in order to include additional (or alternative) objects in the reconstruction. For example, a user might use a client device 218 to submit information about a pedestrian bridge that is to be added to an environment represented in captured sensor data. Appropriate embeddings for the bridge can be determined and encoded into the latent space for the environment. In some embodiments, the user might view the reconstruction on the client device 218 and make modifications, which can be provided as updated input to the large language model 212 to provide an updated tokenized text string and environment reconstruction. In some embodiments, a user can be allowed to generate a new environment reconstruction independent of sensor data. A user might provide input (e.g., speech or text) describing an environment, and this input (after any appropriate reformatting or analysis) can be used to select an appropriate point in latent space 214, which can then be provided as input to the language model to generate an appropriate tokenized text string. In some embodiments, the user input may be able to be provided directly to the language model as input, without the need for separate feature extraction or embedding generation. Such an approach can be useful for simulation environment generation, where a large amount of environment data can be generated synthetically without extensive cost or manual effort, which can be beneficial for training machine learning models or other artificial intelligence systems to operate in these various simulated environments. An environment generation process can then generate environments automatically, in response to human prompts, or through a combination of both.

Modifications to the environment can be made relatively quickly and without significant processing through updating of the tokenized text string.

In at least one embodiment, an environment generation and/or reconstruction system can work with various data formats, and can perform reformatting or restricting as appropriate. For example, data might be received in map, object, or graph format and can be converted to tokenized text string in a structured language. Similarly, such a text string can be used to generate any of these or other such representations of an environment. The text can also be regenerated to correspond to a different human language, as the same language (e.g., RTL) may have different terms or descriptors in different human languages (e.g., French or Spanish) for similar types of objects or relationships. When specifying the context such as the country or region, a language model can also learn to speak a language in which it may not have been initially trained, and can learn to use the terminology that is appropriate for a given location or context. It may be the case that components of a system all speak in a structured token-based language internally, but may accept input or generate output in any of a number of different formats. Using the structured language to communicate internally can help to ensure that no data regarding semantics, relationships, or other such aspects are lost during processing and analysis due to the type of format being used.

As mentioned, a language-based representation can be very compact and discrete. Such aspects make language representations beneficial for use in real time, real-world environments as the representations can be updated quickly and accurately, and can be updated to include only that information that is relevant at the current time. For example, a language model might be used with a navigation system of an autonomous vehicle to make real-time navigation determinations. The ability to make these decisions is critical for many such applications. As the vehicle moves, the language representation can be updated to include portions of the environment that are now visible to the sensors ahead of the vehicle, for example, and can remove or delete portions that are no longer visible or are otherwise determined to not be important to navigation and the current location given the current direction and rate of motion, or other such aspects. Similarly, as another vehicle enters the roadway near the current (e.g., ego) vehicle, a representation of that other vehicle can be added to the language representation, while vehicles exiting the roadway or being more than a threshold distance away from the ego vehicle may be removed. Such an approach can allow the language representation to be easily right-sized, such that it can contain all of the information determined to be important and an exclude any information that is determined to be irrelevant, or at least no longer relevant based upon the current position, speed, direction, etc. Keeping a dynamic language representation current but compact can help to make better, faster decisions by only including the information needed to make decisions at a current (or near future) point or period in time.

As mentioned, a language model in at least one embodiment can be self-supervised. A language model can be trained to understand the structures, patterns, syntax, relationships, and other aspects of the language(s) on which it is trained. The trained model can then take in text (or other language input) for a new environment and generate or reconstruct that environment based on its learnings, or can take in an incomplete or inaccurate representation of an environment and can generate a corrected or more complete representation. And this can be an end-to-end automated process with no need for human intervention, as opposed to prior systems that required human intervention at some if not all stages of map generation. When a model learns that it made a mistake and/or is able to correct a mistake or omission, the model can learn from that in order to make better future decisions. Such an approach can help to generate far more accurate representations that would be possible, or at least practical, with human-generated systems, as there can be many more rules or relationships for an environment such as an intersection or parking lot than may be practical for a human to attempt to accurately code, particularly when many of these rules or relationships might be implicit such that a human may not consciously even be aware they exist. A language model can learn these and other such rules and relationships without coding or supervision, which provides a significant advantage over prior mapping or reconstruction systems.

In one example, a language model can be used to generate or correct a representation such as a high definition (HD) map. An HD map generally is a type of map used for tasks such as autonomous driving, which may contain details or information that are not typically included in, or associated with, a conventional map. In an example HD map, individual sections of a roadway are encoded separately. These encodings can differentiate regions corrupting to different lanes in an intersection, for example, as well as potentially options for navigating on those lanes. Such information can be helpful in an intersection where there may not be painted or explicit lane markers for each available lane in each direction. This information helps a navigation system to function more like a human would, having the ability to understand implicit information based on context, but using previous systems these aspects needed to be hard coded and were thus limited in scope and difficult to scale. Each feature in the road can be represented by a node in a graph associated with the HID map. A language model can take this information, and can make corrections or additions based on its understanding of the relationships and semantics of the environment, which can account for implicit inferences typically performed by human beings that can otherwise be difficult to design or instruct an automated process to perform. While aspects such as critical road boundaries may be relatively straightforward to code using a manual approach, for at least some environments, coding more implicit operations such as how to maneuver relative to a crosswalk in a complex urban environment (where the options can differ based upon the number and locations of people in that crosswalk at any given time, the state of crossing signals which may not all be visible, and decisions of people to not follow the rules and cross against the light or jaywalk, etc.) or to navigate through a detour or unique construction region can be much more difficult for a traditional system, and can benefit from the inferences and similarity determinations able to be performed using a language model as presented herein.

In at least one embodiment, a vector-based search can be used to find similar vectors (or other embeddings or encodings, etc.), such as may correspond to a very similar intersection, for use in inferring aspects of the environment or actions to take with respect to that environment, particularly where the raw sensor data may be inaccurate or incomplete. Such an approach is thus not a rule-based search, but a similarity-based search based upon what is determinable about an object or environment. Any appropriate vector-based similarity approach can be used, such as may attempt to determine a cosine similarity of an L1-based similarity between feature vectors. For a similarity-based search, an example is provided that is to be used for the search, rather than a description, label, or query attempting to clarify aspects of, or parameters for, the search. For a similarity-based search, an example is provided and the search attempts to locate similar examples independent of any description, labels, or annotations associated with the example (although such information could be used as additional search parameters in at least some embodiments). Such a search can be performed quickly using incomplete or slightly inaccurate information, which can provide significant advantages over rules-based search, and can allow for results that are not an exact match. An embedding can also represent various uncertainties with respect to an object. Such an embedding can also be a very lightweight representation that requires little storage capacity or bandwidth or streaming or transmission. As additional information is obtained for an object, the embedding for that object can be updated as well.

A language used with such a model will be somewhat lossy in many instances, so it can be important in at least one embodiment to attempt to encode features in that language in such a way as to retain as much important information as possible. For example, an image can contain a large number of details about a person or vehicle, and many of these details will be lost in a compact language description. For many aspects this will be acceptable, as information about the general appearance or clothing of a person will typically not impact the decisions made by a vehicle with respect to this person, such as to avoid coming within more than three feet of that person at any time. A type of object may thus be used as a primary indicator or type of token, but there can be additional details or information stored to the token or to a token descriptor in a token-based text string. In at least one embodiment, geo-coordinates are stored as well so all nodes or tokens have well-defined places in space in addition to information about connectedness or relationships. The nodes thus store information about geometry in addition to information about semantics and topology. The information can also be general enough to support multiple domains or tasks that may involve similar types of objects.

In at least one embodiment, this additional information can be generated using conventional algorithms or machine learning, among other such options. For example, one or more machine learning models can be trained and used to provide information about the semantics, topology, and geometry (or other such aspects) of an object or environment. This can include the use of one or more language models that can take in various types of input and output a textual description of, or textual content for, any of these aspects. In some embodiments, the raw sensor data can be provided as input, while in other embodiments there may be at least some amount of pre-processing, such as to determine bounding boxes around objects and extract the relevant image data, or perform basic object classification based on operations such as computer vision-based analysis, among other such options.

FIG. 2B illustrates an example tokenized text string 250 that can be generated for an environment in accordance with at least one embodiment. As illustrated, the string is a tokenized and sequential text string that represents individual objects as tokens, similar to nodes of a map graph. In this example, there are objects of types such as signs, lanes, and vehicles that are represented by tokens in the text string, along with token identifiers. There are also token descriptors, or additional information for those tokens, included in the text string. These descriptors provide additional information, such as a traffic direction for a lane or information identifying a connected lane. Other information is encoded as well, as may relate to key points or geometry for the various tokens with respect to the environment. The key points—indicated by lettered pairs in the string used to encode geometric coordinates in the environment—may be used to indicate geometric coordinates or bounds of a lane, or section of a lane, for example. Although the example text string is rather long (as may include thousands of tokens for a single environment), the text string provides the necessary information to perform tasks such as navigation or driver assistance in a much more compact form than if the data were a set of high resolution images or a high density point cloud representation of the environment. Although a single text string is illustrated, it should be understood that in at least one embodiment there may be multiple text strings generated to represent different portions or features of an environment. Also, different types of information can be used with a text string as is appropriate for a given environment in a specific embodiment. In this example, the text string is generated using a specific language, such as RTL. The language is structured so that the text string will be both discreet and sequential in its tokenized (one-dimensional) representation. In at least one embodiment, a generated text string can be auto-regressive in that an individual token in the string will depend in part upon the previous token(s) in the string. As mentioned, a language model can be trained using an unsupervised (or self-supervised) approach in order to be able to cover the wide variety of concepts needed, without the need for a very large and varied corpus of annotated training data. In at least one embodiment, even though the text string is tokenized and sequential, there can be few other structural limitations placed on the generation of the string in order to prevent those limitations from becoming a bottleneck that can negatively impact performance due in part to the large amount of input data that may need to be processed. The structure may be flexible, similar to how there can be many valid ways to flatten a map graph or object graph that are all equally valid. There may also be many different valid object graphs to represent the same environment, and the generation of a tokenized text string can have similar flexibility. This flexibility also helps the text string generation to be able to better update over time, as well as to scale to include larger or smaller numbers of tokens based at least in part upon changes in the relevant environment.

For tasks such as those related to autonomous vehicle or machine operation, for example, it can be important—if not critical for at least some types of operation—to have access to map data that is precise, accurate, and as up-to-date as possible. As mentioned, prior approaches are generally very expensive and time consuming, which often results in undesirable delays in updating of map data. In many instances, autonomous vehicles will capture data about a portion of an environment using one or more sensors, as discussed herein, and can analyze this data to perceive various types of information about the environment. This perception data can be compared against the relevant map data to make more accurate and/or confident determinations about the environment in which the vehicle is operating. Oftentimes, the perception data generated based on an instance or set of sensor data for a vehicle will differ from the corresponding map data. In some instances, this will be due to one or more changes to the environment that should be reflected in the map data, such as where the one or more lanes have changed, a new offramp has been opened, or a stop sign has been added to an intersection, among other such circumstances. In other instances, however, differences may be identified that should not be used to update the map data, such as where the sensor data was incomplete, noisy, or otherwise inaccurate. For example, another vehicle might be obstructing a view of a stop sign such that the perception data does not indicate the presence of a stop sign that is indicated in the map data. As another example, snow or other weather conditions might obscure the view of various lane markers or objects near the roadway. In other instances, a sensor may not be operating or calibrated properly, and may thus provide information or measurements that are incorrect, such that the perception data may indicate an incorrect location of an object, such as a lane marker, that does not match the location indicated in the map data. Further, an object such as a stop sign might be temporarily removed as a result of construction or a traffic accident that involved the sign, such that the stop sign indicated in the map data will not be present in the perception data. There can be various other situations where the map data and perception data may differ in any of a number of different ways.

In at least one embodiment, a map update system can attempt to identify any differences between the perception data and the map data, and analyze those differences to determine whether those differences might warrant a change to the respective map data (or any other related data pertaining to at least that portion of the environment). This may include attempting to determine a type of difference and/or reason for the difference, and then discarding any differences that are determined to not be of a type that might justify a change to the map data. For those differences that may warrant a change, update, or addition, a map update system or service in accordance with at least one embodiment can attempt to obtain additional data for the difference to attempt to establish, with at least a minimum level of confidence, whether there is an actual difference that warrants an update to the map data, as well as what that update should be with sufficient confidence and/or precision.

Approaches in accordance with various embodiments can overcome at least some of these and other such deficiencies in existing solutions for managing map data (or other environmental representations) for a physical environment. This can include identifying differences between map data and perception data (or other types of observational data) determined for a plurality of data instances, such as for data captured by each of a fleet of vehicles traveling through at least a portion of a physical environment. The perception data determined for an individual vehicle (or set of vehicles) can be analyzed and compared against the corresponding portion of map data reflecting a current location of the vehicle(s) in the physical environment. At least some identified differences can then be analyzed to determine whether updates should be made to at least that portion of the map data.

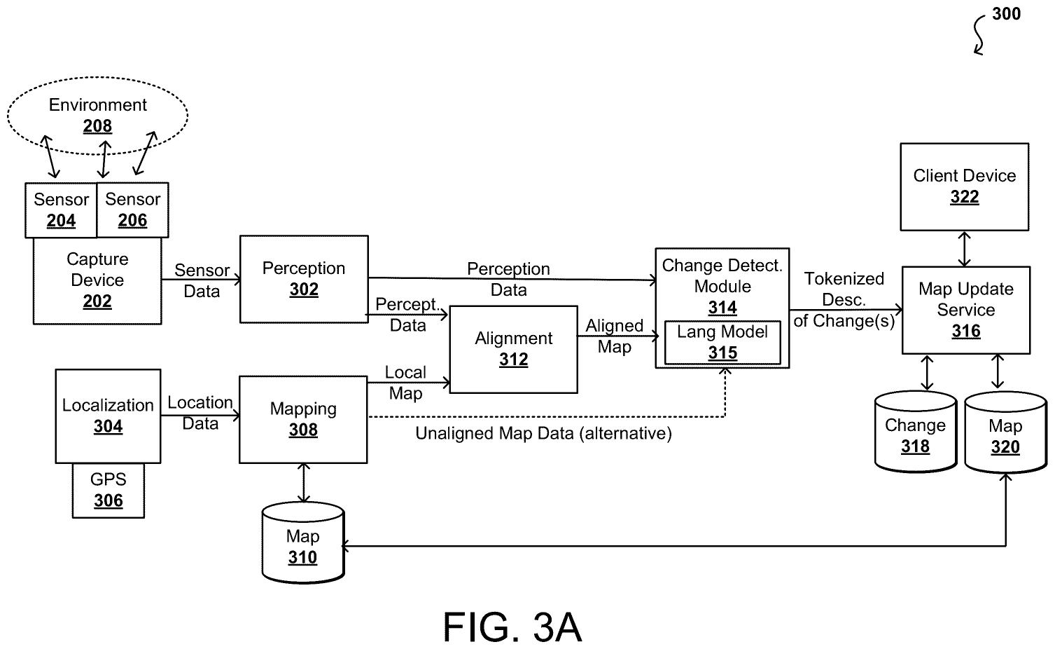

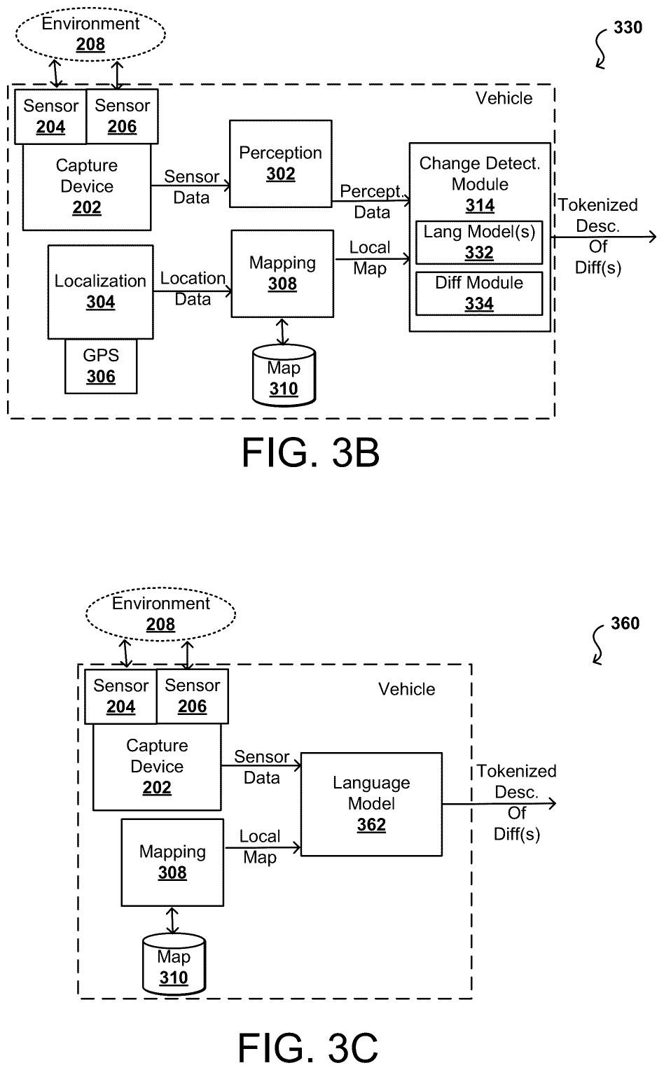

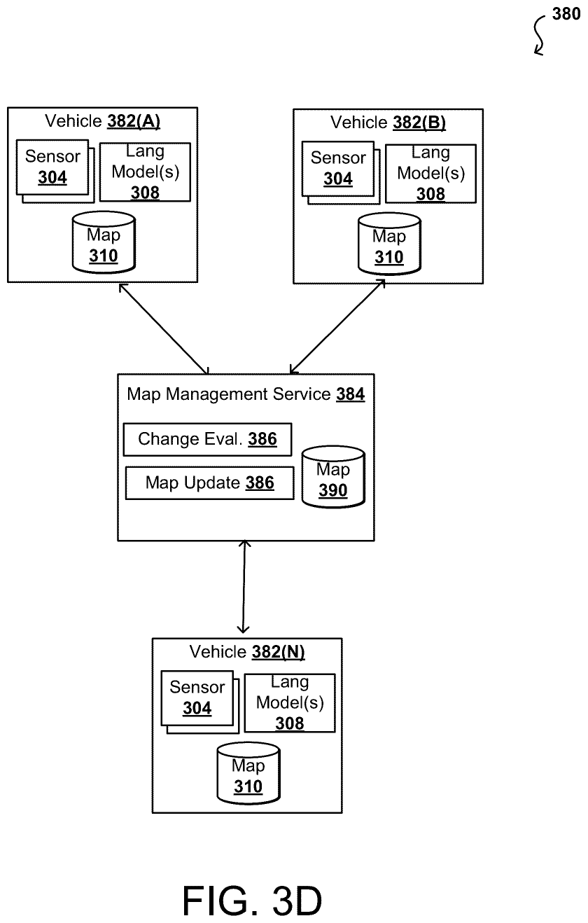

As an example, FIG. 3A illustrates an example system 300 that can be used in accordance with at least one embodiment. It should be understood that reference numbers can be carried over between figures for similar elements, but such usage should not be interpreted as a limitation on scope of the various embodiments. In this example, a capture device 202 including sensors 204, 206 to capture sensor data (or obtain other such observations) pertaining to an environment 208 using an approach such as that described with respect to FIG. 2A, although other mechanisms or approaches can be used to obtain such data as well within the scope of the various embodiments. Further, additional data can be used to attempt to perceive information about at least a portion of the environment 208 as discussed in more detail elsewhere herein.

In this example, sensor data from the capture device 202 (along with potentially other observations) is provided to a perception module 302. The capture device 202 may perform at least some amount of processing of the sensor data before providing it to the perception module 302, as may include noise reduction, aggregation, correlation, redundant data point removal, and the like. The sensor data may be provided in any appropriate form(s), as may include image data, 3D point cloud data, feature vectors, and so on. The perception module 302 can perform tasks including those discussed in more detail elsewhere herein, such as to extract features from the sensor data and attempt to identify objects in the environment, as well as to determine relevant information about those objects. Feature extraction or feature inference may be performed by an encoder in at least one embodiment to extract and encode features that may be relatively low-level and may not have a clear sematic meaning attached. The features may be used to generate a relatively universal and/or generic representation of the sensor data. The sensor or perception data can be interpreted and/or correlated in the cross-attention layer(s) of one or more neural network models. Such a model can attempt to correlate related features to allow objects to be represented using shapes, such as may be comprised of lines, triangles, or polygons, and can recognize and associate semantic information with the represented objects. In at least one embodiment, a model may analyze a feature vector including appearance information for an object, without any higher-level structure information, and attempt to determine various attributes relating to semantics, relationships, topology, geometry, and the like. An encoder thus may just attempt to represent the sensor data as faithfully and accurately as possible using a subset of points or embeddings, in a way that is friendly to downstream processing. A model (or other such component) receiving these features or embeddings can then attempt to make sense of these encodings using domain-specific knowledge.

Sensor data can be extracted and/or encoded in a number of different ways. For example, there may be one encoder per sensor so that each sensor can output a respective token stream that can be input to a model. A trained model can then fuse the information in the parallel streams with the map data as discussed herein. In other embodiments, sensor data fusion can be performed before generating the token stream. As an example, a point cloud representation of the environment around a vehicle can be generated using data captured by sensors around the vehicle, and this point cloud representation can be analyzed to generate the token stream. Correlation of the sensor data can be performed in such a way as calibration information for the sensors may already be available in many instances, such that position data can be determined with respect to a consistent coordinate system or frame of reference. The model can then analyze the consistent 3D representation to generate a single representative token stream in at least one embodiment. The correlation of the sensor data can also address issues relating to multi-modality, as any of a number of different approaches can be used to interpret and correlate data from different types of sensors. For example, algorithms are available that can correlate appearance features extracted from a camera image with position data obtained from a LiDAR system, etc.

In at least one embodiment, a perception module 302 may attempt to identify only specific objects of interest, or types of objects, in order to reduce environment perception to a more manageable task. For navigation of a vehicle, for example, this may include detection of static and/or dynamic objects relevant to driving, as may include lane boundaries, traffic signals, other vehicles on the roadway, pedestrians within a range of the vehicle, and so forth. The perception module may determine that there are static objects away from the roadway, or what are otherwise unlikely to impact navigation, and may either classify those objects as unimportant or exclude those objects from identification, among other such options. In at least one embodiment, the perception module 302 will attempt to determine at least a relevant position of specific types of objects with respect to the ego vehicle, if not an absolute position with respect to some geographic origin or reference plane, point, or coordinate system. For objects that may be in motion, such as vehicles on a same roadway as the ego vehicle, this may include a position at a specific point in time or a range of positions over a window of time, such as a window having a length corresponding to the capture or refresh rate of the relevant sensor(s) used to determine the position. For objects in motion, the perception module 302 may also attempt to determine a direction and/or rate of motion, such as velocity, acceleration, or deceleration, as may be based in part on position or motion information determined for a prior point or window in time. In at least one embodiment, a perception module 302 can produce an accurate recreation or representation of the environment in which the ego vehicle is operating, in order to allow a vehicle control system, process, or module to determine instructions for safely operating the vehicle within that environment to achieve a desired goal, such as to navigate the vehicle safely to a target destination.

As mentioned, in at least some embodiments a machine—such as an autonomous or semi-autonomous vehicle—can operate based on this perception data. In order to provide for a more accurate perception of at least a relevant portion of the environment 208, however, a system in accordance with at least one embodiment can attempt to augment or improve an accuracy of this perception data using local map information. In the example system 300 of FIG. 3A, a mapping module 308 can access map data stored to a map repository 310 or other such location. The map repository 310 may be available on the vehicle or accessible over a wireless data connection, for example, where relevant map data can be pre-fetched by the vehicle based on a current and/or anticipated location of the vehicle, such as for a given minimum distance of the vehicle or along a current navigation route. Pre-fetching can be used to attempt to ensure that the relevant map data is available even in the event that the wireless network connection is weak, spotty, or otherwise unreliable or unavailable in a given location or region. The mapping module 308 in this example can work with a localization module 304 to attempt to determine a current geographic location of the vehicle. The localization module 304 can contain, or communicate with, at least one system, sensor, device, component, process, service, or other such mechanism to determine a location of the ego vehicle. This may include, for example, use of a GPS system 306 that uses satellite-based radio signals to perform geolocation anywhere a sufficiently strong signal is able to be received from at least a minimum number of satellites, such as at least three or four satellites. A benefit of GPS is that it can be highly accurate, does not require an outgoing data transmission from the ego vehicle, and does not require an active network connection, such as an Internet or cellular connection.

In at least one embodiment, the current geolocation provided by the localization module 304 can be used to determine local map data from a map repository 310, using a mapping module 308, and this local map data may be provided, along with the perception data, to a change detection module 314, which can include (or otherwise utilize) a language model 315 to perform change detection. It might be the case, however, that the location data provided by the localization module 304 is not sufficiently accurate and/or provided with at least a minimum level of confidence. For example, a GPS system must generally have an unobstructed transmission path from the minimum number of satellites, however, which may not be possible in certain locations, such as cities with tall buildings, tunnels, or mountainous regions. Other geolocation mechanisms can be used as well in other embodiments, such as those that make determinations based at least in part upon signals transmitted from earth or recognizable features in the nearby environment 208, among other such options. A GPS receiver will typically be on the vehicle while other approaches might use components not on the vehicle, although latency and connectivity can then become problematic in certain situations. In at least one embodiment, the localization module 304 can attempt to improve or stabilize the location data from the GPS (or other such system) using other available information, such as the velocity and direction of travel of the vehicle, the locations of nearby objects, signal noise reduction, and so on. In this example, the mapping module 308 can receive geolocation data from the localization module 304, and can determine the current location of the ego vehicle with respect to the stored map data. In at least one embodiment, this can be used to obtain and/or pre-fetch local map data for a current geolocation of the ego vehicle.

In at least one embodiment, at least a selected portion of the perception data from the perception module 302, and the geolocation and/or local map data from the mapping module 308, can be provided as input to an alignment module 312 to attempt to improve the accuracy of the geolocation data, or at least to better align the local map data with the perception data. The alignment module 312 can attempt to “align” the perception data and the mapping data to provide a more accurate and reliable interpretation of the location and surroundings of the ego vehicle. Approaches to alignment can involve various SLAM-based approaches, for example, where simultaneous localization and mapping is performed using data obtained from one or more perception modules and/or sensors, such as cameras or LiDAR sensors. Such approaches can be used to attempt to detect, classify, and track objects in a dynamic environment, based in part upon movement of the ego vehicle and/or the detected objects. As mentioned, however, such approaches typically require highly accurate geolocation and/or map data, as well as sufficient perception data to allow for proper alignment. Issues such as obstructed objects or features in the environment can also prevent perception data to be reported with a sufficient level of confidence.

Approaches in accordance with at least one embodiment allow for aligning available map and perception data, which can provide for a more robust localization than various prior approaches. In at least one embodiment, local map information is retrieved for an approximate geographic location, such as may be determined using a localization module. The local map data can then be matched and aligned with perception results based in part on, for example, static landmark features such as traffic signs, traffic signals, poles, crosswalks, stop and yield lines, lane dividers, or curbs, among other such options. Such alignment can lead to robust localization of the ego vehicle, such as where a GPS signal or data may be unreliable or unavailable. Such approaches avoid the need for highly precise location determination components, as a general location can be sufficient to correlate or align local map data with what is identified in the perception data. As an example, a location in an urban environment may be determinable only to within a four block region, but static objects identified in the perception data can be used to determine, more precisely, where a vehicle is within that four block region. Once the location is properly determined and the local map data aligned with the perception data, that data can be considered together to generate a more accurate and consistent representation of at least that portion of the environment. In some systems a location determination might not be available at all, but past geolocation information and motion information about the vehicle can be used to infer an approximate location, and localized map data for that approximate location can then be aligned with the current or most recent perception data.

In at least one embodiment, aligned map data can be used as a prior of the surrounding environment. Obtained sensor data or other observations can be fused together and used to detect or infer static and/or dynamic objects. These results can be treated as a likelihood function of these objects given the surrounding environment. A language model, or other language-based generative model such as an LLM, can take both aligned map data and detection result data as input, and can produce an updated description of the surrounding environment. In at least one embodiment, this description can be in the format of a tokenized description, or string of text-based tokens, in a domain-specific language, such as RTL. The geolocation of the ego car can also be updated based in part on the updated information.

Such a framework can provide several advantages over previous solutions. As an example, such a framework can fuse map and perception modules organically with a neural network, such as a language model, that is able to enforce spatial consistency and semantic structure(s) learned from the map data. The map information can help the perception module to infer occluded map features and boost ambiguous map features that a detection algorithm or process of the perception module may not be able to report with confidence. An advantage of using language models is that these models can be trained using large quantities of map data, comprising not only the final, accurate maps but also the intermediate data on how human operators corrected errors in the initial maps. A language model can learn the natural signature of natural maps using a domain-specific language, and this trained language model can then be used to assist in performing perception-related tasks.

In this example, the perception data and the local map data (aligned or unaligned) can be provided as input to a change detection module 314. The change detection module 314 can attempt to analyze corresponding pairs of local map data and perception data, such as for specific time stamps and locations of an individual vehicle, and identify differences between the map and perception data. The change detection module 314 can then provide information about any or all detected differences, such as at least those that are determined to potentially be of a type or extent that may warrant a change to at least the local map data.

In at least one embodiment, the change detection module 314 can use a language model 315 that is trained to understand identify and correlate objects and features represented in the map data and/or the perception data. A language model can also be trained to recognize aspects such as road entities and relationships, for example, and can use this understanding to infer and/or correct relationships, as well as to infer where entities are missing or should be present, as well as whether the entities are located in an unexpected location or differ in location between the map data and the perception data, among other such aspects. Such knowledge can be built in part by presenting a deep learning model with millions of examples of valid map documents containing a representation of the road in a tokenized representation in a domain-specific language, such as RTL. In many instances a given map document will encode only a small local section of an overall map for an environment, where that section may relate to an intersection or other such feature. Such an approach can be to what a driver may conceptualize at a single instant in time based on what would be visible to them. The language model can be trained to generate and/or complete these documents, such as where at least a portion of a document is provided as input and the model can use its knowledge to fill in any gaps, make appropriate corrections, or otherwise augment the document. A trained language model 315 can also perform similar operations for the perception data, such as to perform gap filling or augmentation based in part upon learnings obtained by the model during training, as well as relationships, semantic information, and other data inferred from the perception data and/or local map data.

In at least one embodiment, a language model 315 can be trained to correlate and compare objects or features in the map data and the perception data, and to identify differences. In at least one embodiment, the differences identified by the language model 315 can be received by the change detection module 314, which can then transmit a description of the differences to a map update service 316. The map update service 316 may be hosted on one or more cloud resources available across at least one network, for example, and can receive information about differences detected by multiple vehicles and/or other such sources. The map update service 316 can attempt to determine, as discussed in more detail elsewhere herein, whether any of the differences warrant updating of, or other modification to, the map data. This may involve, for example, storing data for differences or potential changes to a change repository 318, for example, until a determination can be made to either make or discard the change (or a related change). This can include updating or modifying map data stored to a map repository 320, with the updated map data then being transmitted to, or otherwise obtained by, a mapping module 308 of a vehicle or other device or system, and stored as current map data to a local map repository 310. In other embodiments, the language model 315 of the change detection module 314 on a vehicle might generate a description of one or more potential changes inferred based on detected differences in the map data and perception data, and the map update service 316 can analyze the proposed change data as received from one or more sources. If an insufficient number of data points are received for the change over a period of time, or if an insufficient number or fraction of vehicles travelling through that portion of the environment suggests a similar change, then the proposed change can be discarded, archived, or otherwise handled by a process other than implementation. If update map data is generated, that map data can be propagated, or at least made available to, any or all vehicles, devices, or systems that utilize that map data and should have access to an updated copy.

In at least one embodiment, a process for identifying map updates to be made, and then performing those map updates and making the updates map data available, can require minimal latency or processing time, in order to ensure that vehicles or other devices or systems are not operating with outdated map data (or other such representation). The ability to quickly identify and process information about differences and potential changes can be improved by using text-based representations, such as tokenized descriptions of the inferred differences or proposed changes, that can include very detailed and relevant information but also can be very discrete and compact in nature. In at least one embodiment, a language model 315 can be trained to output a tokenized description in a domain-specific language that is relevant to the operation to be performed, such as a road- or navigation specific language, such as RTL described in more detail elsewhere herein. The language model 315 can receive map and perception data in any appropriate format, which in some embodiments may also comprise tokenized descriptions in a domain-specific language. The language model 315 can infer one or more differences, and may generate a tokenized description of these differences, or may generate a tokenized description of proposed changes to the map data based in part upon the corresponding perception data. The proposed changes may be used to update a navigation plan relative to the road, as well as being transmitted to a map update service or other such recipient to potentially update a global set of map data for at least a relevant portion of the physical environment.

The example system 300 illustrated in FIG. 3A allows for map updates to be performed using a moderated and/or automated process. For example, an expert or trained human user might be able to use a client device 322 to review changes proposed or managed by the map update service 316. This may include the map update service making at least an initial pass over the proposed changes from the various vehicles, or changes determined from the received difference information, in order to retain or recommend only those that satisfy at least one map change criterion or threshold. Such a criterion may include, for example, a type of change to be represented in the map data, such as the change in a number of lanes versus a change in sidewalk width or placement. The change criterion may also include at least a minimum distance or extent of the change, which may depend in part upon the type of change. For example, if a roadway gets repaved and the lane markers shift by a couple inches, then the change may not warrant a change to the global map data. If a lane has been rerouted by several feet, however, then that may be sufficient to satisfy a change criterion and warrant a map update. In some embodiments, a change criterion might include a number or frequency of similar suggestions, or at least a minimum confidence in the suggestions. For example, if twenty cars drive by the same location in a day and less than 15 of them identify the change, then the potential change may be discarded, or may be stored for up to a maximum amount of time until a confident decision can be generated with respect to the proposed change. In some embodiments, the fact that something is not present in the perception data does not necessarily mean that the map data should be updated. For example, an object might be obscured with respect to the sensors, such that the object will not show up in the sensor data, and thus the perception data, but that does not mean that the object is not still in the expected location. In other embodiments, a traffic sign such as a stop sign might get taken down due to an accident or construction, but the language model may be able to determine based in part upon other information that vehicles should still stop at that location, and may thus determine not to update the map data. There may be various other criteria or situations applicable as well within the scope of the various embodiments.

In a moderated system, the map update service 316 can provide information for proposed changes for human review. The human can then determine whether to implement or discard the change, or whether additional information is needed. The human may also provide input or approval as to the type of change. For example, the map update service 316 might provide a recommended change to the map data with information about the change, but the human expert might instead make a different change to the map that is more appropriate and/or clear based in part on the provided description. Having a human in the loop may be required for certain operations or per certain regulations, such as for L3 or higher levels of automation. In some embodiments, there may be certain changes that may be made without human review. For example, the exact placement of a stop sign near an intersection or update in speed limit based on clearly posted speed limit signs (identifiable with high confidence) may be able to be updated automatically. In other embodiments, any change to be made to a map may be able to be made automatically, as long as the changes are preceded by at least some minimum amount of automated consistency and/or validity checks or processing.

A language model 315 can have an understanding of the domain-specific language, as well as what constitutes a valid and/or complete map. Such a model can be applied to a variety of domain-related tasks, as may include improving map data for an environment based in part on perception data, as well as improving the accuracy of the perception data itself. Perception can be a very complex task in general, but additional complexity can result from its use for tasks such as autonomous navigation where perception must be done to a highly accurate level in real time. As illustrated in FIG. 3A, a perception module 302 can attempt to understand or map its environment based at least in part on data from a set of sensor inputs, as may include a single camera frame, a video snippet from a single camera, or up to a sequence of frames from several sensors of various types (e.g., camera, LiDAR, radar, or sonar), among other such options.

Approaches in accordance with at least one embodiment can produce representations of different portions of the map data for an environment in real time by, in part, representing the map data using a tokenized description that is lightweight and can be processed using a trained language model. A language model can also be trained to generate, update, or augment a tokenized description of significantly higher complexity than would be produced from map data along, or by a typical perception model that focuses on limited tasks, such as recognizing the lane lines or traffic signs in a portion of an environment. A language model in accordance with at least one embodiment can perform these and other such tasks, including organizing perceived objects relationally and topologically, as well as annotating them with rules into a representation of the road which can be acted upon by, for example, an autonomous vehicle system. For an autonomous vehicle to act, the vehicle in many instances will need to understand the concepts of the road (or other navigation region), including the rules and the current state of the road. The use of the same (or a different) language model 315 to generate a tokenized description of an environment, as well as to generate a tokenized representation of inferred changes or proposed differences, can help to greatly improve the quality of the downstream operations by leveraging a more robust and complete understanding of environment including the road(s) to be navigated. In at least one embodiment, a sensor deep learning trunk can focus on sensor feature inference, and one or more sensor-to-map layers can focus on how to organize those into a map. The language model 315 can then push towards maps that conform to how maps are understood to work, and can guide subsequent sensor-to-map layers towards a consistent, coherent, and current map representation of an observed road. Such an approach provides advantages over prior approaches that relied heavily on existing HD maps for L4 navigation tasks, for example, instead using the sensor data primarily to detect and avoid dynamic objects, such as pedestrians or other vehicles. Other approaches have attempted to perform a mapless (or primarily mapless) type of perception where both static and dynamic obstacles are detected from the sensor data, but such approaches can be limited in accuracy due to factors such as line of sight an environmental conditions, as well as limits on accurate determinations of complex information in real time due in part to limited processing capacity, memory, and other such factors. Approaches in accordance with various embodiments presented herein leverage map data, where available, to provide for more accurate and robust environment determinations, which can be used to infer appropriate changes to be made to map data representative of that environment.

As illustrated in FIG. 3A, a trained language model 315 can take both perception data and map data as input. Other types of input can be provided as well, as discussed in more detail elsewhere herein. The map data, particularly if aligned, can help to improve the accuracy of determinations made based at least in part on the perception data, as well as to potentially augment the data to be used for the determinations with information that may not have been able to be perceived from the sensor data alone, or that may not have been able to be perceived with sufficient confidence without confirmation from the aligned map data. The ability to use a lightweight, compact, and robust representation of the perception and map data, such as in the form of a tokenized description in a domain-specific language, can allow for more complete and complex perception results for an environment to be generated in situations with potentially limited computing resources, such as on board an autonomous vehicle, in real time as needed for autonomous operation. Such an approach can also allow for a natural integration with a current perception stack, as may be transformer-based in at least one embodiment. The ability to augment the perception data using a language model can also allow for more conceptual understanding of the sensor data and the information inferred or perceived from that sensor data.

Current perception modules do not offer or provide a higher-level understanding of the relationships or semantics of, and between, various objects in an environment, and thus are limited in their ability to provide complete and robust perception determinations. This higher-level understanding can help to ensure that map data representative of the environment is updated in accurate and necessary ways based at least in part upon highly accurate perception data and difference determinations.

A language model can also be flexible in the way in which information is aggregated from the input map and/or perception data as the language model can use a larger context window. With more information available, the language model can select the important information based on relationships, semantics, or other such aspects, without being constrained by a specific rule or fixed value, such as to only consider objects within 30 feet of the vehicle or that will be within a specified proximity of the vehicle in the next 30 seconds, etc. The ability to grab and use additional information as needed can also make the tokenized description more expressive and robust than other perception representations, and can therefore be of more benefit when attempting to determine changes to be made to existing map data based upon differences identified with respect to the perception data.

In at least one embodiment, a tokenized description can stores information about objects in a nearby portion of an environment that are relevant to a particular task. For vehicle navigation, these may include object relevant to driving. The information can be encoded using a domain-specific language, such as RTL. The perception data generated by a perception module 302 may be in a different format, such as a very dense but low-level representation of a portion of an environment in a 2D bird's eye view. The perception data may not include any, or at least a full set of, semantic labels for objects in the environment, while the map data may already include the relevant semantic labels. In order to be able to apply the labels from the map data to the perception data, the map data needs to be aligned with the perception data. The aligned map data and the perception data can both be provided as input to a language model 315, which can perform the correlation, apply semantics, relationships, and other relevant information or aspects, and generate a more detailed tokenized description of the environment, which can be in the same, or a different, domain-specific language. In at least one embodiment, the matching or correlation of the map data and perception data can be performed implicitly through cross-attention layers of the language model 315. The output, augmented perception data can then be a tokenized description of the environment that has been generated based in part upon the fusing of the map data with the real-time perception data. This can be thought of as prompting the language model to describe the sensor input in a way that is consistent with the map data. The augmented tokenized description will then be a more complete and accurate representation of the surrounding environment than the map or perception data alone, while still being a discrete and compact representation that is relatively lightweight. This can then be compared against the existing map data to determine where actionable differences may occur.

In at least one embodiment, a tokenized description or representation does not need to include decoded information in the individual tokens. For example, an object might be associated with many tokens that store information for different aspects of that token. In some embodiments, the text within a given token of a token string or sequence can be in a human readable language and easily understandable by a human reader. In some embodiments, the information in a given token may also, or alternatively, be in a textual representation, but not in a human-readable language. For example, a textual encoding can be used for these various aspects, and the textual encoding can be stored to individual tokens. A human reader accessing a token may then not be able to interpret the textual information, but such information can be understood by a system able to decode and/or understand the textual encodings, as well as a language model that is to produce and/or process the textual encodings of various tokens. In some embodiments a final tokenized representation may be in a domain-specific language that should be understandable to a human reader, for example, but intermediate or other such tokenized descriptions or representations may be in other languages, as may include encodings or other such textual components. In at least one embodiment, a model may be trained to take encoded tokens as input and output tokens in a domain-specific language that is human understandable, among other such options. As mentioned, a language model can take input in various other forms as well, as may include feature and/or embedding vectors, points in a latent space, raw sensor data, and so forth. A final output representation in a domain-specific language can then be used to perform various operations, such as to provide for a visualization of at least a portion of an environment in 3D space.

In some instances, the sensor data may be unreliable, such as where an obstruction might prevent sensor data from being captured for an object that is represented in the map data. In other instances, there may be an object detected by the sensors that is not represented in the map data. Further still, there may have been a change or update to the environment since the map data was generated or updated, as may relate to a temporary change—as may be due to construction or an event—or a more permanent change, such as an addition of another lane to a roadway or a modification of a turn lane at an intersection, among other such options. An advantage of using a trained model—such as a language model—to align and compare the map and perception data is that there is no need for a large set of explicit rules to handle the wide variety of potential differences that may arise. A language model can be trained to output what the model believes to be the most confident difference result based at least in part on the received input data. In at least one embodiment, a model used for aligning and/or comparing the map and perception data can perform a type of implicit localization, where the model can attempt to use its learnings to infer the most likely alignment and/or localization result. A language model receiving input in the form of a tokenized description as described herein can benefit from the inclusion of semantic, relationship, topology, geometry, and other such information in the representation to better infer a consistent output. For example, if the map data and the sensor data represent a turn lane to start in different locations, the language model can process the map data and sensor data using relationship information for other objects in the scene, such as the placement of signs, signals, and other vehicles, to infer a mostly likely starting point for the lane, based in part upon its learning from other, similar roadways and environments. While sensor data may be more up-to-date than the map data, the sensor data may also be more susceptible to factors such as noise, environmental conditions, obstructions, and the like. The model can take all the available information, including semantics and relationships, and infer the most likely representation based on the information and its learnings from training data for similar locations.

There are several advantages to such an approach, with respect to prior approaches to generating and/or updating map data. As an example, such an approach can provide higher quality data by understanding the semantic and relationships of various objects in an environment, which allows for more accurate representations of the environment to be generated that are both compact and discrete. A relatively small number of cars can be used to collect data, using various high-quality sensors, and use that data to construct a base map with high geometric precision. Once generated, a larger number of cars can be used to capture sensor data for the environment using lower-cost sensors. This sensor data can be received over a wide spatial coverage area, including a relatively high frequency of data capture for individual portions of a physical environment. As mentioned, the sensor data (or resulting perception data) can be compared against the map data using relatively lightweight text-based descriptions that allow for fast and robust difference determinations. By having a significant number of vehicles all collect data supporting a given difference between the map and perception data, a relatively high confidence can be obtained for that difference, which can be used to determine whether to update the respective map data, as well as how to accurately update the map data. As mentioned, a map can be represented as one or more compact graphs of discrete map elements, which can be stored using on-board memory or data storage of various vehicles. The compact graph representations can also be integrated with a perception module, system, or process to allow for highly-efficient change detection, such as may utilize a dedicated change detection module or service.

In at least one embodiment, proposed changes to map data can be expressed as sequences of tokens representing semantic and geometric information of landmarks and their relationships. Map changes expressed as token sequences can be ingested by a language model, such as may use a domain-specific language, that can take the base map, previous changes in the same area, knowledge of implicit structural regularities of maps learned from training data, and any other contextual information into consideration, and can output an update-to-date, high-quality and coherent map that also aligns with the base map. In addition to a perception module that can infer a tokenized description of a map from sensor data—including optionally a prior localized map—a dedicated deep neural network (DNN) can be used to focus on the presence of changes in a map, without necessarily inferring the update(s) to be performed corresponding to those changes. Such a change detection DNN can be used as a strong signal that the map needs to be updated, as well as a signal that certain parts of the map should be considered unreliable for subsequent usage in, for example, an AV pipeline. Outputs from such a DNN can be shared with a cloud update service, for example, to make determination about the vehicles from which to pull data to support the update, including sensor data to enable human moderation of the change when high map-quality levels are required. In at least one embodiment, the outputs from the DNN can indicate one or more portions of the map data—such as in the map graph or tokenized description—that may be appropriate to add, remove, or modify, along with a confidence level or other such metric. In at least one embodiment, a change detection task may only need a strong signal where false positives are acceptable but false negatives are to be avoided. As mentioned, a language model trained in a domain-specific language can be capable of learning implicit structural regularities from existing maps, as well as taking both the base map and map changes to output an updated map. For autonomous vehicles, this may involve the application of a language such as the road topology language (RTL) to encode map information. Such a model can support efficient exchange of information between cars and a central service, as well as flexible ways to handle map changes, alignment with the base map, and fusion of various types of information.

In at least one embodiment, there may be a large number of vehicles—such as consumer owned or operated vehicles—that each are able to transmit data to a central map management service, or other such recipient. FIG. 3B illustrates an example of one such vehicle 330, which as illustrated contains both a perception module 302 for generating perception data for a current location, as well as a mapping module 308 for determining local map data corresponding to that location. Each car can also include at least one language model 332 that is able to generate a tokenized description of the mapping data and/or the perception data. In at least one embodiment, there may be tokenized descriptions generated for both the perception data and the map data, and these tokenized descriptions (in the same domain-specific language) can be fed as input to a difference determining (or “diff”) module 334, which can determine differences between the tokenized descriptions. The change detection module can then determine which of these differences to transmit to the central map management service. In at least one embodiment, another language model 332 can generate a tokenized description of the differences to send to the centralized service, while in at least one embodiment the difference module may include (or comprise) another trained language model that can take in the map and perception data as tokenized descriptions, and then output the differences as tokenized descriptions. In let another embodiment, there may be a single language model 332 that takes the map data and perception data as input, in tokenized description form or otherwise, then outputs a tokenized description of the differences, among other such options. Each vehicle can then send inferred differences based in part upon the localized ego-centric representation that each vehicle generates with respect to the portion of the environment in which it is located and/or operating. In at least some embodiments, differences will be uploaded that satisfy at least one difference or importance criterion, such as being of a certain object type, difference type, or extent, etc. A cloud-based map management service, for example, can then analyze the difference information received from the various vehicles, and determine an extent to which the vehicles are reporting similar differences for similar locations, which may warrant updates to the map data, with any updated map data then being transmitted back, or at least made available to, those vehicles and other such recipients. In at least one embodiment, the updated map data, or data to be used to update locally-stored map data, can be transmitted as one or more tokenized descriptions generated by one or more language models.

In at least one embodiment, at least some vehicles (or other sources of difference data) can have at least one trained language model 362 that can directly output a tokenized description of inferred differences, as illustrated in the example vehicle 360 of FIG. 3C. In this example, the captured sensor data can be fed directly as input to a language model 362. The sensor data can be in raw data form, or a different form after processing as discussed elsewhere herein, including a tokenized description in at least one embodiment. The language model 362 can also receive map data as input, which may also be in a tokenized description format. The tokenized description may be compact enough that the language model may be able to take in all local map data for an environment, or may take in map data for a portion of that environment based upon determined position and/or localization information as discussed previously, among other such options. The language model 362 can be trained to analyze the input data and infer differences (at least of a type or extent for which the model is trained) to be output in a tokenized description in a domain-specific language. The tokenized descriptions of differences determined from the various vehicles can be transmitted to the map management service or other appropriate recipient or destination. In at least one embodiment, such a tokenized description may include change- or difference-specific tokens, such as tokens that specify the delta or information about the change, including the type and extent of the change, the location of the change, semantic information about the change, relationships that may be impacted by the change, and so forth. If the tokenized description includes proposed changes, the tokens may specify the action to take as well, as may relate to adding, moving, removing, or replacing a specific feature. The tokens may also include uncertainties or confidence levels for the inferred differences or proposed changes, such that a map management system receiving these descriptions from multiple vehicles can make a more accurate determination of how much to rely on various representations of the same region of an environment, as well as how to reconcile those differences in a consistent way.

As illustrated in the example network-based system 380 of FIG. 3D, there can be multiple vehicles 382(A)-(N) that can all transmit vehicle-determined difference information to a map management service 384, which may be hosted using one or more computing resources—such as cloud resources—across at least one network, such as a cellular network, peer network, or the Internet. Each of these vehicles 382(A)-(N) can include one or more sensors 304 for capturing live sensor data and one or more map repositories 310 for storing local map information. Each vehicle can also use at least one local language model 308 to analyze the sensor data (or corresponding perception data) and map data and determine differences that can be written to a tokenized description in a domain-specific language, and transmitted to a destination—such as a port or interface with a specific network address—associated with the map management service 384. The map management service 384 can analyze the difference data from the various vehicles using a change evaluation module 386, for example, which can correlate data for corresponding differences, and can identify changes that satisfy the relevant change criteria. These can include, for example, changes of a type that are determined to be at least important to a specific operation, that reflect at least a minimum amount of change, and/or that can be determined with at least a minimum level of confidence, among other such criteria. If such a change is identified, data for the change can be sent to a map update module 388, for example, that can attempt to determine how to best represent the change in the map data. In some embodiments this may be performed automatically, while in other embodiments such a change may require review and approval from a human reviewer. There can be a set of basic rules to generating a map that can be followed, or a trained generative model can be used to generate an updated map based on the prior map and change data, among other such options. Once the updated map data is generated, the updated map data can be stored to a master map repository 390, for example, with the updated map data (or at least notification of the update(s)) being propagated to the various vehicles. In some embodiments the updates may get pushed to all vehicles or vehicles within a same general region, while in other embodiments the updates or updated map data may get pushed only to those vehicles determined to have at least a minimum likelihood of passing through that region in an upcoming period of time, among other such options.

An advantage of transmitting the differences in a tokenized description in a domain-specific language, other than the compact and discrete nature, is that the descriptions received from the various vehicles can all be in a similar format and language, which can make aggregating and analyzing the various descriptions faster and less compute intensive than approaches where difference information might be received in different formats or languages, with different difference types or levels of precision, which may then require processing such as reformatting, translation, and normalization, etc. In some embodiments, a map management service might utilize a separate component to quickly analyze the received descriptions and decide which ones are sufficiently reliable or otherwise should be considered based on one or more selection criteria, which may take the form of another head on a trained language model that is trained for this specific task.

In at least one embodiment, a language model can be trained to receive raw sensor data as input, in at least a number of different formats. The sensor data may alternatively include features extracted from the sensor data, which may be in the form of embeddings, feature vectors, or points in a latent space, among other such options. The model can also take in map data, which may be in various formats or may be in a tokenized description in a domain-specific language, among other such options. The model may also (or alternatively) take at least a relevant portion of the perception data as additional input. In at least one embodiment, the model can take in the lower level sensor data before (or separate from) decisions have been made about perceptions drawn from that sensor data. The ability to directly analyze the sensor data in the language model can help to make the results less noisy by avoiding, or at least reducing, the presence of perception error. The model can make its own type of perception-like inferences, which can then be compared against the local map data to attempt to identify relevant differences, which are limited in scope to that information that is represented in a relevant portion of the map data. Such an approach allows for exclusion of highly variable data or data that is not essential to the map, or at least the local map. The model can thus be trained to recognize when the sensor data does not support the critical (or at least relevant) information contained in the local map data.

The language model can be trained to recognize different types of changes, updates, or differences as well. For example, if the map data is viewed as an object graph then there can be changes that impact nodes and there can be changes that impact edges. For example, if an express lane is added to a highway then that may create a new object in the graph. If the location of a lane marker shifts, or there is another topological change, then that may modify an edge of the graph, or an aspect of one of the nodes. There may also be changes at different granularities, and a model can be trained to recognize these at the various levels of granularity, which may also correspond to different embedding vectors for the respective features. Such an approach can allow a model to identify a missing node, edge, or sub-graph, in addition to changes in aspects of those graph features. A difference determination can also analyze the data at these various granularities. In at least one embodiment, feature vectors (or other such representations) can be analyzed from the top town. If there are no changes detected at a local map level, then there is no need to drill down to more granular feature vectors or representations. If a change is detected, then the investigation can occur at finer levels of granularity (or lower levels of a feature hierarchy) until the precise change or difference is identified, and then a determination can be made as to whether an update to the map data is warranted. There may be a minimum level of granularity or detail, however, because the ability for a lane to still be valid for driving or operating a vehicle only requires so much detail or precision, and changes finer than that may not impact the overall ability to drive in that lane or warrant a change to the map data. A determination can be made as to whether the current map data can be used as a valid prior for operation, and if not then a change is likely warranted.

In at least one embodiment, training data for such models can be generated by moving, adding, removing, or modifying aspects of the map data or portions of the sensor data, and then providing an appropriate difference and/or change recommendation. This can be performed at varying levels of granularity, and the outcome may also depend in part upon factors such as the type of operation to be performed or even the type of vehicle, as an e-bike can have very different operating characteristics and requirements than a tractor trailer, etc.

Another advantage to determining differences on the individual vehicles in real time, based on live sensor data, is that the vehicle can make better decisions as to which data to use to make operational decisions, or an extent to which to rely upon the different types of data. For example, if there is an obstruction preventing the sensors of a vehicle from detecting a lane line or traffic signal, but based on the map data or other perception data the lane line or traffic signal should be there, then the vehicle can rely more heavily on the map data or other perception data in determining how to navigate this portion of the roadway. If, however, the map data indicates that there is a turn lane but the sensor data indicates, with high confidence, that the turn lane is no longer there or otherwise not currently usable, then the vehicle can rely more on the sensor data and avoid using the turn lane indicated by the map data. Different levels of confidence for different types of differences can be used to help determine which data is more reliable at a given time and use that data to make better decisions or inferences in operation. In some embodiments, if a diff module determines with high confidence that there is a change that may warrant an update to the map, the vehicle may then rely (fully or primarily) upon the perception data for operation at, or near, the current location, at least with respect to the inferred change.

In at least one embodiment, there may be at least some advantages to using a separate language model for change detection as change detection may be a less complex task that can be performed relatively quickly. A perception module can accurately determine information about a current region of an environment based in part on the live sensor data, and then the change detection model can relatively quickly compare that against the corresponding map data to determine differences. Trying to do perception and change detection at the same time using the same model can come with additional complexities and potential for error when trying to perform various tasks simultaneously with separate convergence criteria, etc. A separate change detection model may also be able to be trained more accurately and reliably than a model that performs complex tasks in addition to change detection.

As mentioned, a change detection model can also be trained to focus only (or at least primarily) on those objects, features, or aspects of the environment that are critical to operation or performance of a domain-specific tasks. For example, a model can focus first on the lane in which a vehicle is located, as well as any objects within a given distance that are relevant to that lane, followed by nearby lanes or upcoming intersections, etc. The model may not focus on aspects of buildings or billboards off the side of the road, objects in the same lane but far off in the distance, or other aspects that are not critical for operation of the vehicle over a current point and upcoming period of time. In at least one embodiment, a tokenized description of the perception data might only include tokens relevant to these objects, aspects, or features, which can help to make the descriptions more discrete, compact, and relevant to the specific task. Similarly, a tokenized description of the local map data might only include those features or aspects of the map that are determined to be critical to operation of the vehicle at a current point and upcoming period of time.

In at least one embodiment, change detection can include a temporal aspect at least for vehicles or devices in motion. For example, a sensor might not detect a stop sign in a first sequence of frames, but may detect the stop sign in a subsequent series of frames, such as where an obstruction has moved or the sensor data is determined to have a higher level of accuracy. Since the stop sign is eventually detected, the vehicle should not send a change recommendation to the map management service based on the data from the initial sequence of frames. Thus, in at least some embodiments a change detection module will analyze the sensor and/or perception data over time, such as while within a potential viewable range of the stop sign, and only recommend a change if the stop sign (or other change) is not detected over that range of time. In some embodiments, the change detection module might also only recommend a change if the module can determine, with at least a minimum level of confidence or certainty, that at least one of the image frames or other instances of sensor data was unobstructed or otherwise should have been able to detect the stop sign if it were still there. Such analysis can be performed over a sliding window of time or distance, among other such options. Further, if a change is not detected consistently over a number of frames or time stamps, then the change detection module may not suggest a change, or may only provide an indication that a difference was detected, which may then be used with change recommendations from other vehicles or at other points in time. In some embodiments, since the tokenized descriptions are relatively lightweight and there will be significantly more processing capacity in the cloud, the vehicles may defer to transmitting a larger amount of difference information that may or may not be critical, then allowing the cloud-based processing to make more accurate determinations based upon a larger available data set from the various vehicles (and other sources). For example, a change may not be determinable with minimum confidence on any given vehicle, but if a large number of vehicles are identifying the same change then in aggregate there may be enough data to generate sufficient confidence to make a change to the map data. The cloud-based process with access to the larger data set might also be able to make a better determination as to the type of change to make based on the perception from the various vehicles. In some embodiments, a map management service or change detection service might also request specific additional information from vehicles when in, or near, a potential change region, to attempt to obtain information that can help to make a more confident or informed decision. A vehicle may then use a data capture mode with higher precision or frequency, for example, to attempt to provide more accurate or precise information. In some embodiments the vehicle may send some of the raw sensor data up to the cloud to allow for more accurate determinations, but such an approach may have to take into account privacy and other data transmission restrictions, and thus may only be permitted to send certain types of data, or data for certain types of objects, etc. In at least one embodiment, a map management module can also send data to a human expert to review or analyze if a determination cannot be made automatically with at least a sufficient or minimum level of confidence. In at least one embodiment, a vehicle can also include a text-to-speech component (or similar mechanism) that allows a question for further information to be asked of an occupant of a vehicle, and any response from the occupant can be used in attempting to determine whether to make a change, at least to the extent the response is reliable or provided with sufficient precision.

In some instances, a cloud-based service may request additional information from the vehicles that may be obtained from different systems or sensors. For example, there may be data available indicating how the vehicle operated in a specific region, including whether a driver of the vehicle took control or performed a specific action that may be associated with a change. For example, if a vehicle stopped at an intersection or changed into a specific lane, that information may be used to make a more confident determination as to the state of the environment. If a significant number of vehicles make unexpected movements, such as rapid decelerations or accelerations, then this may also trigger an evaluation of whether a change is to be made to the relevant map data.

In at least some embodiments, such an approach can allow for dynamic updating of map data, which can therefore include representations of temporary changes. For example, if a roadway or intersection is under construction for a couple months, the map data can be updated to reflect the temporary change, as soon as the change is determined with sufficient confidence and/or consensus, then another change can be made when the construction has completed, or as the critical aspects of the road or intersection change. Map data can be updated as often as is appropriate to provide accurate information about critical features of the roadway, for example, and the updated map data can be pushed to the relevant vehicles or otherwise made available. In at least one embodiment, a vehicle in motion may periodically check with a cloud-based mapping service to determine if there have been any updates to the map data for an upcoming area, whether based on a navigation path or a direction of propagation, for example, and can request the updated data. In other embodiments, a centralized monitoring service may monitor the location, direction, or destination of a vehicle and push out relevant map updates as appropriate, among other such options. In at least one embodiment, a temporary change may be identified as temporary if so determinable, as may be determined based on the presence of traffic cones or detour signs, for example, which may then make a subsequent change detection easier to make once the temporary change is no longer in effect.

As mentioned, the compact and discrete nature of the tokenized descriptions can allow map data to be updated with relatively high frequency or low latency. In at least one embodiment, map data may be able to be updated within around thirty seconds of a detected change, including detection, propagation to a cloud service, updating of the map data, then propagation of the updated map data. The map data can be updated any time a change is detected that satisfies the appropriate change criteria. In some embodiments, for at least some types of critical updates, detected changes may also (or alternatively) be propagated directly to nearby vehicles where the change may be important for safe operation of the those nearby vehicles. The vehicle can be performing continuous inferencing as part of the perception process, so changes or differences can be determined in near real time and transmitted for analysis. The ability to quickly update and propagate map information can reduce the number of vehicles operating with out-of-date map information, which can be important for safe operation of those vehicles.

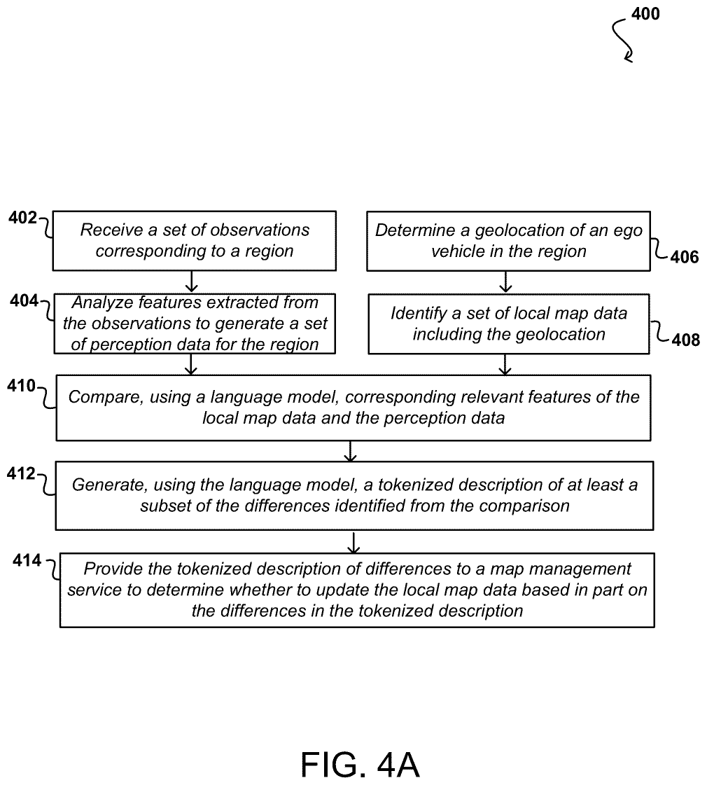

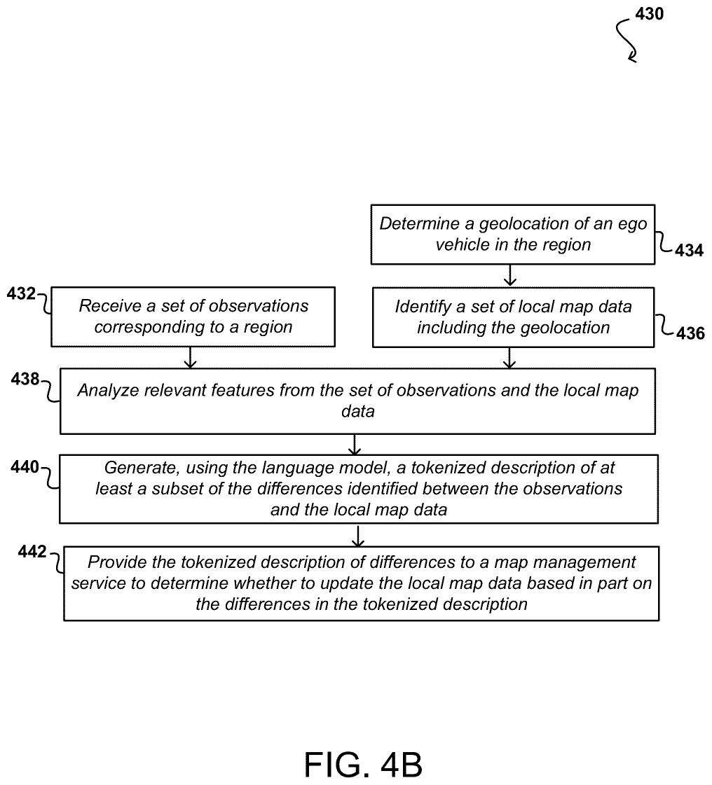

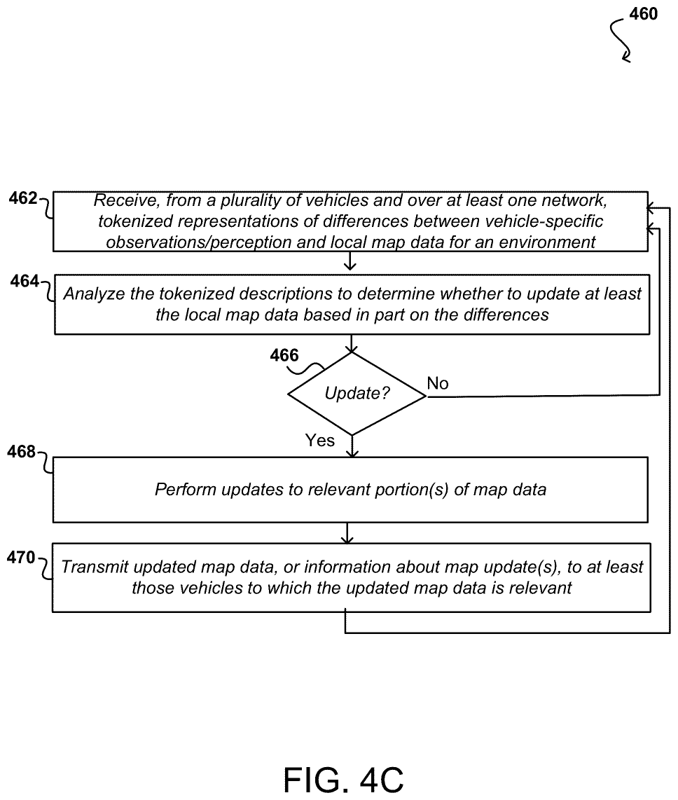

FIG. 4A illustrates an example process 400 that can be performed to generate a tokenized description indicating differences between map data and live perception data for a region of a physical environment, in accordance with at least one embodiment. It should be understood that for this and other processes presented herein that there may be additional, fewer, or alternative steps performed or similar or alternative orders, or at least partially in parallel, within the scope of the various embodiments unless otherwise specifically stated. Further, although this and other examples herein will be discussed with respect to driving or navigation domains and environments, and perception data generated for those domains and environments, there can be other types of observations obtained or generated for other types of domains, environments, and representations used and/or generated as well within the scope of various embodiments. In this example process, a set of observations is received 402, or otherwise obtained, that corresponds to a region (or domain, area, physical location, or other portion of a physical environment). The set of observations may include data captured by one or more sensors, for example, or other observations or data representative of objects or features in the environment. A set of representative features can be extracted from the set of observations and analyzed 404 to generate a set of perception data for the region. The perception data can include information for objects in the region that were recognized, or inferred, based in part upon the set of observations (as well as potentially other types of related data). In at least one embodiment, a set of observations can be obtained over a sequence of points in time, or time stamps, and perception data generated or updated for each point in time, where the perception data may vary based on movement of one or more objects in the environment or movement of an ego vehicle corresponding to sensors used to capture the set of observations, among other such options.

In this example, a geolocation of the ego vehicle can also be determined 406 in the region, and this determination can be made in parallel with the generation of the perception data, such as to allow for an update in the geolocation data for each time stamp. The geolocation data may be determined using a position determination sensor, system, or mechanism, such as may be based on a GPS signal, and may be used with a localization system to attempt to improve an accuracy of the position determination, as may be based in part upon movement of the ego vehicle, sensor data about the environment, or other such information. Based at least in part upon the geolocation, a set of local map data can be identified 408 that include the geolocation. The local map data can be selected from a larger set of map data, and may be of a fixed size or may be of a size determined based upon factors such as resource capacity, vehicle motion, map density, or other such factors.

The perception data and the local map data can then be provided to a comparison or difference determination module or process, for example, which may include or use at least one trained neural network, such as a language model trained to generate output in a domain-specific language. A trained language model can analyze the map data and the perception data to attempt to infer a consistent representation of the region, including information about semantics, relationships, topology, and geometry of the region. As part of the process, the language model can compare 410 corresponding features of the local map data and the perception data, such as those features determined to be specific to a particular task to be performed with respect to the domain (e.g., operating an autonomous vehicle on a roadway). A language model in at least one embodiment can generate a text-based representation of the region can be generated, as may relate to a tokenized description that includes one or more tokens for identified objects in the region, where a given object may have multiple associated tokens that store textual information about one or more aspect of the object, as may relate to static or dynamic information for the object. The same trained language model, or a different language model, can also (or alternatively) generate 412 a tokenized description of at least a subset of the differences identified from the comparison. The subset may be selected based on various selection or importance criteria, such as a type of difference or an extent of the difference as discussed in more detail elsewhere herein. As mentioned, certain differences such as very minor differences in traffic sign location or differences in buildings away from the roadway may not be included or specified as differences in the tokenized description as not being determined to be critical for performance of the domain-specific operation. The tokenized description of the differences can also include additional or alternative tokens that relate to the differences, such as indication of the type of difference, a delta indicating the difference, semantic information relating to an object affected by the difference, and so on. The tokenized description of the differences can be provided 414 to at least one system, service, or process—such as a cloud-based map management service—to determine whether to update the local map data and/or other portions of the map data based in part upon the differences in the tokenized description. This may include receiving such tokenized descriptions from multiple vehicles or other such sources, and attempting to come to a confident consensus as to the state of the difference and whether updating of map data (or another representation of that portion of the environment) is warranted.

FIG. 4B illustrates an example process 430 for generating a tokenized description of differences between map data and a set of observations that can be performed in accordance with at least one embodiment. Unlike the process of FIG. 4A, in this process a language model can take in the sensor data and/or other observations and determine a set of differences with respect to local map data without the need to first and separately generate perception data to be compared against the map data. As mentioned, in addition to requiring fewer components and processing, such an approach can allow a trained language model to have access to (potentially all of) the raw sensor data instead of being restricted to perception decisions made by another module or process based in part on that sensor data.

In this example, a set of observations is received 432, or otherwise obtained or generated, corresponding to a region of a physical environment. This may include, for example, a set of sensor data being obtained by sensors on an ego vehicle at a particular location and/or point in time in a physical environment. In addition, a geolocation of the ego vehicle in the region can be determined 434, such as by using GPS or another location or positioning mechanism. The geolocation can be used to identify 436 a set of local map data that includes that geolocation. The geolocation may not be highly accurate, but in many instances will be accurate enough to select a relevant portion of a map of a physical environment, such as a local neighborhood, city, portion of a highway, etc. In some embodiments, additional processing can be performed to attempt to align the observation data and the map data as discussed elsewhere herein. As discussed, the map data may be available in the form of a tokenized description in a domain-specific language, among other such options.

In this example, at least the relevant features from the set of observations and the local map data can be analyzed 438. This may be performed by a language model receiving the data, or by a component—such as a separate encoder—to extract the relevant features and provide those features as input to a trained language model in the form of, for example, one or more feature vectors, embeddings, or points in a latent space, among other such options. The language model can compare at least these features to attempt to identify at least relevant or critical differences between the map data and the set of observations. The language model can then generate 440 a tokenized description of at least a subset of the differences, which can include tokens that are specific to those differences, as may include information identifying the types or extents of the differences, etc. In at least one embodiment the language model can generate a single tokenized description that includes a representation of the environment as well as difference information, while in at least one embodiment a trained language model might only generate a tokenized description for the differences, or might generate separate descriptions for the environment representation and for the differences. Separate language models may also be used for such purposes. Once generated, the tokenized description of at least the differences can be provided 442 to a map management service to determine whether to update at least the local map data based in part on those differences. In at least one embodiment, the tokenized description may also—or alternatively—include one or more recommended changes corresponding to the determined difference(s).

As mentioned, such a tokenized description including information about identified differences between local map data and observation/perception data can be received from multiple vehicles and/or other such sources, and then used to make a more confident and informed decision as to whether to update map data or other representational data for at least a portion of a physical (or virtual) environment. FIG. 4C illustrates an example process 460 for attempting to determine and implement updates to map data based at least in part on such information, according to at least one embodiment. In this example, tokenized descriptions can be received 462 from multiple vehicles (and/or other such sources) of differences between vehicle-specific observations and/or perception data, with respect to local map data for at least one region of a physical environment. The tokenized descriptions can be analyzed 464, such as by using a language model, to attempt to determine whether to update at least the local map data based in part on the differences. In at least one embodiment, at least one additional component can be used to aggregate and correlate the data, and provide any processing needed to place the data from the different vehicles into a format that can be operated on by the trained learning model to attempt to determine changes to be made to the map data. In another embodiment, the correlation of various tokenized descriptions may be performed using a trained language model that can generate a tokenized description of the proposed change(s) to be made to the map data, and the tokenized description can be provided to a map update module that can determine whether, and how, to implement the changes. This module may include a language model or other algorithm or process, and may include an approval process for a human reviewer, among other such options. If it is determined 466 that no update to the map data is necessary based on the received difference data then the map data can remain unchanged (unless a change is to be made for another reason) and the process can continue. In at least one embodiment, tokenized descriptions of differences can be received from a variety of sources in relatively continuous fashion over at least a period of time (or region) of operation of those vehicles. If it is determined that an update is to be performed, then the updates to the relevant portion(s) of the map data can be performed 468. If the updated map data is not already in a tokenized description format, then a tokenized description can be generated of either the updated map data or the updates to be performed to the map data, using a trained language model. The updated map data, or information about the update(s), can then be transmitted 470 to at least those vehicles to which the updated map data is determined to likely be relevant, such as those vehicles near the region for the updates or that are determined to likely be located in that region in a near future, although in some embodiments the updates may be transmitted to any or all such vehicles, which can then store that information or use the information to obtain the updated map data at a relevant future period of time, among other such options. As mentioned, the tokenized description can benefit from language rules and other learnings of the language model. The tokenized description in this example can be provided to a control system, or other downstream module or process, of the ego vehicle for determining one or more operations to be performed. For an autonomous vehicle, for example, this may include operation of the vehicle over an upcoming period of time, where proper and/or safe operation of the vehicle is determined based in part upon the tokenized description. The tokenized description will be compact yet robust and full of important information, such that highly accurate operational decisions can be made in real time. Processes discussed herein can be used for other purposes as well as discussed and suggested herein. This may include, for example, the operation of robotics or automation in an environment, as well as the recreation or simulation of a physical environment, or training of a control system to operate in such an environment.

In at least one embodiment, a tokenized description generated by a trained language model can be used to provide an accurate representation of at least a portion of an environment. While such a description can be used for various “offline” purposes such as simulation and environment reconstruction, as discussed herein, a tokenized description can also be used for making “online” or otherwise real-time decisions, such as may be useful when performing operations such as vehicle navigation (autonomous, semi-autonomous, or otherwise) or robotic automation control or training. When performing or planning such operations, it can be important to have an accurate and robust understanding or representation of the environment in which the operations are to be performed. Such understanding can help to not only ensure proper or intended performance, such as to accurately identify objects for interaction and their precise location, but also to help avoid unintended occurrences, such as may involve undesired interactions with one or more objects in the environment.

For operations relating to vehicle navigation, for example, a control system will often include at least some type of perception system, module, or process. A perception module, for example, can attempt to process observations or other such data about the environment—as may be received from, or captured by, one or more sensors in communication with the perception module—and attempt to “perceive” information about the environment, such as to identify objects in the environment and determine information about those objects, such as their type, position, orientation, motion, etc. At least some systems will attempt to correlate this perception data with map data for at least a nearby or proximate portion or region of the environment. Being able to correlate map data and perception data can help to improve the accuracy of the perception data by matching it with “known” map information, such as the locations of lane boundaries or intersections.

When one or more such maps are available, a perception module can make use of them by first getting, obtaining or determining precise location information for the “ego” vehicle being controlled, or at least provided with navigation or operation instructions or information. In order to obtain precise location information, a system such as a global positioning system (GPS) can be used, among other such options. There may be issues with obtaining accurate location information from such a system, however, such as when the GPS signal is unreliable or lacks sufficient signal strength. There may also be issues with the accuracy and/or current state of the map, which may also result in difficulty aligning the map and perception data. If the map data and perception data are unable to be accurately aligned, or if no sufficiently accurate map data is available, then the perception module can be responsible for detecting all driving-relevant objects around the ego vehicle in real time and with high accuracy, which can result in higher pressure placed on the perception module in terms of both performance. This additional pressure not only can require and/or consume additional resources, but may produce results that are less accurate or require additional latency, which can be undesirable for many intended operations.

In many situations, there will be dynamic objects that are represented in the sensor or perception data that are not represented in the map data. This can include objects of various types, such as vehicles, pedestrians, scooters, and the like. A model can still attempt to make inferences that are consistent with the map data, even for objects only represented in the perception data, as may be based in part upon the types of objects that would normally be expected to be in specific locations, such as operating along a roadway or crossing in a crosswalk. In addition to basic information about an object, such as the type and location, a model can also attempt to encode information about the dynamic nature of the object, as may relate to the velocity, orientation, direction, acceleration, deceleration, or other such information. In at least one embodiment, these various aspects can correspond to encodings in one or more additional tokens associated with a given object. In at least one embodiment, a model can maintain a consistent frame of reference to use to determine the dynamic data, in order to represent the data consistently in the various tokens over time. Storing dynamic information may increase the number of tokens needed, such as 2,000 or 3,000 tokens for an intersection rather than 1,000, but the lightweight nature of the tokenized description allows for such additional data, and the description can be maintained discrete and compact by storing only that portion of the dynamic information that is relevant to the operation to be performed, and only for those objects determined to be relevant for operation over an upcoming period of time, distance, or other such factor. In at least one embodiment, adaptive representations of spatial locations can be used to reduce an amount of precision needed, and allow for fewer and/or smaller tokens. Other optimizations can be performed as well, such as to output tokens with critical information earlier in the string than less critical information, which allows that information to be processed more quickly.

In order to determine aspects of motion for dynamic objects, for example, a trained model can have the ability to analyze information across multiple frames of sensor data or points in time. This may include, for example, a cross-attention model analyzing data across multiple time stamps, such as for a most recent time stamp and a number of prior time stamps across a context window of any appropriate length, which may be limited only by the amount of available data and the capacity of the system resources, etc. The model can attempt to extract or identify the information from any or all of these time stamps that is determined to be relevant to determine current information pertaining to dynamic objects. For example, data for the current and immediately prior time stamp may be needed to determine current velocity and direction of motion of an object, while data from at least three time stamps may be needed to determine orientation or path of motion. A model can determine which information, and how much information, to grab from the current frame and any identified prior frames in order to determine dynamic information for the current time stamp. While using data from a larger number of time stamps can help provide more accurate determinations of aspects such as a path of motion or style of motion, data for prior frames that are further out in time will generally be less useful when determining information such as current velocity or acceleration, which may change over time such that older information may be less relevant. A trained model can then aggregate corresponding dynamic object data based on, for example, a key value of attention. The model can thus be capable of not only identifying the data needed across multiple time stamps to calculate various dynamic data values, but also determining which of the available data points is most relevant to calculating an accurate value. In at least one embodiment, a model is not trained to fuse this information in a specific way, but can learn from the training data how to correctly fuse specific types of information together to generate an accurate and useful result.

The ability to extract and fuse data over a large context window can be improved, at least with respect to various other systems, in part by the fact that the information processing is being performed in a discrete latent space. Such an approach can be more efficient and light weight, without the need to discard any sensor input but instead allow the model to select which subset of the data the model determines to be relevant. For example, a model may pull information identifying the location and orientation of a trash bin along the curb but in the roadway, but may not care about information such as the color, type, or design of the trash bin. The relevant information can be extracted, fused, and used to generate the information to be written to the appropriate tokens of the tokenized description to be generated for a current state of the environment in which an ego vehicle is located (or other relevant portion of an environment). The resulting description is both conceptually and spatially compact, as the description contains only that information relevant to the specific task or operation, such as vehicle navigation or operation in an environment. The description can further include only information relevant to the specific task or operation at a current point in time, such that information about vehicles within about a 500 foot radius might be considered, for example, but information for vehicles beyond that distance may be excluded, where the distance may depend in part on factors such as a current rate of travel or type of location, etc. Such optimizations can be implemented through filtering, model training, or a combination thereof.

In at least one embodiment, a large language model can be used to fuse both perception data and fusion data. The language model can be trained using domain-specific data, to generate a tokenized description in a domain-specific language. The language model can be trained to identify and extract relevant information from both the map data and the fusion data, and fuse that information together in a way that provides for the most consistent representation. Such an approach can be used for various domains, such as for driving, navigation, robotics, or automation. The approach can also be used to generate tokenized descriptions for various purposes, such as operation, simulation, or training, where the tokens included in the tokenized descriptions generated by the trained models may vary for different purposes as the important or relevant aspects of various objects may also vary. Such an approach can thus allow for simplicity of architecture, as well as scalability of data, among other such benefits. A model trained as described herein can be compact and lightweight enough to allow for online processing for real-time operations, but can also provide tokenized descriptions that can be consumed offline by downstream models, such as for prediction, planning, training, and other such operations.

In some instances, the sensor data may be insufficient for use for an intended operation, such as vehicle navigation and operation. For example, there may be obstructions preventing data from being captured, noise in the data, or issues with sensor calibration or availability, among various other such factors. In at least some systems, a lack of reliable sensor data can prevent successful operation performance. Approaches in accordance with various embodiments can overcome at least some of these issues with sensor or perception data quality by attempting to infer a most reasonable and consistent representation of the environment based at least on the available map data and any prior data for that environment, as well as any sensor or perception data received. When training such a model, there may be instances where a portion of the perception or sensor data is removed before training, or instances where only the map data is provided. In some instances, data from one or more sensors may be removed from consideration during training. In other situations, all perception data might be available but at least a portion, if not all of the map data, can be removed from consideration. It may also be the case that only a lower-resolution map, such as an SD map, is available, rather than a higher-resolution map such as an HD map. Such an approach can train a language model to infer a most reasonable and consistent representation based on the data that is available at any given time. Such an approach can help to avoid situations where an operation is not able to be performed due to issues with the available data, such as where an autonomous vehicle stops in the middle of an intersection because the available data is insufficient for the vehicle control system to make any operational decision that meets a minimum confidence or safety threshold.

In addition to real-time operations, such as autonomous vehicle navigation, that can be performed based on a combination of static and dynamic data, inferences are able to be made using such data that can allow for proactive or predictive operation. For example, a model may be able to determine aspects such as direction, velocity, and acceleration of nearby vehicles. Such information, along with available map data for at least a portion of the environment, can allow the model to predict the state of the environment over a series of future time stamps even though the sensor data has not yet been received. Being able to predict future states of the environment, including dynamic objects, allows for predictions of undesirable actions or states, as may relate to collisions or other operational states that may fall below a minimum safety threshold or otherwise fail to meet at least one requirement of safe operation. The availability and understanding of semantic information and relationships can also help a trained model to make more accurate predictions or inferences than may be possible using other approaches or components. Instead of only sending the tokenized description of the environment to a downstream component to attempt to perform an operation such as collision avoidance, the model can infer or predict a potential collision and send a warning or other indication of the potential undesirable action. This warning may be sent in the same tokenized description, or as a separate tokenized description of higher importance that may be sent to a different system, or directly to a specific system. In at least one embodiment, a model may also generate one or more recommended actions or instructions to attempt to avoid the predicted collision or other undesirable state. The ability to save even a little bit of latency by making the prediction in the model itself instead of in a downstream system or process can help to improve the overall safety of operation, particularly for higher risk operations such as autonomous navigation at high speed. Such an approach also has an advantage of being based on observations or learnings of the model, based on semantics and other information inferred for objects in the environment, rather than rules-based approaches that need to be hard-coded for various existing collision avoidance systems. The model-based approach can be more flexible and scalable, in addition to being easier and less complicated to train than encoding, managing, and updating a set of rules that needs to be highly accurate and comprehensive, even under varying environmental conditions. Such an approach can also help make better decisions for general operation as well, such as to make a better determination of when to make a lane change for a merge, or pull out into traffic, based on predicted future states of the environment rather than currently available sensor data. Such an approach can help to better perform operations for outlier instances, such as when there is construction or an accident and someone is directing traffic. It can be difficult to properly interpret all situations and make accurate decisions in a rule-based system, unless you have a specific rule for a given situation, but a language model-based approach can determine patterns of operation of other vehicles and can infer the appropriate action(s) to take based on these patterns and available environmental data, even if the vehicle control system has never previously encountered such a situation.

It should be understood that representations, such as feature vectors or tokenized descriptions, can be generated for regions of different types or sizes. For example, a tokenized description may represent a single, larger intersection, and/or there may be several other tokenized descriptions used to represent portions of that intersection, such as individual lanes or traffic signals associated with that intersection. In at least some embodiments the levels and types can be user configurable, but in at least some embodiments tokenized descriptions should be generated for a set of domains where there are specific rules or behaviors, or where it can be important or beneficial to have more detailed data. For example, a long, two-lane highway in the desert may benefit from few, if any, tokenized representations, as a vehicle can primarily treat the location as one, long lane in a given direction and navigate primarily using sensor data. For a very complicated intersection or roundabout, for example, it may be beneficial to have one tokenized description of the large roundabout and associated entries and exits as a whole, but there may be benefit to having more granular representations of portions of that intersection, where the various entrances and exits may not all be highly similar, there may be different behaviors expected, and so forth.

In some embodiments, a vector database or latent space management algorithm can attempt to remove redundancies, such as points or vectors that came from separate sources but refer to the same regions or domains. In some embodiments, highly similar domains may not have individual vectors or points stored, but may have a single representation stored that is associated with those various domains. For example, in a planned community all the intersections may be designed to be identical, although there will typically be at least some minor variations. In at least one embodiment, a single feature vector may be stored that is associated with all of these intersections, rather than storing a separate but highly similar feature vector for each intersection.

In another example, long highways may have many sub-regions that are substantially similar, at least from a feature-of-interest perspective. In such instances, there may be a single feature vector (or small number of feature vectors) used to represent potentially many sub-regions along a very long stretch of highway, or a section of that highway may be taken as representative and then one feature vector encoded that represents a portion of that highway. Instead of having hundreds or thousands of feature vectors that are highly similar, or that contain a significant amount of shared information, a single representative feature vector might be used for that highway, or at least large portions of that highway that are essentially similar from at least a feature-of-interest standpoint, that is then associated with multiple sub-regions or locations (or ranges of GPS coordinates, etc. There may be different feature vectors encoded for specific offramps or other portions, but in many instances each highway or roadway with long, similar stretches might be represented by a single feature vector that can be reused as appropriate.

By storing representative feature vectors for similar locations rather than feature vectors for each location, the size of the latent space or vector database can be significantly reduced, such that large map representations for entire regions or environments may be able to be stored on a vehicle or computing device, rather than managing subsets that are relevant to a particular time or location. In some embodiments, cluster density or proximity may be used as a determining factor for reducing the number of representative points or vectors for similar domains as well. The amount of information stored in individual tokens of a tokenized description may also be variable or user configurable, with some information being required for certain tasks or operations and additional information being optional. For example, description of objects (e.g., buildings, post office boxes, etc.) near a roadway may be stored if desired, but may not be required for navigation or at least semi-autonomous navigation. In at least some embodiments, a reduction in dimensionality can be performed on the feature vectors to attempt to further reduce the size and complexity of a vector database (or latent space, etc.). Such an approach can also help improve the efficiency of clustering, and may result in fewer but more relevant clusters in at least some instances.

Approaches in accordance with at least one embodiment can formulate a wide range of geospatial information processing and related tasks—such as map building, map editing, map-based navigation, planning, and driving—as document manipulation tasks that leverage one or more LLMs to solve them in a unified and joint fashion. In at least one embodiment, an LLM is built using one or more deep neural networks (DNNs) that are trained using textual information—such as in a domain specific language (DSL) like RTL—using textual representations of geospatial information (such as maps). The DSL described herein may be referred to as, without limitation, the RTL. The RTL may rely on both the existence of a rich feature database and a graph describing relationships of these or other such features within a map or other such representation. Using one or more automated processes or operations, a set of map features/landmarks (e.g., those encoded in an HD map using a data format suitable for HD maps) may be deterministically converted to the RTL, and vice versa. In some embodiments, the graph can be represented as a knowledge graph that expresses road objects, road object relationships, and road network topology, rather than generic knowledge.

In some embodiments, an LLM (or other language model type(s)) may retrieve and/or access map data or other information determined to be necessary to generate an output using one or more application programming interfaces (APIs) and/or plug-ins (e.g., third-party plug-ins). For example, in order to retrieve additional contextual information, additional map information, additional feature information, and/or other information not directly included in a prompt to the model, the system—using the LLM, in some embodiments—may generate one or more prompts or queries for one or more data sources (e.g., open street maps (OSM), wolfram alpha, a local map database, etc.), via one or more APIs or plug-ins, in order to obtain the additional information required (or deemed necessary) for responding to the initial query or prompt. Such an approach to querying additional resources may be recursive, in at least some embodiments, in that the system may continue to access one or more data sources via the API(s) and/or plug-ins until it is determined the necessary information has been obtained, or until no additional information is available. In some embodiments, an initial prompt for the model may be generated using one or more APIs or plug-ins, such as an API for retrieving an RTL description of a selected section of a map. For example, a user may, via an API, select a portion of a map to be processed or analyzed using the LLM, and the API may return a textual or tokenized description of the portion of the map in the DSL (such as RTL).

The RTL may use an S-expression syntax as one way to represent map information. In S-expressions, information can be grouped—such as in sets of parentheses—where each set includes one or more items that can be either simple pieces of information like numbers or text, or another set of S-expressions. This allows for representing maps in a hierarchical and compositional way that can be relatively simple to parse. Other graph representations may also be adopted and used in some stages of the system to facilitate specific data manipulation when appropriate.

One of the use cases of the RTL is to interface with an LLM (or other language model type), where the grammatical validity of the output of the LLM can be ensured. Formally expressing data using a grammar can make it easier to assert its validity compared to managing an arbitrary bag of strings or relying on generic formats like JavaScript Object Notation (JSON) or Yet Another Markup Language (YAML)—which can result in loss of semantic information. As such, using a formal grammar to represent the input/output of a language model can improve the robustness and reliability of the system, and can help to ensure that the processed data has proper semantic meaning and is well-formed.

In at least one embodiment, one main entity in an RTL document is a directed graph describing a portion of a road network—such as an intersection. There are multiple possible approaches to encode map coordinates and—in order to accommodate a small, fixed-size vocabulary—a grid-based tokenization as the decimal notation may be implemented. However, alternative approaches may be used, such as using a geo-hashing representation, which provides another technique to encode geospatial locations. However, geo-hashing often relies on a global reference system and supports precision at various levels, which result in the need for a very large vocabulary.

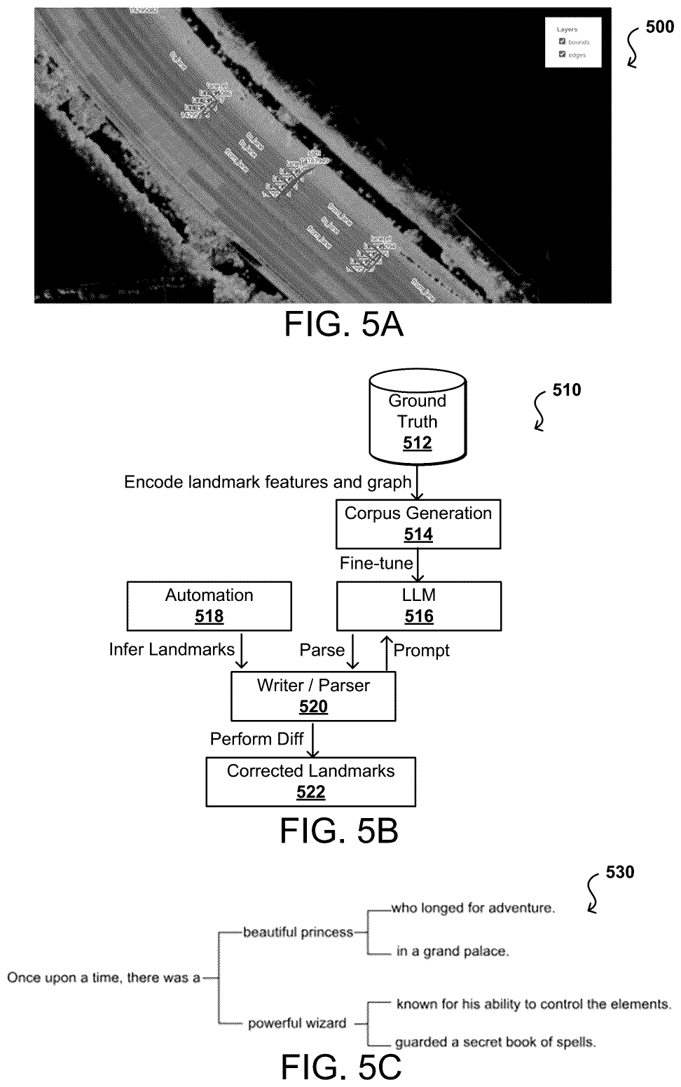

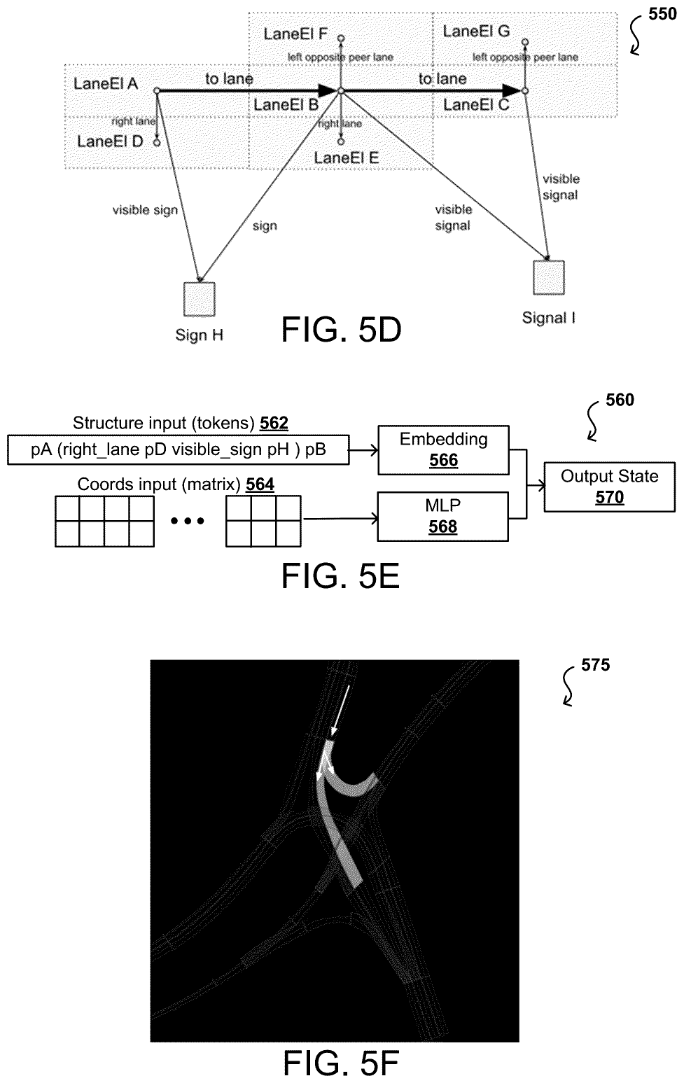

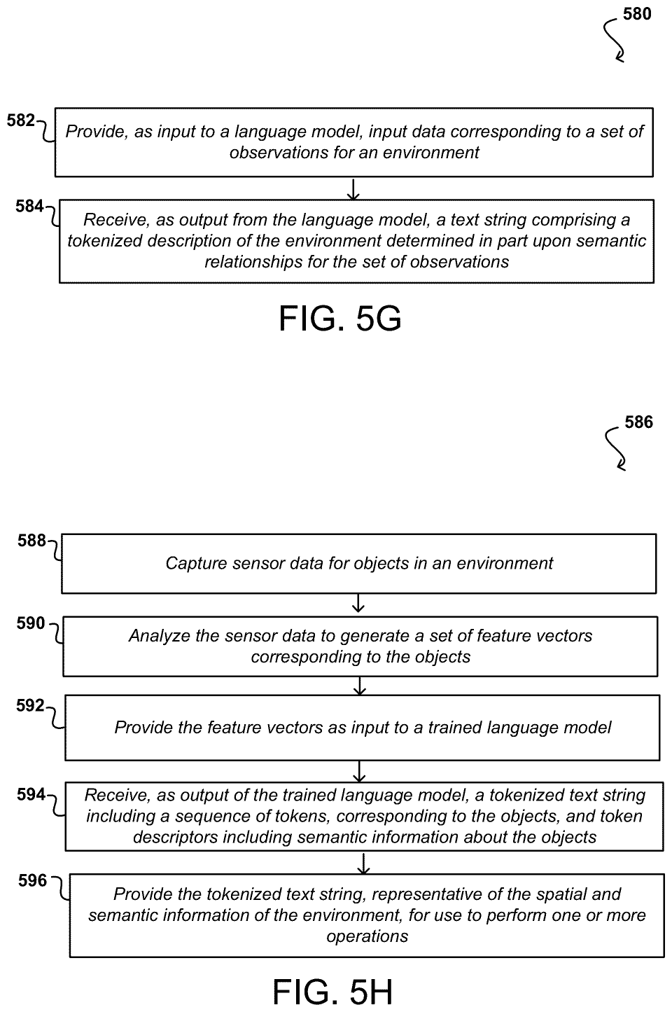

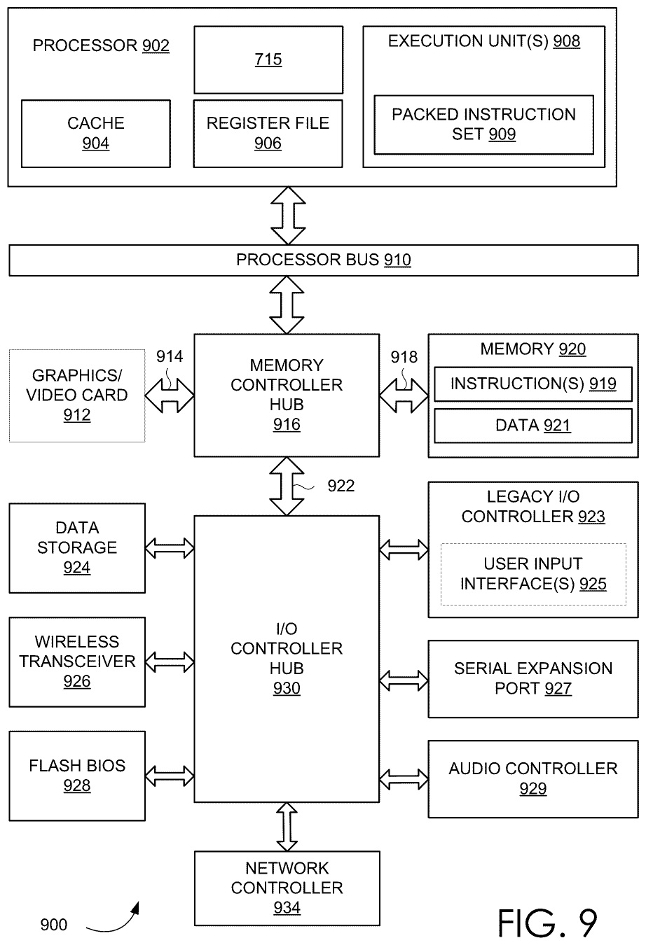

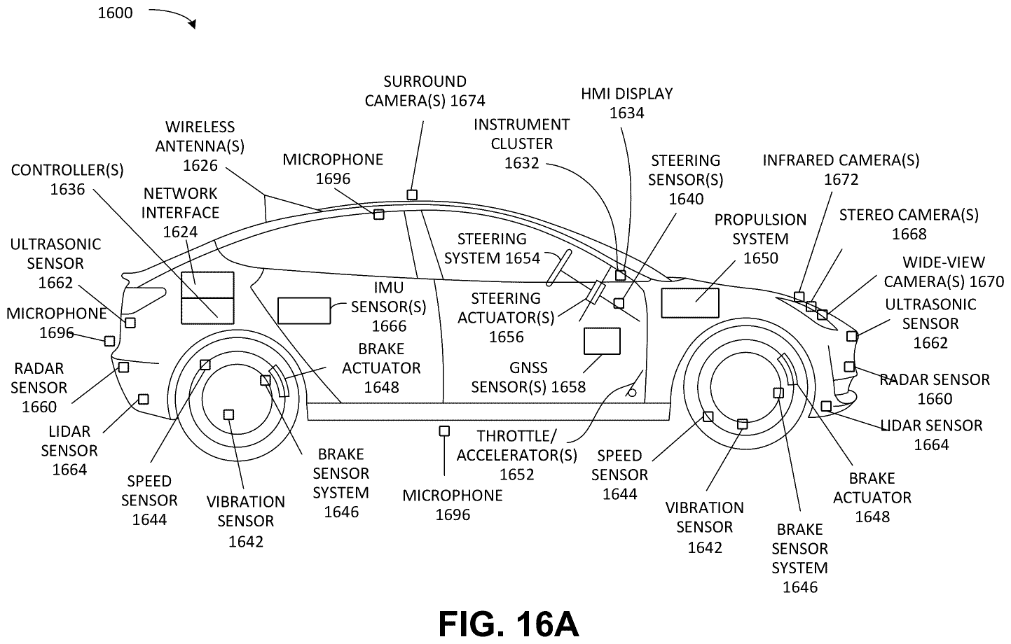

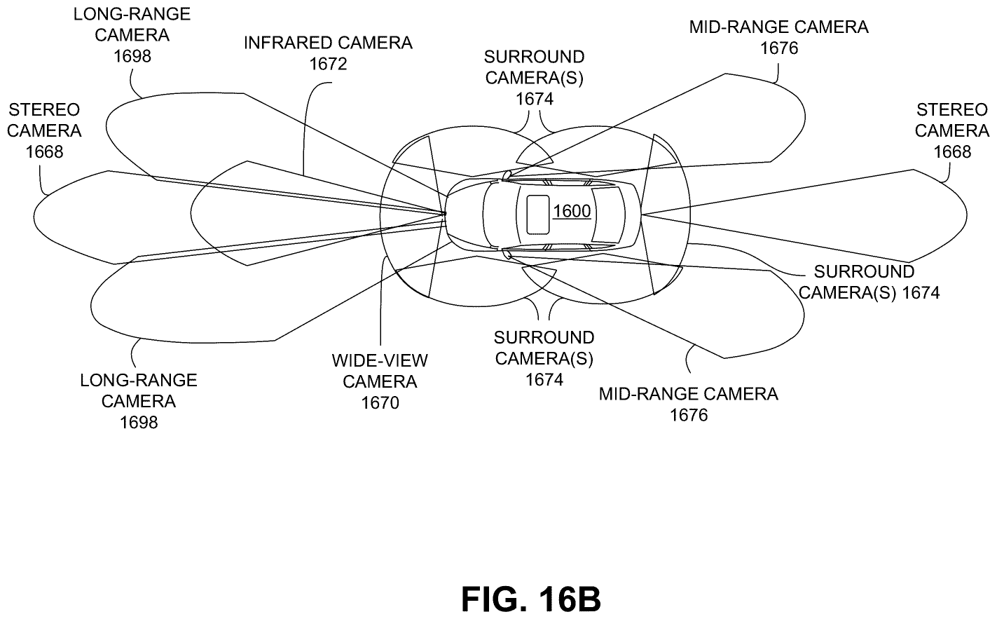

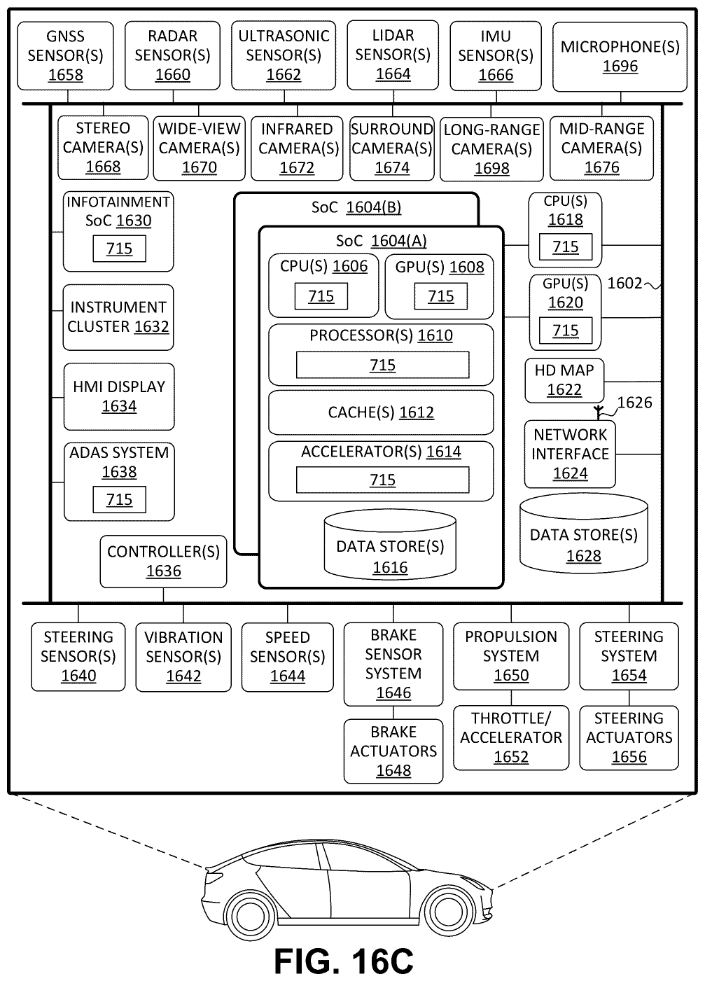

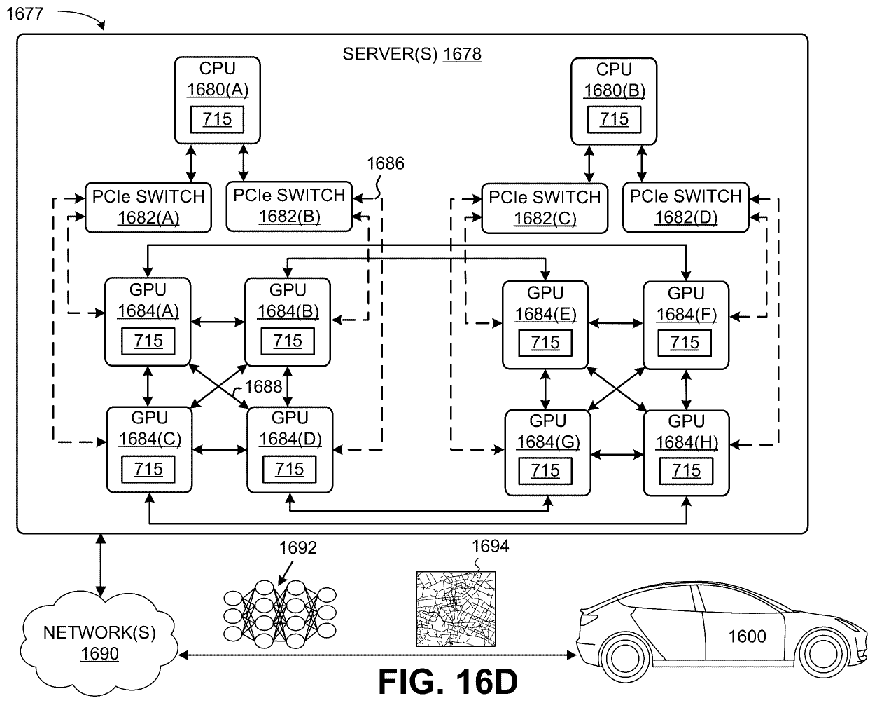

FIG. 5A illustrates an example graph view 500 of an environment corresponding to a portion of a multiple-lane roadways in accordance with at least one embodiment. To express a map for such an environment using a language such as RTL, semantic data about the map may be used. FIG. 5B illustrates an example architecture 510 for the training and deployment of an LLM, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1600 of FIGS. 16A-16D, example computing device 900 of FIG. 9, and/or data center.

As illustrated in the example architecture 510 of FIG. 5B, semantic information may be available—e.g., encoded in one or more maps from a database 512 or repository of ground truth data—and may be used to describe the map in the relevant language. In some embodiments, existing map data may be used to perform tasks such as to encode landmark features and other aspects of a map or graph. For example, an HD map (which may be represented using an occupancy map generated from any type of sensor data, such as image data, LiDAR data, RADAR data, etc., in embodiments) may have various layers—such as planning layers, semantic data layers, sensor-specific layers (e.g., RADAR layers, LiDAR layers, camera layers, etc.), and/or other layer types. To convert the map representation to a language-based representation, such as a sequential, tokenized text string, one or more of these layers may be used. An automated conversion tool can be used to read the map data in a map format and convert the data to the RTL, or otherwise generate a language-based representation of the map data, such that an LLM can understand and process the data. In at least one embodiment, this can include using a corpus generation component 514 that can generate a text-based representation based on the encodings or embeddings from the map data, and perform training before providing the text representation to an LLM 516. As such, the RTL may include or comprise a language that can express a topology of a road network (and/or other network, such as those associated with warehouses, buildings, outdoor spaces, waterways, etc.) that is derived from, for example, an HD map. The RTL may then serve as an interface between an LLM 416 and the HD map such that the LLM(s) can learn the underlying structure of the road network (and/or other network(s)).

In some embodiments, the RTL may be encoded into an HD map—e.g., into one or more layers, such as a semantic layer, of an HD map. The LLM 516 may then be trained using this encoded information as a training corpus. In some embodiments, the features that are included or represented in the RTL can include, without limitation, traffic signs, traffic signals, poles, lane dividers, road boundaries, road markings, stop lines, wait elements, lane elements, and/or the like. For each landmark or feature, various types of data may be represented—such as a landmark ID (e.g., global unique IDs), a landmark number (e.g., total number of current landmark types), spatial information (e.g., 3D latitude and longitude, size, orientation, pose, etc.), and/or semantic information. The spatial information in some embodiments may include 2D coordinates (which may be derived from 3D coordinates), 3D coordinates (which may be determined from 2D coordinates), 4D coordinates (that may change over time or have a temporal component), bounding shape locations, and/or curve locations. Bounding shapes may be represented using float[3] for location, float[3] for sizes, and float[3] or [4] for orientation or pose. Landmarks that are curves may be represented using a list of key points and their 2D or 3D locations, or may be represented using parameters of curves based on a parametric form. Semantic information may include, for example and without limitation, a landmark type, a landmark association (e.g., a traffic light's associated lane IDs, lane boundary segment locations), and/or textual information (e.g., text displayed on signs).

An LLM 516 trained with an RTL (or other DSL) corpus built from a database 512 of map ground truth data can be queried to correct features output from a machine learning (ML) automation pipeline. The output of an LLM 516—such as by using a writer and/or parser component or module 520—can be mapped back to the extracted features. A difference (e.g., diff) operation can then be performed with respect to inferred landmarks from an automation component 518, for example, to perform any appropriate corrections to generate a map graph 522. An example use case is to infer the road topology (e.g., edges) from an incomplete set of nodes (e.g., landmarks) with potential applications in, for example and without limitation, tooling, quality assurance (QA), and automation. In some embodiments, document embeddings may be indexed in a vector database, or n-dimensional latent space (where n can represent a number of extracted features or feature types), and the index can then be used to cluster similar intersections—thus allowing the unsupervised labeling and retrieval of operation design domains (ODDs) (e.g., features or landmarks).

In at least one embodiment, a structured language such as RTL can rely on both the existence of a rich feature database and a graph describing the relationships of these features within the map. Approaches described herein allow for deterministically converting from a set of landmark features to an RTL representation, and vice-versa. A graph in this example can be thought of as a knowledge graph, but instead of generic knowledge, the graph expresses the road network topology or other aspects of the relevant environment. In one or more embodiments, there may be strong constraints around how to encode coordinates so that they can be understood by language models (LMs). Location-related aspects such as coordinates, latitude, longitude, and altitude coordinate tuples can be represented using coded values or representations, such as sets of two characters from the permutations of the alphabet: “ab ac ad . . . ” up to size 256, for a non-limiting example.

To tokenize or encode a coordinate, for example, one, some, or all landmark features in a document can be considered, and a values such as their centroid may be used as the origin in an east, north, up (ENU) coordinate system (or another coordinate system), with altitude set to the average altitude of coordinates in the document. A radius R can be considered, such as, for example, 350 meters around that origin that is split into a grid (e.g., a 65536×65536 grid). The tokenization precision can be a function of this width, as a cell in the grid can be the smallest addressable (or indexable) unit which equals, for example, 0.0107 m with the proposed range. Such a fixed-size grid can allow for the coordinates to be represented at the same scale across documents (versus being normalized against the bounding shape of each document, for example).

In at least one embodiment, an important entity in a language-based representation—such as an RTL document—may be implemented as a directed graph describing a portion of an environment such as a road network. Such a graph can be used to express the connectivity between road features (topology) and may be similar to a knowledge graph. The graph nodes can then correspond to landmark features and may be typed or classified with their landmark type. The edges of the graph can correspond to the relationships between road features. In some embodiments, all source nodes may include lane elements. An individual lane element (laneEl) can be converted into a small graph, and a document can contain all nodes related to a given laneEl. A road graph can be represented by listing the entirety of its nodes and edges. The ordering of the nodes and edges may be arbitrary; however, edges can reference nodes by their index in the document.

In a graph traversal representation, an edge sequence can be used to express the path on the underlying graph of the map. Such a path can include the list of the laneEl nodes visited and their attributes. The attributes of a laneEl node may include its intrinsic properties (such as the laneEl's drivable direction), as well as the attributes of the nodes it can reach (such as signals this laneEl can see, and its neighboring laneEl). In this way, the RTL document may not capture the full graph of the map, but rather possible paths on the map. A sentence of a natural language can also be thought of as a path on the underlying graph of the natural language. At each word, there can be many different possibilities of what the next would be, and those possibilities can form a graph, with a particular sentence consisting of a sequence of choices of different edges at the nodes of the graph. FIG. 5C illustrates an example simple graph 530, similar to a sentence diagram, which can break out objects or tokens, and can associate additional information with the appropriate tokens or objects.

In at least one embodiment, a language model can analyze a number of sentences, and determine the next word such that it is consistent with the words that came before. Essentially, the LLM has learned the underlying graph structure such that it can walk on the graph to produce reasonable sentences. By providing a sufficient number of potential paths, the map LLM can learn the graph of the map and can generate plausible paths on a map. For example, when seeing a turn signal light in the input sequence, the LLM may predict a turn lane for the next token in the sequence.

Using a form of edge sequences can allow for a more compact representation of the RTL documents. Moreover, integer IDs used to refer to the features can be eliminated completely. Since there can be a linear path in the structure, the nodes and properties around that path can be expressed in an appropriate fashion. FIG. 5D illustrates an example of a sub-graph 550 around such a sequence in accordance with at least one embodiment. Here, the sub-graph corresponds to sequence laneEl A->laneEl B->laneEl C. In such an example, the traversal may use a number (e.g., 19) tokens in total to specify the structure of the path, which is a fairly compact representation. In one example, a path can be expressed in the following tasks:
Task 1: Specify a node by its type and attribute/property. For example, node laneEl A is specified as LaneEl pA, where pA are the properties of A (e.g., traffic_direction straight, allowed_vehicle_type car, etc.)
Task 2: Specify the main path by listing the nodes it goes through: LaneEl pA LaneEl pB LaneEl Pc.
Task 3: For each node on the main path, specify the non-navigable nodes it can connect to in the format (edge_type node). For example, for laneEl A, the non-navigable nodes are (right_lane laneEl pD visible_sign Sign pH).
Task 4: When referring to a node that is identified before, use its index directly. For instance, if sign H is listed as a non-navigable node for A, when it is observed again for B, it would be (sign 0) since it is the first sign in the sequence.

Various approaches may be used to encode map coordinates. For example, decimal notation, grid-based tokenization, geo-hashing, and/or other approaches may be used in various embodiments. In order to ensure a small fixed-sized vocabulary, some embodiments use a grid-based tokenization method—as decimal notation and geo-hashing may require larger vocabularies. As an LLM can work well with sequences, a delta-based encoding can be used to express coordinates. As an alternative, a global coordinate system may be implemented; however, a global coordinate system—while easier to parse and encode—may result in sparse tokens and make the topology learning less effective. As a note, cumulative absolute error is not considered problematic at this point as the length of the traversals is short and approximate relative positions may be suitable.

With each node having at least four key points, the first key point can be used as the anchor point for the subsequent points in the node. As a non-limiting example, a 263×263 grid may then be laid out, and centered at the anchor point, which may allow for an indexable area of 878 m×878 m at 5 cm precision. FIG. 5E illustrates an example architecture 560 that can be used to determine an output state 570. To tokenize a coordinate, such as coordinates received as input in a matrix 564, all landmark features in a document may be considered, such as may be received as a set of tokens or other structure input 562. A value such as a centroid may be used as the origin in an ENU coordinate system, for example, with the altitude set to the average altitude of coordinates in the document. The tokens can be processed to determine appropriate embeddings using an embedding module 566, and the coordinate input processed using an MLP 568, for example in order to generate the appropriate output state 570. In at least one embodiment, graph traversals can be generated using random-walking on the laneEl graph. The connections of the laneEls (e.g., from laneEl and to laneEl fields) may define all possible ways of navigating on the map. To generate a traversal, one approach is to start from a laneEl and recursively follow the successor laneEls to generate a path. When a branch point is encountered where multiple successors exist, the approach can be to randomly take one of the successors and follow the path until, for example, a max token limit is reached.

FIG. 5F illustrates an example image 575 of an intersection in an example map. As depicted, white arrows indicate the possible directions of traffic and the two highlighted lanes are the two successor laneEls of the laneEl above them. When generating the traversal, one approach is to start from the top laneEls, and one of the successor laneEls may be picked to add to the path and follow one of its successors, and so on. To generate graph traversal, a random walk on the laneEl graph can be performed. In practice, graph traversals can be generated with tasks such as the following:
Task 1: Extract all laneEls in the map and put their ids into a vector.
Task 2: Randomly choose a start laneEl from the vector, where the to_laneEl fields are the possible successor laneEls that this laneEl can go to. Randomly choose one successor laneEl and follow its successor, and so on.
Task 3: While at a laneEl in the path, extract the landmark features that are reachable by this laneEl and add them to the traversal results. Stop the path once the traversal reaches the max token limit.

In this example, nodes correspond to landmarks. A common node type in this example is the lane_el, but also includes road_boundary, lane_divider, signal, sign, stop line, etc. Edges can represent relationships between landmarks, with each edge having a type, such as from_lane, to_lane, visible_sign, sign_edge, etc.

According to one or more embodiments, the grammar may include a simple directed graph data structure with an arbitrary number of edges. Node attributes can be specified in the node entity and depend on the node type, which is the same as the landmark feature type. An RTL document can be produced by using logic such as the following: the features are within a predefined area (e.g., 700 m×700 m) as defined with respect to coordinates encoding herein; a document is written for every laneEl that includes the related features as nodes and their relationships encoded as edges; and the edges of the node are included as well. The language can be compiled using a command line tool. Such a tool can validate (lint), for example, check that all nodes referred to are present in the document, and compile to other targets such as keyhole markup language (KML) or an image, which can be useful for debugging. An RTL API can provide a public interface that lets developers generate structured language documents, and also allows users to query a trained model. As described herein, a schema can be provided to tokenize the edge sequence path, where attributes of the node are represented by a single token for illustration purposes. While in reality all the node attributes may not fit into a single token, there is still room to compress them into as few tokens as possible.

In some embodiments, high level contextual information may be added to prefix an RTL document. The generative part of a language model can learn to manufacture RTL graphs from contextual information. Using such an approach can allow for converting from natural language descriptions, other simpler map representations, or images (camera or BEV) to a language such as RTL. For example, the LLM may be prefixed with natural language descriptions such as “a 2 lane road,” “a 4 way intersection with 2 lanes in each direction,” or “a large intersection with traffic lights,” or using a more structured language that captures the same information, such as “DESCRIPTION 2 lanes 4 way intersection GEN (graph (lane el . . . ” Such high-level contextual descriptions may be derived from HD and/or SD map information. In some embodiments, an image may be processed using a model (e.g., a DNN) and a description of the image—or road topology or contextual information represented in the image—may be output by the model. This contextual information or semantic information may also be used to generate RTL, which may allow for fitting the RTL to an image (using an overlay capability).

Such a process can be performed with top-down or bird's eye view (BEV) images. Such a process can also provide the ability for processing an image (in camera or BEV) into RTL (or another DSL).

As such, contextual information—in a format different than the DSL or RTL—may be provided or prepended to a query or prompt for the LLM in order to direct the generation of the output from the LLM. For example, an LLM configured for maps and an LLM for natural language—or a combined LLM trained to process both types of language—may be used in order to understand both natural language and the DSL. The context, as described herein, may include a higher-level description of the scene “a two lane road,” “a 4 way intersection with two lanes in each direction,” or “a large intersection with traffic lights.” In some embodiments, an encoded representation of a standard or lower definition map (relative to an HD map)—such as a navigational map—may be generated and used as a prefix or a prepended portion of a prompt of the LLM. For example, this map information may be encoded in natural language, or may be encoded in another format that is digestible by the LLM. This type of information, with more or less detail, in embodiments, may be processed by the one or more LLMs to generate a representation of the described scenario or scene in the RTL, for example. In some embodiments, observed geometry or image features may also be included or prepended to the prompt. Some of this information may be retrieved or generated using a map. For example, a map may include information encoded therein such as “type: intersection asymmetrical t junction {incomplete} (NE=>SW),” and this information may be used as part of the prompt. In some embodiments, information or descriptions such as (num lanes, num lanes in/out of intersection, num turn lanes, etc.) may be retrieved or obtained from reading the map. To capture this information, in embodiments, the RTL vocabulary may be extended to include these types of descriptions as prompt tokens. For example, as described above, the training data may include “DESCRIPTION 2 lanes 4 way intersection GEN (graph (lane el . . . ), and the LLM(s) may be queried with or without the RTL graph information. This information may also be generated from open street maps (OSM) or another map source or database, and/or from processing images or other sensor data types.

As mentioned, such a representation of an environment can be used to perform specific tasks, as may relate to simulation or testing. In at least one embodiment, representations generated using approaches presented herein can be sufficiently realistic to allow a planning control system for an autonomous vehicle to operate within the environment. Maintaining semantic information and building from understood relationships can provide for a much more accurate and thorough representation of an environment that could otherwise be built using low-level primitive representations alone—such as points, lines, segments curves, or polygons representative of the shapes and locations of objects in an environment—with additional information (e.g., semantic data) being cast aside early in the reconstruction process as in prior approaches. As mentioned, topology information obtained from such low-level primitives can also be fragmented due to occlusions and other such factors. An example representation as generated in accordance with at least one embodiment can retain this additional information and complete a fragmented representation using one or more language models. Further, a representation might be able to be further improved by using multiple perception and/or localization modules that can analyze distinct types of input and fuse those inputs to generate more accurate features and relationships. A prior map or representation information can be used as well, where available. A language model can further be used to fuse these types of information to generate a single, consistent representation.

FIG. 5G illustrates an example process 580 to generate a text representation of an environment that can be performed in accordance with at least one embodiment. It should be understood that for this and other processes presented herein that there may be additional, fewer, or alternative operations or tasks performed or similar or alternative orders, or at least partially in parallel, within the scope of the various embodiments unless otherwise specifically stated. Further, although this and other examples herein will be discussed with respect to mapping and navigation environments, there can be other types of environments and representations used and/or generated as well within the scope of various embodiments. In this example process 580, input data corresponding to a set of observations for an environment can be provided 582 as input to a language model, such as a trained LLM. The set of observations can correspond to raw sensor data, features extracted from the raw sensor data, a set of feature vectors or embeddings, or an object map, among other such options. The language model can be a generative model that was trained using spatial and semantic information for various environments, and is able to infer relationships between various objects or features in an environment. A text string can be generated and received 584 as output from the language model. The text string in this example can be a single, tokenized text string that comprises a tokenized description of the environment determine in part upon aspects and relationships determined or inferred for the set of observations, including semantic, geometric, and topological aspects of those observations. The text string can include information that can provide additional information about the tokens in the string, which in turn can correspond to objects in the environment. In some embodiments, multiple text strings or text objects can be provided for use in representing an environment. The generated text string can be used to generate a number of different representations of the environment in different forms or for different purposes, and can be used to locate similar environments based at least in part upon the tokens included in the tokenized string.

A process such as that described with respect to FIG. 5G can be used to generate a reconstruction of a physical environment, or the synthesis of a new environment that complies with real-world rules. An example process 586 illustrated in FIG. 5H can be performed to generate a reconstruction of a physical environment based at least in part upon sensor data (or other such data) captured or obtained for that physical environment. In this example process 586, sensor data is captured 588 for objects in an environment. The sensor data can be captured using any appropriate sensors or devices such as those discussed herein, as may include LIDAR, RADAR, camera, or sonic sensors, among other such options. Additional data for the environment may be obtained as well, as it may include prior map data, feature vectors, or representative text strings. The sensor data (and any additional data) can be analyzed 590 to generate a set of feature vectors corresponding to the objects, as may correspond to embeddings in a latent space. In this example process 586, the feature vectors are provided 592 as input to a trained language model, although in other embodiments the language model may take the sensor data as input and generate the feature vectors or embeddings internally, among other such options. The language model can be trained using semantic, geometric, and/or topology data for various environments (in addition to natural language information) and can understand the relationships between objects in the environment, as well as the real-world rules that apply to those objects. A tokenized text string (or other textual representation) can be received 594 as output of the trained language model. The tokenized text string can include a sequence of tokens, corresponding to objects in the environment, providing semantic (and other) information about those objects. The sequence of tokens can function as a flattened map graph in at least some embodiments and can be used to generate a realistic environment. The tokenized text string, representative of the spatial and semantic information for the environment, can be provided 596 in this example to a reconstruction generator (which may also include a generative machine learning model) to generate a digital reconstruction of the environment, as may correspond to a birds-eye view map, an HD map, or a 3D virtual environment, among other such options.

Aspects of various approaches presented herein can be lightweight enough to execute in various locations, such as on a device, such as a client device that includes a personal computer or gaming console, in real time. Such processing can be performed on, or for, content that is generated on, or received by, that client device or received from an external source, such as streaming data or other content received over at least one network from a computer or processor 620 (e.g., a cloud server or control system) or third party service 660, among other such options. In some instances, at least a portion of the processing, generation, compositing, and/or determination of this content may be performed by one of these other devices, systems, or entities, then provided to the client device (or another such recipient) for presentation or another such use.

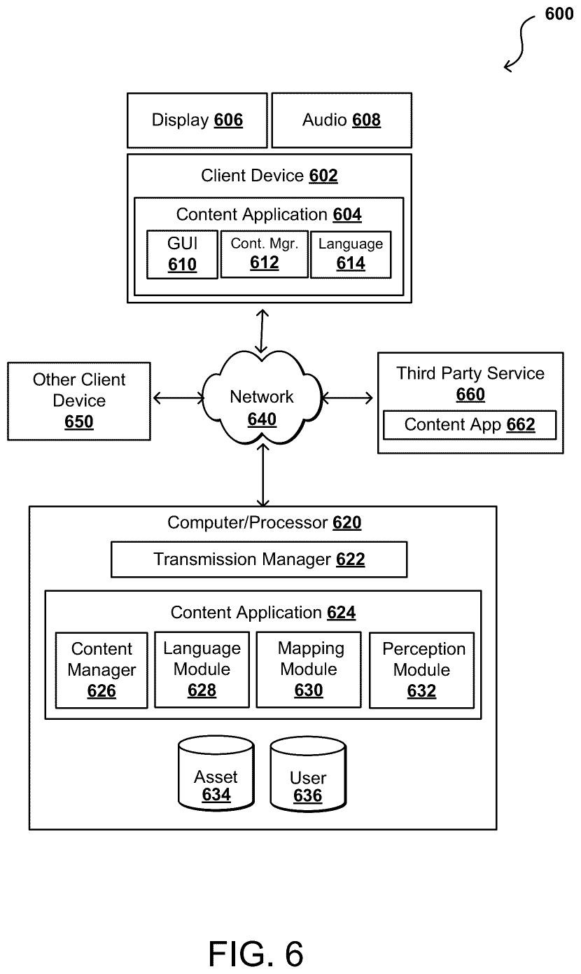

As an example, FIG. 6 illustrates an example network configuration 600 that can be used to provide, generate, modify, encode, process, fuse, and/or transmit generated data or other such content. In at least one embodiment, a client device 602 can generate or receive data for a session using components of a content application 604 on client device 602 and data stored locally on that client device. In at least one embodiment, a content application 624 executing on a computer or processor 620 may initiate a session associated with at least one client device 602 (e.g., a vehicle or robot), as may use a session manager and user data stored in a user database 636, and can cause content such as one or more digital assets (e.g., implicit and/or explicit object representations or maps) from an asset repository 634 to be determined by a content manager 626. A content manager 626 may work with a trained language module 628 to generate text-based representations of an environment based upon several types of input data. This may include mapping and/or sensor data, where the mapping data may be generated and/or identified by a mapping module 630, which may be correlated with perception data generated by a perception module 632 based on captured sensor data or other such information. In at least one embodiment, differences between the map data and local observation or perception data can be determined using a language model 614, 628, for example, and these differences can be provided to a mapping module 630 to attempt to determine whether to update at least local map data, At least a portion of the generated text-based representations, as may correspond to map data or updates to specific map data, can be transmitted to the client device 602 using an appropriate transmission manager 622 to send by download, streaming, or another such transmission channel. An encoder may be used to encode and/or compress at least some of this data before transmitting to the client device 602. In at least one embodiment, the client device 602 receiving such content can provide this content to a corresponding content application 604, which may also or alternatively include a graphical user interface 610 and content manager 612 for use in providing, synthesizing, rendering, compositing, modifying, or using content for presentation (or other purposes) on or by the client device 602. The content application 604 can also include a language module 614 that can perform various generating tasks, such as to update or augment a text-based representation, update map data, determine differences between map data and observation/sensor data, or to generate textual descriptions using map and/or perception data on the client device itself. In some embodiments, the computer 620 and client device 602 may be able to communicate directly without needing to transmit data over a network 640, in order to avoid issues with latency and availability, etc. Adecoder may also be used to decode data received over the network 640 for presentation via client device 602, such as image or video content through a display device 606 and audio, such as sounds and music, through at least one audio playback device 608, such as speakers or headphones. In at least one embodiment, at least some of this content may already be stored on, rendered on, or accessible to client device 602 such that transmission over network 640 is not required for at least that portion of content, such as where that content may have been previously downloaded or stored locally on a hard drive or optical disk. In at least one embodiment, a transmission mechanism such as data streaming can be used to transfer this content from computer or processor 620, or user database 636, to client device 602. In at least one embodiment, at least a portion of this content can be obtained, enhanced, and/or streamed from another source, such as a third party service 660 or other client device 650, that may also include a content application 662 for generating, enhancing, or providing content. In at least one embodiment, portions of this functionality can be performed using multiple computing devices, or multiple processors within one or more computing devices, such as may include a combination of CPUs and GPUs (Graphics Processing Unit).

In this example, these client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, which sits on a network edge and is outside at least one security layer associated with the cloud provider environment. In this way, latency can be reduced by allowing the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device or may incorporate one or more Virtual Machines (VMs). In at least one embodiment, such a system can be implemented at least partially in a data center or at least partially using cloud computing resources.

### Inference and Training Logic

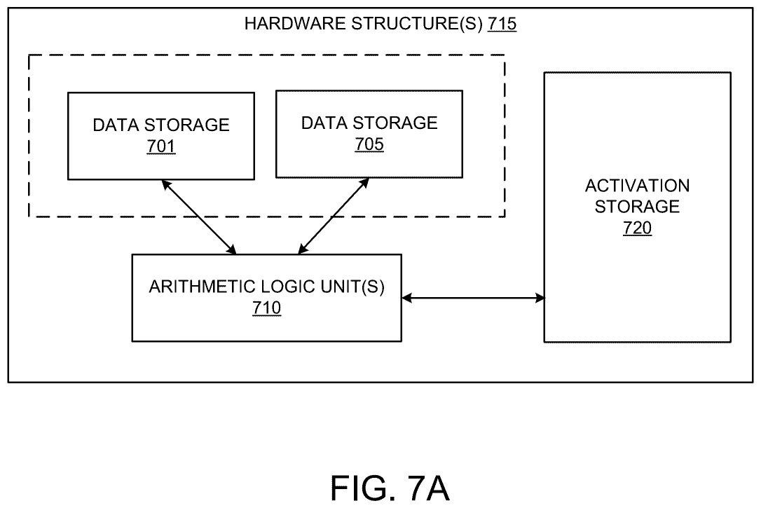

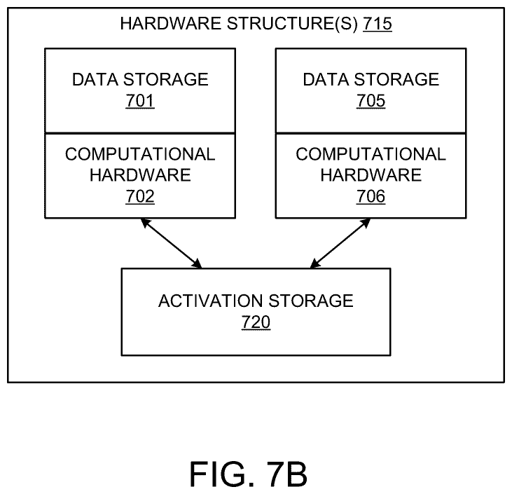

FIG. 7A illustrates inference and/or training logic 715 used to perform inferencing and/or training operations associated with one or more embodiments. Details regarding inference and/or training logic 715 are provided below in conjunction with FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or data storage 701 may be cache memory, dynamic randomly addressable memory (“DRAM”), static randomly addressable memory (“SRAM”), non-volatile memory (e.g., Flash memory), or other storage. In at least one embodiment, choice of whether code and/or data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to on one or more processors or other hardware logic devices or circuits. In at least one embodiment, code and/or data storage 705 may be cache memory, DRAM, SRAM, non-volatile memory (e.g., Flash memory), or other storage. In at least one embodiment, choice of whether code and/or data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be same storage structure. In at least one embodiment, code and/or data storage 701 and code and/or data storage 705 may be partially same storage structure and partially separate storage structures. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 701 and/or code and/or data storage 705 are used as operands along with other values, such as bias values, gradient information, momentum values, or other parameters or hyperparameters, any or all of which may be stored in code and/or data storage 701 or code and/or data storage 705 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one or more embodiments. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one “storage/computational pair 701/702” of code and/or data storage 701 and computational hardware 702 is provided as an input to “storage/computational pair 705/706” of code and/or data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Data Center

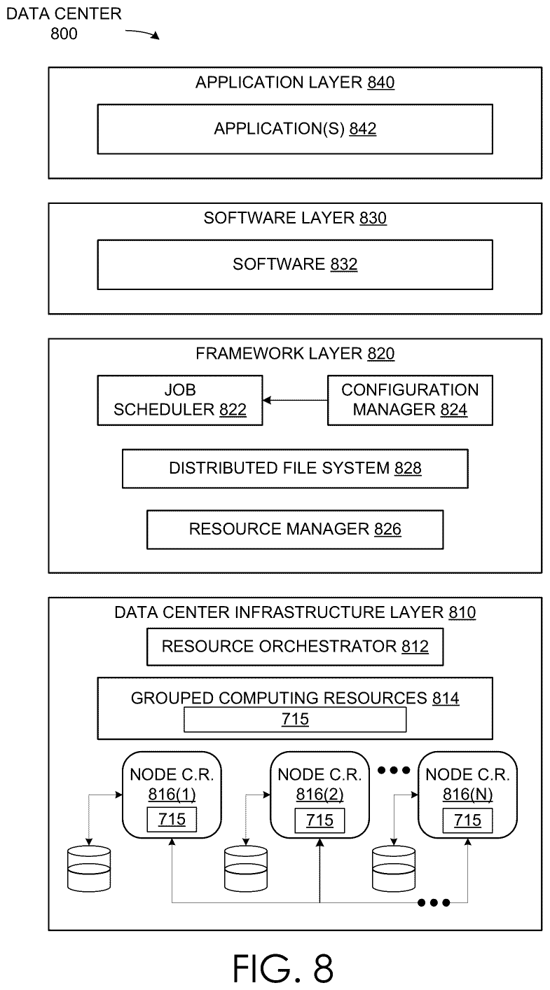

FIG. 8 illustrates an example data center 800, in which at least one embodiment may be used. In at least one embodiment, data center 800 includes a data center infrastructure layer 810, a framework layer 820, a software layer 830, and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator 812 may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may use distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. The one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underused and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components can be used to identify differences between local map data and live perception or observation data, and determine whether to update the local map data for at least the relevant region of a physical environment.

### Computer Systems

FIG. 9 is a block diagram illustrating an exemplary computer system 900, which may be a system with interconnected devices and components, a system-on-a-chip (SOC) or some combination thereof formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution unit(s) 908 to perform machine learning model training and/or inferencing according to techniques described herein. In at least one embodiment, computer system 900 is a single processor desktop or server system, but in another embodiment computer system 900 may be a multiprocessor system. In at least one embodiment, processor 902 may include, without limitation, a complex instruction set computing (“CISC”) microprocessor, a reduced instruction set computing (“RISC”) microprocessor, a very long instruction word computing (“VLIW”) microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache 904 may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer register.

In at least one embodiment, execution unit(s) 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit(s) 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor data bus 910 for performing operations on packed data, which may eliminate need to transfer smaller units of data across processor data bus 910 to perform one or more operations one data element at a time.

In at least one embodiment, execution unit(s) 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interface(s) 925, a serial expansion port 927, such as Universal Serial Bus (“USB”), and a network controller 934. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components can be used to identify differences between local map data and live perception or observation data, and determine whether to update the local map data for at least the relevant region of a physical environment.

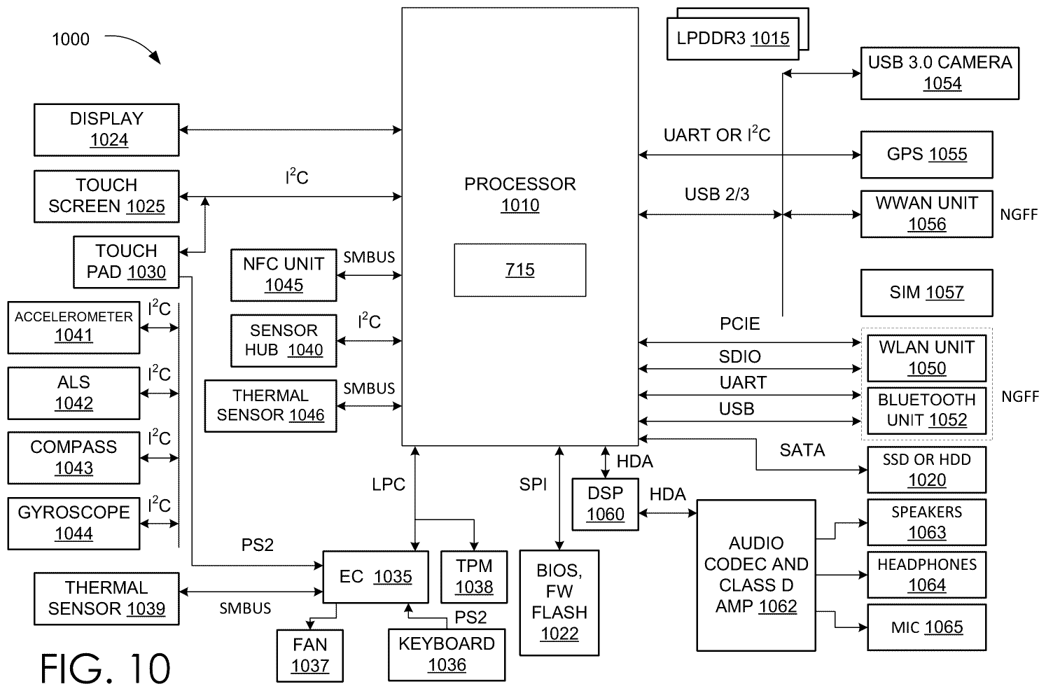

FIG. 10 is a block diagram illustrating an electronic device 1000 for using a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 1000 may include, without limitation, processor 1010 communicatively coupled to any suitable number or kind of components, peripherals, modules, or devices. In at least one embodiment, processor 1010 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 10 illustrates an electronic device 1000, which includes interconnected hardware devices or “chips”, whereas in other embodiments, FIG. 10 may illustrate an exemplary System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1036, and a touch pad 1030 may be communicatively coupled to EC 1035. In at least one embodiment, speakers 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1062 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 10 for inferencing or predicting operations based, at least in part, on weight parameters calculated using neural network training operations, neural network functions and/or architectures, or neural network use cases described herein.

Such components can be used to identify differences between local map data and live perception or observation data, and determine whether to update the local map data for at least the relevant region of a physical environment.

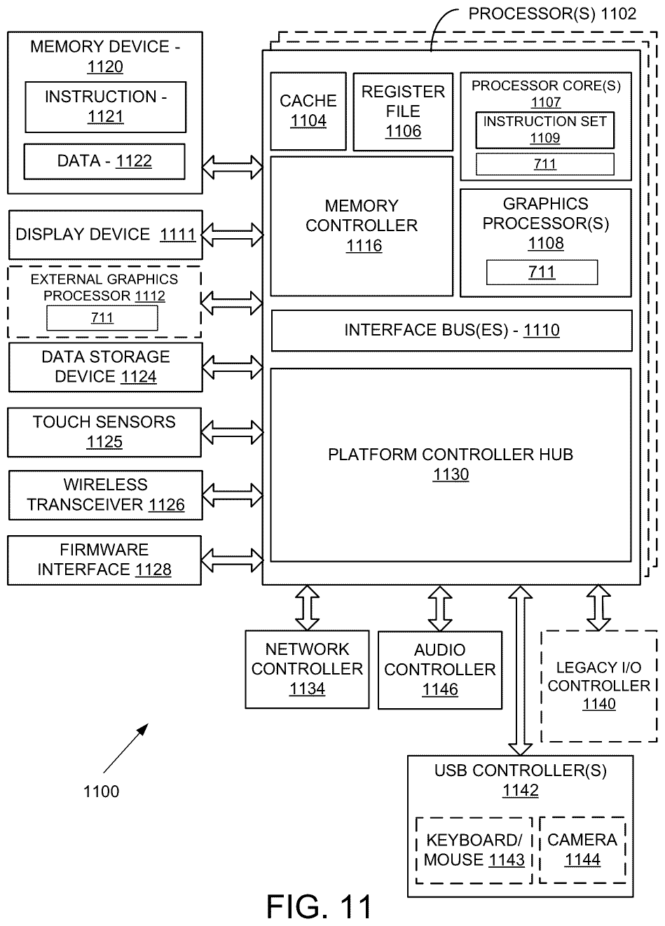

FIG. 11 is a block diagram of a processing system, according to at least one embodiment. In at least one embodiment, processing system 1100 includes one or more processor(s) 1102 and one or more graphics processor(s) 1108, and may be a single processor desktop system, a multiprocessor workstation system, or a server system having a large number of processor(s) 1102 or processor core(s) 1107. In at least one embodiment, processing system 1100 is a processing platform incorporated within a system-on-a-chip (SoC) integrated circuit for use in mobile, handheld, or embedded devices.

In at least one embodiment, processing system 1100 can include, or be incorporated within a server-based gaming platform, a game console, including a game and media console, a mobile gaming console, a handheld game console, or an online game console. In at least one embodiment, processing system 1100 is a mobile phone, smart phone, tablet computing device or mobile Internet device. In at least one embodiment, processing system 1100 can also include, coupled with, or be integrated within a wearable device, such as a smart watch wearable device, smart eyewear device, augmented reality device, or virtual reality device. In at least one embodiment, processing system 1100 is a television or set top box device having one or more processor(s) 1102 and a graphical interface generated by one or more graphics processor(s) 1108.

In at least one embodiment, one or more processor(s) 1102 each include one or more processor core(s) 1107 to process instructions which, when executed, perform operations for system and user software. In at least one embodiment, each of one or more processor core(s) 1107 is configured to process a specific instruction set 1109. In at least one embodiment, instruction set 1109 may facilitate Complex Instruction Set Computing (CISC), Reduced Instruction Set Computing (RISC), or computing via a Very Long Instruction Word (VLIW). In at least one embodiment, processor core(s) 1107 may each process a different instruction set 1109, which may include instructions to facilitate emulation of other instruction sets. In at least one embodiment, processor core(s) 1107 may also include other processing devices, such a Digital Signal Processor (DSP).

In at least one embodiment, processor(s) 1102 includes cache memory (“cache”) 1104. In at least one embodiment, processor(s) 1102 can have a single internal cache or multiple levels of internal cache. In at least one embodiment, cache 1104 is shared among various components of processor(s) 1102. In at least one embodiment, processor(s) 1102 also uses an external cache (e.g., a Level-3 (L3) cache or Last Level Cache (LLC)) (not shown), which may be shared among processor core(s) 1107 using known cache coherency techniques. In at least one embodiment, register file 1106 is additionally included in processor(s) 1102 which may include different types of registers for storing different types of data (e.g., integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor(s) 1102 and other components in processing system 1100. In at least one embodiment, interface bus(es) 1110, in one embodiment, can be a processor bus, such as a version of a Direct Media Interface (DMI) bus. In at least one embodiment, interface bus(es) 1110 is not limited to a DMI bus, and may include one or more Peripheral Component Interconnect buses (e.g., PCI, PCI Express), memory buses, or other types of interface buses. In at least one embodiment processor(s) 1102 include an integrated memory controller 1116 and a platform controller hub 1130. In at least one embodiment, memory controller 1116 facilitates communication between a memory device 1120 and other components of processing system 1100, while platform controller hub (PCH) 1130 provides connections to I/O devices via a local I/O bus.

In at least one embodiment, memory device 1120 can be a dynamic random access memory (DRAM) device, a static random access memory (SRAM) device, flash memory device, phase-change memory device, or some other memory device having suitable performance to serve as process memory. In at least one embodiment memory device 1120 can operate as system memory for processing system 1100, to store data 1122 and instruction 1121 for use when one or more processor(s) 1102 executes an application or process. In at least one embodiment, memory controller 1116 also couples with an optional external graphics processor 1112, which may communicate with one or more graphics processor(s) 1108 in processor(s) 1102 to perform graphics and media operations. In at least one embodiment, a display device 1111 can connect to processor(s) 1102. In at least one embodiment display device 1111 can include one or more of an internal display device, as in a mobile electronic device or a laptop device or an external display device attached via a display interface (e.g., DisplayPort, etc.). In at least one embodiment, display device 1111 can include a head mounted display (HMD) such as a stereoscopic display device for use in virtual reality (VR) applications or augmented reality (AR) applications.

In at least one embodiment, platform controller hub 1130 allows peripherals to connect to memory device 1120 and processor(s) 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (e.g., hard disk drive, flash memory, etc.). In at least one embodiment, data storage device 1124 can connect via a storage interface (e.g., SATA) or via a peripheral bus, such as a Peripheral Component Interconnect bus (e.g., PCI, PCI Express). In at least one embodiment, touch sensors 1125 can include touch screen sensors, pressure sensors, or fingerprint sensors. In at least one embodiment, wireless transceiver 1126 can be a Wi-Fi transceiver, a Bluetooth transceiver, or a mobile network transceiver such as a 3G, 4G, or Long Term Evolution (LTE) transceiver. In at least one embodiment, firmware interface 1128 allows communication with system firmware, and can be, for example, a unified extensible firmware interface (UEFI). In at least one embodiment, network controller 1134 can allow a network connection to a wired network. In at least one embodiment, a high-performance network controller (not shown) couples with interface bus(es) 1110. In at least one embodiment, audio controller 1146 is a multi-channel high definition audio controller. In at least one embodiment, processing system 1100 includes an optional legacy I/O controller 1140 for coupling legacy (e.g., Personal System 2 (PS/2)) devices to system. In at least one embodiment, platform controller hub 1130 can also connect to one or more Universal Serial Bus (USB) controller(s) 1142 connect input devices, such as keyboard and mouse 1143 combinations, a camera 1144, or other USB input devices.

In at least one embodiment, an instance of memory controller 1116 and platform controller hub 1130 may be integrated into a discreet external graphics processor, such as external graphics processor 1112. In at least one embodiment, platform controller hub 1130 and/or memory controller 1116 may be external to one or more processor(s) 1102. For example, in at least one embodiment, processing system 1100 can include an external memory controller 1116 and platform controller hub 1130, which may be configured as a memory controller hub and peripheral controller hub within a system chipset that is in communication with processor(s) 1102.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processing system 1100. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can be used to identify differences between local map data and live perception or observation data, and determine whether to update the local map data for at least the relevant region of a physical environment.

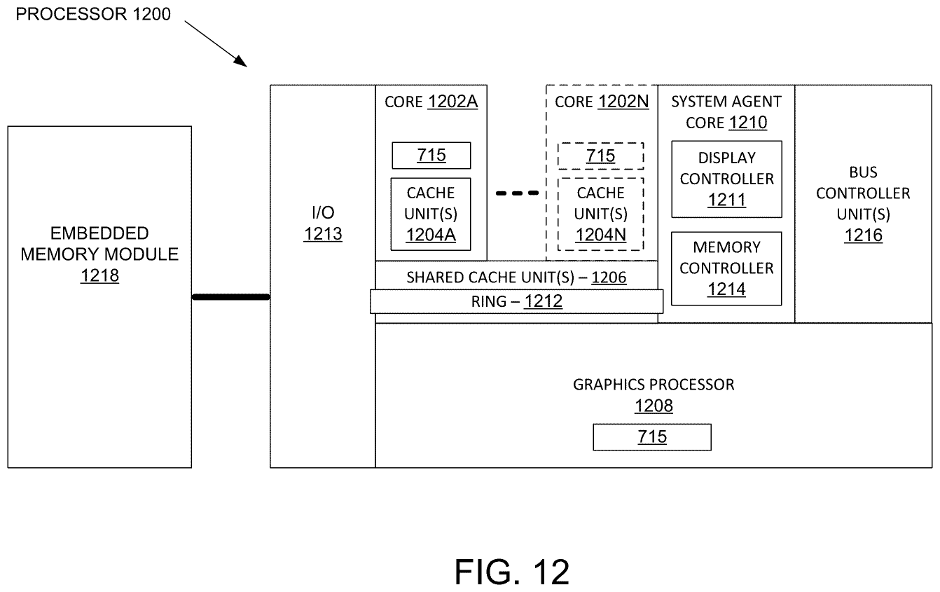

FIG. 12 is a block diagram of a processor 1200 having one or more processor core(s) 1202A-1202N, an integrated memory controller 1214, and an integrated graphics processor 1208, according to at least one embodiment. In at least one embodiment, processor 1200 can include additional cores up to and including additional core(s) 1202N represented by dashed lined boxes. In at least one embodiment, each of processor core(s) 1202A-1202N includes one or more internal cache unit(s) 1204A-1204N. In at least one embodiment, each processor core also has access to one or more shared cached unit(s) 1206.

In at least one embodiment, internal cache unit(s) 1204A-1204N and shared cache unit(s) 1206 represent a cache memory hierarchy within processor 1200. In at least one embodiment, cache memory unit(s) 1204A-1204N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache unit(s) 1206 and 1204A-1204N.

In at least one embodiment, processor 1200 may also include a set of one or more bus controller unit(s) 1216 and a system agent core 1210. In at least one embodiment, one or more bus controller unit(s) 1216 manage a set of peripheral buses, such as one or more PCI or PCI express buses. In at least one embodiment, system agent core 1210 provides management functionality for various processor components. In at least one embodiment, system agent core 1210 includes one or more integrated memory controller(s) 1214 to manage access to various external memory devices (not shown).

In at least one embodiment, one or more of processor core(s) 1202A-1202N include support for simultaneous multi-threading. In at least one embodiment, system agent core 1210 includes components for coordinating and processor core(s) 1202A-1202N during multi-threaded processing. In at least one embodiment, system agent core 1210 may additionally include a power control unit (PCU), which includes logic and components to regulate one or more power states of processor core(s) 1202A-1202N and graphics processor 1208.

In at least one embodiment, processor 1200 additionally includes graphics processor 1208 to execute graphics processing operations. In at least one embodiment, graphics processor 1208 couples with shared cache unit(s) 1206, and system agent core 1210, including one or more integrated memory controller(s) 1214. In at least one embodiment, system agent core 1210 also includes a display controller 1211 to drive graphics processor output to one or more coupled displays. In at least one embodiment, display controller 1211 may also be a separate module coupled with graphics processor 1208 via at least one interconnect, or may be integrated within graphics processor 1208.

In at least one embodiment, a ring based interconnect unit 1212 is used to couple internal components of processor 1200. In at least one embodiment, an alternative interconnect unit may be used, such as a point-to-point interconnect, a switched interconnect, or other techniques. In at least one embodiment, graphics processor 1208 couples with ring based interconnect unit 1212 via an I/O link 1213.

In at least one embodiment, I/O link 1213 represents at least one of multiple varieties of I/O interconnects, including an on package I/O interconnect which facilitates communication between various processor components and a high-performance embedded memory module 1218, such as an eDRAM module. In at least one embodiment, each of processor core(s) 1202A-1202N and graphics processor 1208 use embedded memory module 1218 as a shared Last Level Cache.

In at least one embodiment, processor core(s) 1202A-1202N are homogenous cores executing a common instruction set architecture. In at least one embodiment, processor core(s) 1202A-1202N are heterogeneous in terms of instruction set architecture (ISA), where one or more of processor core(s) 1202A-1202N execute a common instruction set, while one or more other cores of processor core(s) 1202A-1202N executes a subset of a common instruction set or a different instruction set. In at least one embodiment, processor core(s) 1202A-1202N are heterogeneous in terms of microarchitecture, where one or more cores having a relatively higher power consumption couple with one or more power cores having a lower power consumption. In at least one embodiment, processor 1200 can be implemented on one or more chips or as an SoC integrated circuit.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processor 1200. For example, in at least one embodiment, training and/or inferencing techniques described herein may use one or more of ALUs embodied in graphics processor 1208, graphics core(s) 1202A-1202N, or other components in FIG. 12. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of graphics processor 1200 to perform one or more machine learning algorithms, neural network architectures, use cases, or training techniques described herein.

Such components can be used to identify differences between local map data and live perception or observation data, and determine whether to update the local map data for at least the relevant region of a physical environment.

### Virtualized Computing Platform

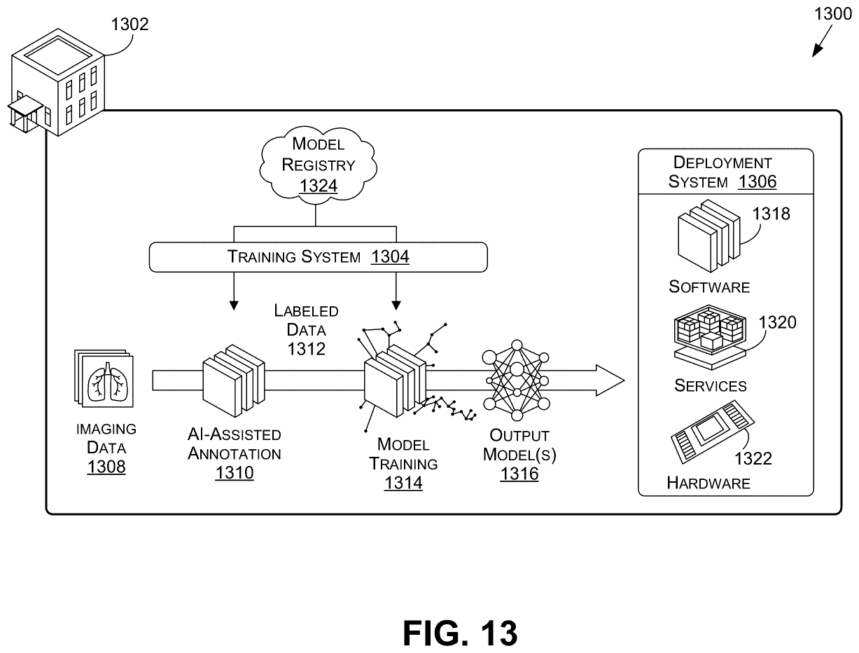

FIG. 13 is an example data flow diagram for a process 1300 of generating and deploying an image processing and inferencing pipeline, in accordance with at least one embodiment. In at least one embodiment, process 1300 may be deployed for use with imaging devices, processing devices, and/or other device types at one or more facility(ies) 1302. Process 1300 may be executed within a training system 1304 and/or a deployment system 1306. In at least one embodiment, training system 1304 may be used to perform training, deployment, and implementation of machine learning models (e.g., neural networks, object detection algorithms, computer vision algorithms, etc.) for use in deployment system 1306. In at least one embodiment, deployment system 1306 may be configured to offload processing and compute resources among a distributed computing environment to reduce infrastructure requirements at facility(ies) 1302. In at least one embodiment, one or more applications in a pipeline may use or call upon services (e.g., inference, visualization, compute, Al, etc.) of deployment system 1306 during execution of applications.

In at least one embodiment, some of applications used in advanced processing and inferencing pipelines may use machine learning models or other Al to perform one or more processing steps. In at least one embodiment, machine learning models may be trained at facility(ies) 1302 using data 1308 (such as imaging data) generated at facility(ies) 1302 (and stored on one or more picture archiving and communication system (PACS) servers at facility(ies) 1302), may be trained using imaging or sequencing data 1308 from another facility(ies), or a combination thereof. In at least one embodiment, training system 1304 may be used to provide applications, services, and/or other resources for generating working, deployable machine learning models for deployment system 1306.

In at least one embodiment, model registry 1324 may be backed by object storage that may support versioning and object metadata. In at least one embodiment, object storage may be accessible through, for example, a cloud storage compatible application programming interface (API) from within a cloud platform. In at least one embodiment, machine learning models within model registry 1324 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training pipeline 1304 (FIG. 13) may include a scenario where facility(ies) 1302 is training their own machine learning model, or has an existing machine learning model that needs to be optimized or updated. In at least one embodiment, imaging data 1308 generated by imaging device(s), sequencing devices, and/or other device types may be received. In at least one embodiment, once imaging data 1308 is received, AI-assisted annotation 1310 may be used to aid in generating annotations corresponding to imaging data 1308 to be used as ground truth data for a machine learning model. In at least one embodiment, AI-assisted annotation 1310 may include one or more machine learning models (e.g., convolutional neural networks (CNNs)) that may be trained to generate annotations corresponding to certain types of imaging data 1308 (e.g., from certain devices). In at least one embodiment, AI-assisted annotation 1310 may then be used directly, or may be adjusted or fine-tuned using an annotation tool to generate ground truth data. In at least one embodiment, AI-assisted annotation 1310, labeled data 1312, or a combination thereof may be used as ground truth data for training a machine learning model. In at least one embodiment, a trained machine learning model may be referred to as output model(s) 1316, and may be used by deployment system 1306, as described herein.

In at least one embodiment, a training pipeline may include a scenario where facility(ies) 1302 needs a machine learning model for use in performing one or more processing tasks for one or more applications in deployment system 1306, but facility(ies) 1302 may not currently have such a machine learning model (or may not have a model that is optimized, efficient, or effective for such purposes). In at least one embodiment, an existing machine learning model may be selected from a model registry 1324. In at least one embodiment, model registry 1324 may include machine learning models trained to perform a variety of different inference tasks on imaging data. In at least one embodiment, machine learning models in model registry 1324 may have been trained on imaging data from different facilities than facility(ies) 1302 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1324. In at least one embodiment, a machine learning model may then be retrained, or updated, at any number of other facilities, and a retrained or updated model may be made available in model registry 1324. In at least one embodiment, a machine learning model may then be selected from model registry 1324—and referred to as output model(s) 1316—and may be used in deployment system 1306 to perform one or more processing tasks for one or more applications of a deployment system.

In at least one embodiment, a scenario may include facility(ies) 1302 requiring a machine learning model for use in performing one or more processing tasks for one or more applications in deployment system 1306, but facility(ies) 1302 may not currently have such a machine learning model (or may not have a model that is optimized, efficient, or effective for such purposes). In at least one embodiment, a machine learning model selected from model registry 1324 may not be fine-tuned or optimized for imaging data 1308 generated at facility(ies) 1302 because of differences in populations, robustness of training data used to train a machine learning model, diversity in anomalies of training data, and/or other issues with training data. In at least one embodiment, AI-assisted annotation 1310 may be used to aid in generating annotations corresponding to imaging data 1308 to be used as ground truth data for retraining or updating a machine learning model. In at least one embodiment, labeled data 1312 may be used as ground truth data for training a machine learning model. In at least one embodiment, retraining or updating a machine learning model may be referred to as model training 1314. In at least one embodiment, model training 1314—e.g., AI-assisted annotation 1310, labeled data 1312, or a combination thereof—may be used as ground truth data for retraining or updating a machine learning model. In at least one embodiment, a trained machine learning model may be referred to as output model(s) 1316, and may be used by deployment system 1306, as described herein.

In at least one embodiment, deployment system 1306 may include software 1318, services 1320, hardware 1322, and/or other components, features, and functionality. In at least one embodiment, deployment system 1306 may include a software “stack,” such that software 1318 may be built on top of services 1320 and may use services 1320 to perform some or all of processing tasks, and services 1320 and software 1318 may be built on top of hardware 1322 and use hardware 1322 to execute processing, storage, and/or other compute tasks of deployment system 1306. In at least one embodiment, software 1318 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1308, in addition to containers that receive and configure imaging data for use by each container and/or for use by facility(ies) 1302 after processing through a pipeline (e.g., to convert outputs back to a usable data type). In at least one embodiment, a combination of containers within software 1318 (e.g., that make up a pipeline) may be referred to as a virtual instrument (as described in more detail herein), and a virtual instrument may leverage services 1320 and hardware 1322 to execute some or all processing tasks of applications instantiated in containers.

In at least one embodiment, a data processing pipeline may receive input data (e.g., imaging data 1308) in a specific format in response to an inference request (e.g., a request from a user of deployment system 1306). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 1316 of training system 1304.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1324 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1320 as a system (e.g., processor 1200 of FIG. 12). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by process 1300 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., process 1300 of FIG. 13). In at least one embodiment, completed and validated applications or containers may be stored in a container registry and associated machine learning models may be stored in model registry 1324. In at least one embodiment, a requesting entity—who provides an inference or image processing request—may browse a container registry and/or model registry 1324 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1306 (e.g., a cloud) to perform processing of data processing pipeline. In at least one embodiment, processing by deployment system 1306 may include referencing selected elements (e.g., applications, containers, models, etc.) from a container registry and/or model registry 1324. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1320 may be leveraged. In at least one embodiment, services 1320 may include compute services, artificial intelligence (AI) services, visualization services, and/or other service types. In at least one embodiment, services 1320 may provide functionality that is common to one or more applications in software 1318, so functionality may be abstracted to a service that may be called upon or leveraged by applications. In at least one embodiment, functionality provided by services 1320 may run dynamically and more efficiently, while also scaling well by allowing applications to process data in parallel (e.g., using a parallel computing platform). In at least one embodiment, rather than each application that shares a same functionality offered by services 1320 being required to have a respective instance of services 1320, services 1320 may be shared between and among various applications. In at least one embodiment, services 1320 may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects—such as ray-tracing, rasterization, denoising, sharpening, etc. - to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where a services 1320 includes an Al service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1318 implementing advanced processing and inferencing pipeline that includes segmentation application and anomaly detection application may be streamlined because each application may call upon a same inference service to perform one or more inferencing tasks.

In at least one embodiment, hardware 1322 may include GPUs, CPUs, graphics cards, an Al/deep learning system (e.g., an Al supercomputer, such as NVIDIA's DGX), a cloud platform, or a combination thereof. In at least one embodiment, different types of hardware 1322 may be used to provide efficient, purpose-built support for software 1318 and services 1320 in deployment system 1306. In at least one embodiment, use of GPU processing may be implemented for processing locally (e.g., at facility(ies) 1302), within an AI/deep learning system, in a cloud system, and/or in other processing components of deployment system 1306 to improve efficiency, accuracy, and efficacy of image processing and generation. In at least one embodiment, software 1318 and/or services 1320 may be optimized for GPU processing with respect to deep learning, machine learning, and/or high-performance computing, as non-limiting examples. In at least one embodiment, at least some of computing environment of deployment system 1306 and/or training system 1304 may be executed in a datacenter one or more supercomputers or high performance computing systems, with GPU optimized software (e.g., hardware and software combination of NVIDIA's DGX System). In at least one embodiment, hardware 1322 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to allow seamless scaling and load balancing.

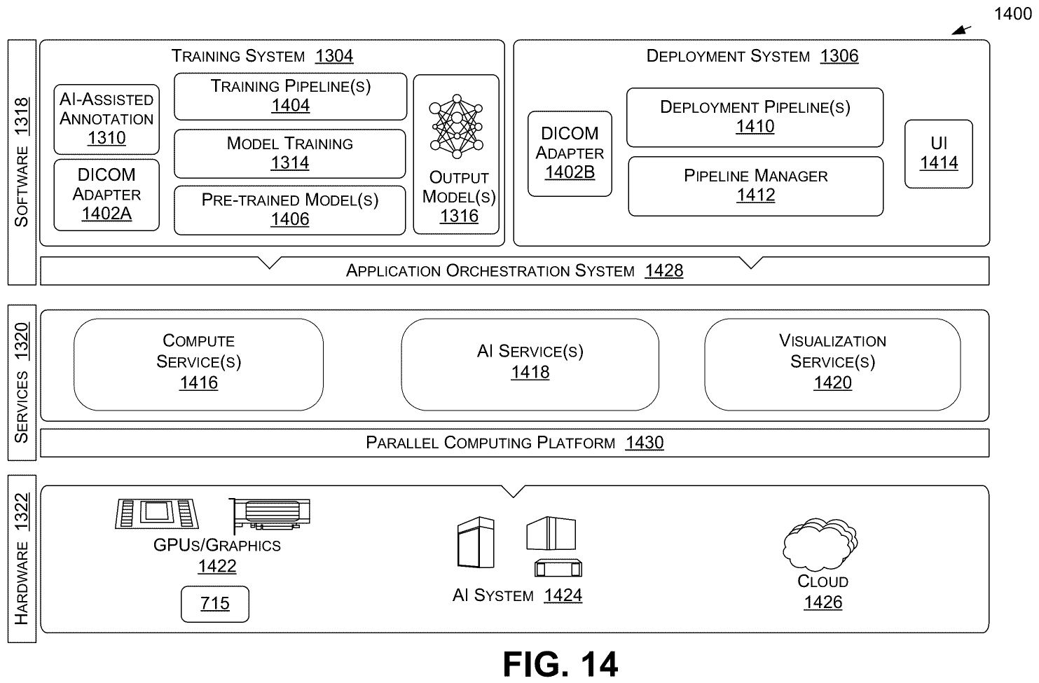

FIG. 14 is a system diagram for an example system 1400 for generating and deploying an imaging deployment pipeline, in accordance with at least one embodiment. In at least one embodiment, system 1400 may be used to implement process 1300 of FIG. 13 and/or other processes including advanced processing and inferencing pipelines. In at least one embodiment, system 1400 may include training system 1304 and deployment system 1306. In at least one embodiment, training system 1304 and deployment system 1306 may be implemented using software 1318, services 1320, and/or hardware 1322, as described herein.

In at least one embodiment, system 1400 (e.g., training system 1304 and/or deployment system 1306) may implemented in a cloud computing environment (e.g., using cloud 1426). In at least one embodiment, system 1400 may be implemented locally with respect to a healthcare services facility, or as a combination of both cloud and local computing resources. In at least one embodiment, access to APIs in cloud 1426 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1400, may be restricted to a set of public IPs that have been vetted or authorized for interaction.

In at least one embodiment, various components of system 1400 may communicate between and among one another using any of a variety of different network types, including but not limited to local area networks (LANs) and/or wide area networks (WANs) via wired and/or wireless communication protocols. In at least one embodiment, communication between facilities and components of system 1400 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1304 may execute training pipeline(s) 1404, similar to those described herein with respect to FIG. 13. In at least one embodiment, where one or more machine learning models are to be used in deployment pipeline(s) 1410 by deployment system 1306, training pipeline(s) 1404 may be used to train or retrain one or more (e.g. pre-trained) models, and/or implement one or more of pre-trained model(s) 1406 (e.g., without a need for retraining or updating). In at least one embodiment, as a result of training pipeline(s) 1404, output model(s) 1316 may be generated. In at least one embodiment, training pipeline(s) 1404 may include any number of processing steps, such as but not limited to imaging data (or other input data) conversion or adaption In at least one embodiment, for different machine learning models used by deployment system 1306, different training pipeline(s) 1404 may be used. In at least one embodiment, training pipeline(s) 1404 similar to a first example described with respect to FIG. 13 may be used for a first machine learning model, training pipeline(s) 1404 similar to a second example described with respect to FIG. 13 may be used for a second machine learning model, and training pipeline(s) 1404 similar to a third example described with respect to FIG. 13 may be used for a third machine learning model. In at least one embodiment, any combination of tasks within training system 1304 may be used depending on what is required for each respective machine learning model. In at least one embodiment, one or more of machine learning models may already be trained and ready for deployment so machine learning models may not undergo any processing by training system 1304, and may be implemented by deployment system 1306.

In at least one embodiment, output model(s) 1316 and/or pre-trained model(s) 1406 may include any types of machine learning models depending on implementation or embodiment. In at least one embodiment, and without limitation, machine learning models used by system 1400 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

In at least one embodiment, training pipeline(s) 1404 may include AI-assisted annotation, as described in more detail herein with respect to at least FIG. 14. In at least one embodiment, labeled data 1312 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1308 (or other data type used by machine learning models), there may be corresponding ground truth data generated by training system 1304. In at least one embodiment, AI-assisted annotation 1310 may be performed as part of deployment pipelines 1410; either in addition to, or in lieu of AI-assisted annotation 1310 included in training pipeline(s) 1404. In at least one embodiment, system 1400 may include a multi-layer platform that may include a software layer (e.g., software 1318) of diagnostic applications (or other application types) that may perform one or more medical imaging and diagnostic functions. In at least one embodiment, system 1400 may be communicatively coupled to (e.g., via encrypted links) PACS server networks of one or more facilities. In at least one embodiment, system 1400 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility(ies) 1302). In at least one embodiment, applications may then call or execute one or more services 1320 for performing compute, Al, or visualization tasks associated with respective applications, and software 1318 and/or services 1320 may leverage hardware 1322 to perform processing tasks in an effective and efficient manner. In at least one embodiment, communications sent to, or received by, a training system 1304 and a deployment system 1306 may occur using a pair of DICOM adapters 1402A, 1402B.

In at least one embodiment, deployment system 1306 may execute deployment pipeline(s) 1410. In at least one embodiment, deployment pipeline(s) 1410 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline(s) 1410 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline(s) 1410 depending on information desired from data generated by a device. In at least one embodiment, where detections of anomalies are desired from an MRI machine, there may be a first deployment pipeline(s) 1410, and where image enhancement is desired from output of an MRI machine, there may be a second deployment pipeline(s) 1410.

In at least one embodiment, an image generation application may include a processing task that includes use of a machine learning model. In at least one embodiment, a user may desire to use their own machine learning model, or to select a machine learning model from model registry 1324. In at least one embodiment, a user may implement their own machine learning model or select a machine learning model for inclusion in an application for performing a processing task. In at least one embodiment, applications may be selectable and customizable, and by defining constructs of applications, deployment and implementation of applications for a particular user are presented as a more seamless user experience. In at least one embodiment, by leveraging other features of system 1400—such as services 1320 and hardware 1322—deployment pipeline(s) 1410 may be even more user friendly, provide for easier integration, and produce more accurate, efficient, and timely results.

In at least one embodiment, deployment system 1306 may include a user interface (“UI”) 1414 (e.g., a graphical user interface, a web interface, etc.) that may be used to select applications for inclusion in deployment pipeline(s) 1410, arrange applications, modify or change applications or parameters or constructs thereof, use and interact with deployment pipeline(s) 1410 during set-up and/or deployment, and/or to otherwise interact with deployment system 1306. In at least one embodiment, although not illustrated with respect to training system 1304, UI 1414 (or a different user interface) may be used for selecting models for use in deployment system 1306, for selecting models for training, or retraining, in training system 1304, and/or for otherwise interacting with training system 1304.

In at least one embodiment, pipeline manager 1412 may be used, in addition to an application orchestration system 1428, to manage interaction between applications or containers of deployment pipeline(s) 1410 and services 1320 and/or hardware 1322. In at least one embodiment, pipeline manager 1412 may be configured to facilitate interactions from application to application, from application to services 1320, and/or from application or service to hardware 1322. In at least one embodiment, although illustrated as included in software 1318, this is not intended to be limiting, and in some examples pipeline manager 1412 may be included in services 1320. In at least one embodiment, application orchestration system 1428 (e.g., Kubernetes, DOCKER, etc.) may include a container orchestration system that may group applications into containers as logical units for coordination, management, scaling, and deployment. In at least one embodiment, by associating applications from deployment pipeline(s) 1410 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1412 and application orchestration system 1428. In at least one embodiment, so long as an expected input and/or output of each container or application is known by a system (e.g., based on constructs of applications or containers), application orchestration system 1428 and/or pipeline manager 1412 may facilitate communication among and between, and sharing of resources among and between, each of applications or containers. In at least one embodiment, because one or more of applications or containers in deployment pipeline(s) 1410 may share same services and resources, application orchestration system 1428 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1428) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1320 leveraged by and shared by applications or containers in deployment system 1306 may include compute service(s) 1416, Al service(s) 1418, visualization service(s) 1420, and/or other service types. In at least one embodiment, applications may call (e.g., execute) one or more of services 1320 to perform processing operations for an application. In at least one embodiment, compute service(s) 1416 may be leveraged by applications to perform super-computing or other high-performance computing (HPC) tasks. In at least one embodiment, compute service(s) 1416 may be leveraged to perform parallel processing (e.g., using a parallel computing platform 1430) for processing data through one or more of applications and/or one or more tasks of a single application, substantially simultaneously. In at least one embodiment, parallel computing platform 1430 (e.g., NVIDIA's CUDA) may allow general purpose computing on GPUs (GPGPU) (e.g., GPUs/Graphics 1422).

In at least one embodiment, a software layer of parallel computing platform 1430 may provide access to virtual instruction sets and parallel computational elements of GPUs, for execution of compute kernels. In at least one embodiment, parallel computing platform 1430 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1430 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, Al service(s) 1418 may be leveraged to perform inferencing services for executing machine learning model(s) associated with applications (e.g., tasked with performing one or more processing tasks of an application). In at least one embodiment, Al service(s) 1418 may leverage Al system 1424 to execute machine learning model(s) (e.g., neural networks, such as CNNs) for segmentation, reconstruction, object detection, feature detection, classification, and/or other inferencing tasks. In at least one embodiment, applications of deployment pipeline(s) 1410 may use one or more of output model(s) 1316 from training system 1304 and/or other models of applications to perform inference on imaging data. In at least one embodiment, two or more examples of inferencing using application orchestration system 1428 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1428 may distribute resources (e.g., services 1320 and/or hardware 1322) based on priority paths for different inferencing tasks of Al service(s) 1418.

In at least one embodiment, shared storage may be mounted to Al service(s) 1418 within system 1400. In at least one embodiment, shared storage may operate as a cache (or other storage device type) and may be used to process inference requests from applications. In at least one embodiment, when an inference request is submitted, a request may be received by a set of API instances of deployment system 1306, and one or more instances may be selected (e.g., for best fit, for load balancing, etc.) to process a request. In at least one embodiment, to process a request, a request may be entered into a database, a machine learning model may be located from model registry 1324 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1412) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<10 min). In at least one embodiment, model execution times may be measured from requesting institution or entity and may include partner network traversal time, as well as execution on an inference service.

In at least one embodiment, transfer of requests between services 1320 and inference applications may be hidden behind a software development kit (SDK), and robust transport may be provide through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1426, and an inference service may perform inferencing on a GPU.

In at least one embodiment, visualization service(s) 1420 may be leveraged to generate visualizations for viewing outputs of applications and/or deployment pipeline(s) 1410. In at least one embodiment, GPUs/Graphics 1422 may be leveraged by visualization service(s) 1420 to generate visualizations. In at least one embodiment, rendering effects, such as ray-tracing, may be implemented by visualization service(s) 1420 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 1420 may include an internal visualizer, cinematics, and/or other rendering or image processing capabilities or functionality (e.g., ray tracing, rasterization, internal optics, etc.).

In at least one embodiment, hardware 1322 may include GPUs/Graphics 1422, Al system 1424, cloud 1426, and/or any other hardware used for executing training system 1304 and/or deployment system 1306. In at least one embodiment, GPUs/Graphics 1422 (e.g., NVIDIA's TESLA and/or QUADRO GPUs) may include any number of GPUs that may be used for executing processing tasks of compute service(s) 1416, Al service(s) 1418, visualization service(s) 1420, other services, and/or any of features or functionality of software 1318. For example, with respect to Al service(s) 1418, GPUs/Graphics 1422 may be used to perform pre-processing on imaging data (or other data types used by machine learning models), post-processing on outputs of machine learning models, and/or to perform inferencing (e.g., to execute machine learning models). In at least one embodiment, cloud 1426, Al system 1424, and/or other components of system 1400 may use GPUs/Graphics 1422. In at least one embodiment, cloud 1426 may include a GPU-optimized platform for deep learning tasks. In at least one embodiment, Al system 1424 may use GPUs, and cloud 1426—or at least a portion tasked with deep learning or inferencing—may be executed using one or more Al systems 1424. As such, although hardware 1322 is illustrated as discrete components, this is not intended to be limiting, and any components of hardware 1322 may be combined with, or leveraged by, any other components of hardware 1322.

In at least one embodiment, Al system 1424 may include a purpose-built computing system (e.g., a super-computer or an HPC) configured for inferencing, deep learning, machine learning, and/or other artificial intelligence tasks. In at least one embodiment, Al system 1424 (e.g., NVIDIA's DGX) may include GPU-optimized software (e.g., a software stack) that may be executed using a plurality of GPUs/Graphics 1422, in addition to CPUs, RAM, storage, and/or other components, features, or functionality. In at least one embodiment, one or more Al systems 1424 may be implemented in cloud 1426 (e.g., in a data center) for performing some or all of AI-based processing tasks of system 1400.

In at least one embodiment, cloud 1426 may include a GPU-accelerated infrastructure (e.g., NVIDIA's NGC) that may provide a GPU-optimized platform for executing processing tasks of system 1400. In at least one embodiment, cloud 1426 may include an Al system(s) 1424 for performing one or more of AI-based tasks of system 1400 (e.g., as a hardware abstraction and scaling platform). In at least one embodiment, cloud 1426 may integrate with application orchestration system 1428 leveraging multiple GPUs to allow seamless scaling and load balancing between and among applications and services 1320. In at least one embodiment, cloud 1426 may tasked with executing at least some of services 1320 of system 1400, including compute service(s) 1416, Al service(s) 1418, and/or visualization service(s) 1420, as described herein. In at least one embodiment, cloud 1426 may perform small and large batch inference (e.g., executing NVIDIA's TENSOR RT), provide an accelerated parallel computing API and platform 1430 (e.g., NVIDIA's CUDA), execute application orchestration system 1428 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1400.

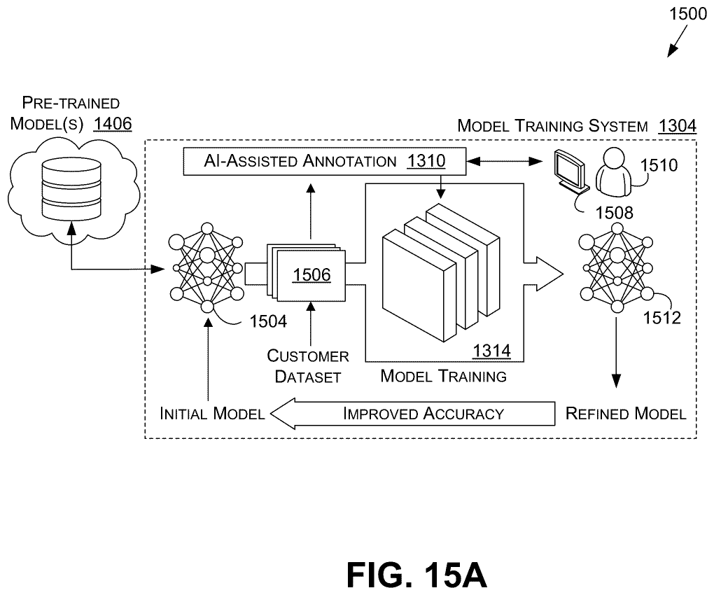

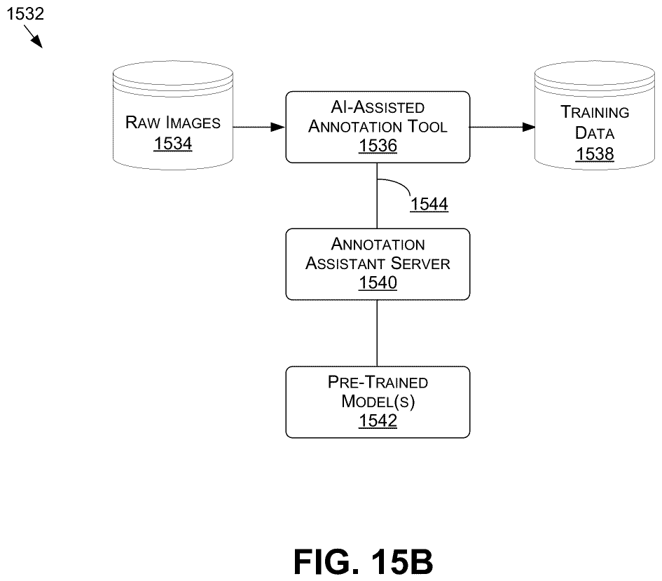

FIG. 15A illustrates a data flow diagram for a process 1500 to train, retrain, or update a machine learning model, in accordance with at least one embodiment. In at least one embodiment, process 1500 may be executed using, as a non-limiting example, system 1400 of FIG. 14. In at least one embodiment, process 1500 may leverage services and/or hardware as described herein. In at least one embodiment, refined model 1512 generated by process 1500 may be executed by a deployment system for one or more containerized applications in deployment pipelines 1510.

In at least one embodiment, model training 1514 may include retraining or updating an initial model 1504 (e.g., a pre-trained model) using new training data (e.g., new input data, such as customer dataset 1506, and/or new ground truth data associated with input data). In at least one embodiment, to retrain, or update, initial model 1504, output or loss layer(s) of initial model 1504 may be reset, deleted, and/or replaced with an updated or new output or loss layer(s). In at least one embodiment, initial model 1504 may have previously fine-tuned parameters (e.g., weights and/or biases) that remain from prior training, so training or retraining 1514 may not take as long or require as much processing as training a model from scratch. In at least one embodiment, during model training, by having reset or replaced output or loss layer(s) of initial model 1504, parameters may be updated and re-tuned for a new data set based on loss calculations associated with accuracy of output or loss layer(s) at generating predictions on new, customer dataset 1506.

In at least one embodiment, pre-trained model(s) 1506 may be stored in a data store, or registry. In at least one embodiment, pre-trained model(s) 1506 may have been trained, at least in part, at one or more facilities other than a facility executing process 1500. In at least one embodiment, to protect privacy and rights of patients, subjects, or clients of different facilities, pre-trained model(s) 1506 may have been trained, on-premise, using customer or patient data generated on-premise. In at least one embodiment, pre-trained model(s) 1506 may be trained using a cloud and/or other hardware, but confidential, privacy protected patient data may not be transferred to, used by, or accessible to any components of a cloud (or other off premise hardware). In at least one embodiment, where pre-trained model(s) 1506 is trained at using patient data from more than one facility, pre-trained model(s) 1506 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained model(s) 1506 on-premise and/or off premise, such as in a datacenter or other cloud computing infrastructure.

In at least one embodiment, when selecting applications for use in deployment pipelines, a user may also select machine learning models to be used for specific applications. In at least one embodiment, a user may not have a model for use, so a user may select pre-trained model(s) 1506 to use with an application. In at least one embodiment, pre-trained model(s) 1506 may not be optimized for generating accurate results on customer dataset 1506 of a facility of a user (e.g., based on patient diversity, demographics, types of medical imaging devices used, etc.). In at least one embodiment, prior to deploying a pre-trained model into a deployment pipeline for use with an application(s), pre-trained model(s) 1506 may be updated, retrained, and/or fine-tuned for use at a respective facility.

In at least one embodiment, a user may select pre-trained model(s) 1506 that is to be updated, retrained, and/or fine-tuned, and this pre-trained model may be referred to as initial model 1504 for a training system within process 1500. In at least one embodiment, a customer dataset 1506 (e.g., imaging data, genomics data, sequencing data, or other data types generated by devices at a facility) may be used to perform model training (which may include, without limitation, transfer learning) on initial model 1504 to generate refined model 1512. In at least one embodiment, ground truth data corresponding to customer dataset 1506 may be generated by model training system 1304. In at least one embodiment, ground truth data may be generated, at least in part, by clinicians, scientists, doctors, practitioners, at a facility.

In at least one embodiment, AI-assisted annotation 1310 may be used in some examples to generate ground truth data. In at least one embodiment, AI-assisted annotation 1310 (e.g., implemented using an AI-assisted annotation SDK) may leverage machine learning models (e.g., neural networks) to generate suggested or predicted ground truth data for a customer dataset. In at least one embodiment, a user may use annotation tools within a user interface (a graphical user interface (GUI)) on a computing device.

In at least one embodiment, user 1510 may interact with a GUI via computing device 1508 to edit or fine-tune (auto)annotations. In at least one embodiment, a polygon editing feature may be used to move vertices of a polygon to more accurate or fine-tuned locations.

In at least one embodiment, once customer dataset 1506 has associated ground truth data, ground truth data (e.g., from AI-assisted annotation, manual labeling, etc.) may be used by during model training to generate refined model 1512. In at least one embodiment, customer dataset 1506 may be applied to initial model 1504 any number of times, and ground truth data may be used to update parameters of initial model 1504 until an acceptable level of accuracy is attained for refined model 1512. In at least one embodiment, once refined model 1512 is generated, refined model 1512 may be deployed within one or more deployment pipelines at a facility for performing one or more processing tasks with respect to medical imaging data.

In at least one embodiment, refined model 1512 may be uploaded to pre-trained models in a model registry to be selected by another facility. In at least one embodiment, this process may be completed at any number of facilities such that refined model 1512 may be further refined on new datasets any number of times to generate a more universal model.

FIG. 15B is an example illustration of a client-server architecture 1532 to enhance annotation tools with pre-trained annotation model(s) 1542, in accordance with at least one embodiment. In at least one embodiment, AI-assisted annotation tool 1536 may be instantiated based on a client-server architecture 1532. In at least one embodiment, AI-assisted annotation tool 1536 in imaging applications may aid radiologists, for example, identify organs and abnormalities. In at least one embodiment, imaging applications may include software tools that help user 1510 to identify, as a non-limiting example, a few extreme points on a particular organ of interest in raw images 1534 (e.g., in a 3D MRI or CT scan) and receive auto-annotated results for all 2D slices of a particular organ. In at least one embodiment, results may be stored in a data store as training data 1538 and used as (for example and without limitation) ground truth data for training. In at least one embodiment, when computing device 1508 sends extreme points for AI-assisted annotation, a deep learning model, for example, may receive this data as input and return inference results of a segmented organ or abnormality. In at least one embodiment, pre-instantiated annotation tools, such as AI-assisted annotation tool 1536 in FIG. 15B, may be enhanced by making API calls (e.g., API Call 1544) to a server, such as an annotation assistant server 1540 that may include a set of pre-trained model(s) 1542 stored in an annotation model registry, for example. In at least one embodiment, an annotation model registry may store pre-trained model(s) 1542 (e.g., machine learning models, such as deep learning models) that are pre-trained to perform AI-assisted annotation 1310 on a particular organ or abnormality. These models may be further updated by using training pipelines. In at least one embodiment, pre-installed annotation tools may be improved over time as new labeled data is added.

### Autonomous Vehicle

FIG. 16A illustrates an example of an autonomous vehicle 1600, according to at least one embodiment. In at least one embodiment, autonomous vehicle 1600 (alternatively referred to herein as “vehicle 1600”) may be, without limitation, a passenger vehicle, such as a car, a truck, a bus, and/or another type of vehicle that accommodates one or more passengers. In at least one embodiment, vehicle 1600 may be a semi-tractor-trailer truck used for hauling cargo. In at least one embodiment, vehicle 1600 may be an airplane, robotic vehicle, or other kind of vehicle.

Autonomous vehicles may be described in terms of automation levels, defined by National Highway Traffic Safety Administration (“NHTSA”), a division of US Department of Transportation, and Society of Automotive Engineers (“SAE”) “Taxonomy and Definitions for Terms Related to Driving Automation Systems for On-Road Motor Vehicles” (e.g., Standard No. J3016-201806, published on Jun. 15, 2018, Standard No. J3016-201609, published on Sep. 30, 2016, and previous and future versions of this standard). In at least one embodiment, vehicle 1600 may be capable of functionality in accordance with one or more of Level 1 through Level 5 of autonomous driving levels. For example, in at least one embodiment, vehicle 1600 may be capable of conditional automation (Level 3), high automation (Level 4), and/or full automation (Level 5), depending on embodiment.

In at least one embodiment, vehicle 1600 may include, without limitation, components such as a chassis, a vehicle body, wheels (e.g., 2, 4, 6, 8, 18, etc.), tires, axles, and other components of a vehicle. In at least one embodiment, vehicle 1600 may include, without limitation, a propulsion system 1650, such as an internal combustion engine, hybrid electric power plant, an all-electric engine, and/or another propulsion system type. In at least one embodiment, propulsion system 1650 may be connected to a drive train of vehicle 1600, which may include, without limitation, a transmission, to enable propulsion of vehicle 1600. In at least one embodiment, propulsion system 1650 may be controlled in response to receiving signals from a throttle/accelerator(s) 1652.

In at least one embodiment, a steering system 1654, which may include, without limitation, a steering wheel, is used to steer vehicle 1600 (e.g., along a desired path or route) when propulsion system 1650 is operating (e.g., when vehicle 1600 is in motion). In at least one embodiment, steering system 1654 may receive signals from steering actuator(s) 1656. In at least one embodiment, a steering wheel may be optional for full automation (Level 5) functionality. In at least one embodiment, a brake sensor system 1646 may be used to operate vehicle brakes in response to receiving signals from brake actuator(s) 1648 and/or brake sensors.

In at least one embodiment, controller(s) 1636, which may include, without limitation, one or more system on chips (“SoCs”) (not shown in FIG. 16A) and/or graphics processing unit(s) (“GPU(s)”), provide signals (e.g., representative of commands) to one or more components and/or systems of vehicle 1600. For instance, in at least one embodiment, controller(s) 1636 may send signals to operate vehicle brakes via brake actuator(s) 1648, to operate steering system 1654 via steering actuator(s) 1656, to operate propulsion system 1650 via throttle/accelerator(s) 1652. In at least one embodiment, controller(s) 1636 may include one or more onboard (e.g., integrated) computing devices that process sensor signals, and output operation commands (e.g., signals representing commands) to enable autonomous driving and/or to assist a human driver in driving vehicle 1600. In at least one embodiment, controller(s) 1636 may include a first controller for autonomous driving functions, a second controller for functional safety functions, a third controller for artificial intelligence functionality (e.g., computer vision), a fourth controller for infotainment functionality, a fifth controller for redundancy in emergency conditions, and/or other controllers. In at least one embodiment, a single controller may handle two or more of above functionalities, two or more controllers may handle a single functionality, and/or any combination thereof.

In at least one embodiment, controller(s) 1636 provide signals for controlling one or more components and/or systems of vehicle 1600 in response to sensor data received from one or more sensors (e.g., sensor inputs). In at least one embodiment, sensor data may be received from, for example and without limitation, global navigation satellite systems (“GNSS”) sensor(s) 1658 (e.g., Global Positioning System sensor(s)), RADAR sensor(s) 1660, ultrasonic sensor(s) 1662, LIDAR sensor(s) 1664, inertial measurement unit (“IMU”) sensor(s) 1666 (e.g., accelerometer(s), gyroscope(s), a magnetic compass or magnetic compasses, magnetometer(s), etc.), microphone(s) 1696, stereo camera(s) 1668, wide-view camera(s) 1670 (e.g., fisheye cameras), infrared camera(s) 1672, surround camera(s) 1674 (e.g., 360 degree cameras), long-range cameras (not shown in FIG. 16A), mid-range camera(s) (not shown in FIG. 16A), speed sensor(s) 1644 (e.g., for measuring speed of vehicle 1600), vibration sensor(s) 1642, steering sensor(s) 1640, brake sensor(s) (e.g., as part of brake sensor system 1646), and/or other sensor types.

In at least one embodiment, one or more of controller(s) 1636 may receive inputs (e.g., represented by input data) from an instrument cluster 1632 of vehicle 1600 and provide outputs (e.g., represented by output data, display data, etc.) via a human-machine interface (“HMI”) display 1634, an audible annunciator, a loudspeaker, and/or via other components of vehicle 1600. In at least one embodiment, outputs may include information such as vehicle velocity, speed, time, map data (e.g., a High Definition map (not shown in FIG. 16A)), location data (e.g., vehicle's 1600 location, such as on a map), direction, location of other vehicles (e.g., an occupancy grid), information about objects and status of objects as perceived by controller(s) 1636, etc. For example, in at least one embodiment, HMI display 1634 may display information about presence of one or more objects (e.g., a street sign, caution sign, traffic light changing, etc.), and/or information about driving maneuvers vehicle has made, is making, or will make (e.g., changing lanes now, taking exit 34B in two miles, etc.).

In at least one embodiment, vehicle 1600 further includes a network interface 1624 which may use wireless antenna(s) 1626 and/or modem(s) to communicate over one or more networks. For example, in at least one embodiment, network interface 1624 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”) networks, etc. In at least one embodiment, wireless antenna(s) 1626 may also enable communication between objects in environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc. protocols.

Inference and/or training logic 715 are used to perform inferencing and/or training operations associated with one or more embodiments. Details regarding inference and/or training logic 715 are provided herein in conjunction with FIGS. 7A and/or 7B. In at least one embodiment, inference and/or training logic 715 may be used in system FIG. 16A for inferencing or predicting operations based, at least in part, on weight parameters calculated using neural network training operations, neural network functions and/or architectures, or neural network use cases described herein.

Such components can be used to identify differences between local map data and live perception or observation data, and determine whether to update the local map data for at least the relevant region of a physical environment.

FIG. 16B illustrates an example of camera locations and fields of view for autonomous vehicle 1600 of FIG. 16A, according to at least one embodiment. In at least one embodiment, cameras and respective fields of view are one example embodiment and are not intended to be limiting. For instance, in at least one embodiment, additional and/or alternative cameras may be included and/or cameras may be located at different locations on vehicle 1600.

In at least one embodiment, camera types for cameras may include, but are not limited to, digital cameras that may be adapted for use with components and/or systems of vehicle 1600. In at least one embodiment, camera(s) may operate at automotive safety integrity level (“ASIL”) B and/or at another ASIL. In at least one embodiment, camera types may be capable of any image capture rate, such as 60 frames per second (fps), 1220 fps, 240 fps, etc., depending on embodiment. In at least one embodiment, cameras may be capable of using rolling shutters, global shutters, another type of shutter, or a combination thereof. In at least one embodiment, color filter array may include a red clear clear clear (“RCCC”) color filter array, a red clear clear blue (“RCCB”) color filter array, a red blue green clear (“RBGC”) color filter array, a Foveon X3 color filter array, a Bayer sensors (“RGGB”) color filter array, a monochrome sensor color filter array, and/or another type of color filter array. In at least one embodiment, clear pixel cameras, such as cameras with an RCCC, an RCCB, and/or an RBGC color filter array, may be used in an effort to increase light sensitivity.

In at least one embodiment, one or more of camera(s) may be used to perform advanced driver assistance systems (“ADAS”) functions (e.g., as part of a redundant or fail-safe design). For example, in at least one embodiment, a Multi-Function Mono Camera may be installed to provide functions including lane departure warning, traffic sign assist and intelligent headlamp control. In at least one embodiment, one or more of camera(s) (e.g., all cameras) may record and provide image data (e.g., video) simultaneously.

In at least one embodiment, one or more camera may be mounted in a mounting assembly, such as a custom designed (three-dimensional (“3D”) printed) assembly, in order to cut out stray light and reflections from within vehicle 1600 (e.g., reflections from dashboard reflected in windshield mirrors) which may interfere with camera image data capture abilities. With reference to wing-mirror mounting assemblies, in at least one embodiment, wing-mirror assemblies may be custom 3D printed so that a camera mounting plate matches a shape of a wing-mirror. In at least one embodiment, camera(s) may be integrated into wing-mirrors. In at least one embodiment, for side-view cameras, camera(s) may also be integrated within four pillars at each corner of a cabin.

In at least one embodiment, cameras with a field of view that include portions of an environment in front of vehicle 1600 (e.g., front-facing cameras) may be used for surround view, to help identify forward facing paths and obstacles, as well as aid in, with help of one or more of controller(s) 1636 and/or control SoCs, providing information critical to generating an occupancy grid and/or determining preferred vehicle paths. In at least one embodiment, front-facing cameras may be used to perform many similar ADAS functions as LIDAR, including, without limitation, emergency braking, pedestrian detection, and collision avoidance. In at least one embodiment, front-facing cameras may also be used for ADAS functions and systems including, without limitation, Lane Departure Warnings (“LDW”), Autonomous Cruise Control (“ACC”), and/or other functions such as traffic sign recognition.

In at least one embodiment, a variety of cameras may be used in a front-facing configuration, including, for example, a monocular camera platform that includes a CMOS (“complementary metal oxide semiconductor”) color imager. In at least one embodiment, a wide-view camera 1670 may be used to perceive objects coming into view from a periphery (e.g., pedestrians, crossing traffic or bicycles). Although only one wide-view camera 1670 is illustrated in FIG. 16B, in other embodiments, there may be any number (including zero) wide-view cameras on vehicle 1600. In at least one embodiment, any number of long-range camera(s) 1698 (e.g., a long-view stereo camera pair) may be used for depth-based object detection, especially for objects for which a neural network has not yet been trained. In at least one embodiment, long-range camera(s) 1698 may also be used for object detection and classification, as well as basic object tracking.

In at least one embodiment, any number of stereo camera(s) 1668 may also be included in a front-facing configuration. In at least one embodiment, one or more of stereo camera(s) 1668 may include an integrated control unit comprising a scalable processing unit, which may provide a programmable logic (“FPGA”) and a multi-core micro-processor with an integrated Controller Area Network (“CAN”) or Ethernet interface on a single chip. In at least one embodiment, such a unit may be used to generate a 3D map of an environment of vehicle 1600, including a distance estimate for all points in an image. In at least one embodiment, one or more of stereo camera(s) 1668 may include, without limitation, compact stereo vision sensor(s) that may include, without limitation, two camera lenses (one each on left and right) and an image processing chip that may measure distance from vehicle 1600 to target object and use generated information (e.g., metadata) to activate autonomous emergency braking and lane departure warning functions. In at least one embodiment, other types of stereo camera(s) 1668 may be used in addition to, or alternatively from, those described herein.

In at least one embodiment, cameras with a field of view that include portions of environment to sides of vehicle 1600 (e.g., side-view cameras) may be used for surround view, providing information used to create and update an occupancy grid, as well as to generate side impact collision warnings. For example, in at least one embodiment, surround camera(s) 1674 (e.g., four surround cameras as illustrated in FIG. 16B) could be positioned on vehicle 1600. In at least one embodiment, surround camera(s) 1674 may include, without limitation, any number and combination of wide-view cameras, fisheye camera(s), 360 degree camera(s), and/or similar cameras. For instance, in at least one embodiment, four fisheye cameras may be positioned on a front, a rear, and sides of vehicle 1600. In at least one embodiment, vehicle 1600 may use three surround camera(s) 1674 (e.g., left, right, and rear), and may leverage one or more other camera(s) (e.g., a forward-facing camera) as a fourth surround-view camera.

In at least one embodiment, cameras with a field of view that include portions of an environment behind vehicle 1600 (e.g., rear-view cameras) may be used for parking assistance, surround view, rear collision warnings, and creating and updating an occupancy grid. In at least one embodiment, a wide variety of cameras may be used including, but not limited to, cameras that are also suitable as a front-facing camera(s) (e.g., long-range camera(s) 1698 and/or mid-range camera(s) 1676, stereo camera(s) 1668, infrared camera(s) 1672, etc.,) as described herein.

Inference and/or training logic 715 are used to perform inferencing and/or training operations associated with one or more embodiments. Details regarding inference and/or training logic 715 are provided herein in conjunction with FIGS. 7A and/or 7B. In at least one embodiment, inference and/or training logic 715 may be used in system FIG. 16B for inferencing or predicting operations based, at least in part, on weight parameters calculated using neural network training operations, neural network functions and/or architectures, or neural network use cases described herein.

Such components can be used to identify differences between local map data and live perception or observation data, and determine whether to update the local map data for at least the relevant region of a physical environment.

FIG. 16C is a block diagram illustrating an example system architecture for autonomous vehicle 1600 of FIG. 16A, according to at least one embodiment. In at least one embodiment, each of components, features, and systems of vehicle 1600 in FIG. 16C is illustrated as being connected via a bus 1602. In at least one embodiment, bus 1602 may include, without limitation, a CAN data interface (alternatively referred to herein as a “CAN bus”). In at least one embodiment, a CAN may be a network inside vehicle 1600 used to aid in control of various features and functionality of vehicle 1600, such as actuation of brakes, acceleration, braking, steering, windshield wipers, etc. In at least one embodiment, bus 1602 may be configured to have dozens or even hundreds of nodes, each with its own unique identifier (e.g., a CAN ID). In at least one embodiment, bus 1602 may be read to find steering wheel angle, ground speed, engine revolutions per minute (“RPMs”), button positions, and/or other vehicle status indicators. In at least one embodiment, bus 1602 may be a CAN bus that is ASIL B compliant.

In at least one embodiment, in addition to, or alternatively from CAN, FlexRay and/or Ethernet protocols may be used. In at least one embodiment, there may be any number of busses forming bus 1602, which may include, without limitation, zero or more CAN busses, zero or more FlexRay busses, zero or more Ethernet busses, and/or zero or more other types of busses using different protocols. In at least one embodiment, two or more busses may be used to perform different functions, and/or may be used for redundancy. For example, a first bus may be used for collision avoidance functionality and a second bus may be used for actuation control. In at least one embodiment, each bus of bus 1602 may communicate with any of components of vehicle 1600, and two or more busses of bus 1602 may communicate with corresponding components. In at least one embodiment, each of any number of system(s) on chip(s) (“SoC(s)”) 1604 (such as SoC 1604(A) and SoC 1604(B)), each of controller(s) 1636, and/or each computer within vehicle may have access to same input data (e.g., inputs from sensors of vehicle 1600), and may be connected to a common bus, such CAN bus.

In at least one embodiment, vehicle 1600 may include one or more controller(s) 1636, such as those described herein with respect to FIG. 16A. In at least one embodiment, controller(s) 1636 may be used for a variety of functions. In at least one embodiment, controller(s) 1636 may be coupled to any of various other components and systems of vehicle 1600, and may be used for control of vehicle 1600, artificial intelligence of vehicle 1600, infotainment for vehicle 1600, and/or other functions.

In at least one embodiment, vehicle 1600 may include any number of SoCs 1604. In at least one embodiment, each of SoCs 1604 may include, without limitation, central processing units (“CPU(s)”) 1606, graphics processing units (“GPU(s)”) 1608, processor(s) 1610, cache(s) 1612, accelerator(s) 1614, data store(s) 1616, and/or other components and features not illustrated. In at least one embodiment, SoC(s) 1604 may be used to control vehicle 1600 in a variety of platforms and systems. For example, in at least one embodiment, SoC(s) 1604 may be combined in a system (e.g., system of vehicle 1600) with a High Definition (“HD”) map 1622 which may obtain map refreshes and/or updates via network interface 1624 from one or more servers (not shown in FIG. 16C).

In at least one embodiment, CPU(s) 1606 may include a CPU cluster or CPU complex (alternatively referred to herein as a “CCPLEX”). In at least one embodiment, CPU(s) 1606 may include multiple cores and/or level two (“L2”) caches. For instance, in at least one embodiment, CPU(s) 1606 may include eight cores in a coherent multi-processor configuration. In at least one embodiment, CPU(s) 1606 may include four dual-core clusters where each cluster has a dedicated L2 cache (e.g., a 2 megabyte (MB) L2 cache). In at least one embodiment, CPU(s) 1606 (e.g., CCPLEX) may be configured to support simultaneous cluster operations enabling any combination of clusters of CPU(s) 1606 to be active at any given time.

In at least one embodiment, one or more of CPU(s) 1606 may implement power management capabilities that include, without limitation, one or more of following features: individual hardware blocks may be clock-gated automatically when idle to save dynamic power; each core clock may be gated when such core is not actively executing instructions due to execution of Wait for Interrupt (“WFI”)/Wait for Event (“WFE”) instructions; each core may be independently power-gated; each core cluster may be independently clock-gated when all cores are clock-gated or power-gated; and/or each core cluster may be independently power-gated when all cores are power-gated. In at least one embodiment, CPU(s) 1606 may further implement an enhanced algorithm for managing power states, where allowed power states and expected wakeup times are specified, and hardware/microcode determines which best power state to enter for core, cluster, and CCPLEX. In at least one embodiment, processing cores may support simplified power state entry sequences in software with work offloaded to microcode.

In at least one embodiment, GPU(s) 1608 may include an integrated GPU (alternatively referred to herein as an “iGPU”). In at least one embodiment, GPU(s) 1608 may be programmable and may be efficient for parallel workloads. In at least one embodiment, GPU(s) 1608 may use an enhanced tensor instruction set. In at least one embodiment, GPU(s) 1608 may include one or more streaming microprocessors, where each streaming microprocessor may include a level one (“L1”) cache (e.g., an L1 cache with at least 96 KB storage capacity), and two or more streaming microprocessors may share an L2 cache (e.g., an L2 cache with a 512 KB storage capacity). In at least one embodiment, GPU(s) 1608 may include at least eight streaming microprocessors. In at least one embodiment, GPU(s) 1608 may use compute application programming interface(s) (API(s)). In at least one embodiment, GPU(s) 1608 may use one or more parallel computing platforms and/or programming models (e.g., NVIDIA's CUDA model).

In at least one embodiment, one or more of GPU(s) 1608 may be power-optimized for best performance in automotive and embedded use cases. For example, in at least one embodiment, GPU(s) 1608 could be fabricated on Fin field-effect transistor (“FinFET”) circuitry. In at least one embodiment, each streaming microprocessor may incorporate a number of mixed-precision processing cores partitioned into multiple blocks. For example, and without limitation, 64 PF32 cores and 32 PF64 cores could be partitioned into four processing blocks. In at least one embodiment, each processing block could be allocated 16 FP32 cores, 8 FP64 cores, 16 INT32 cores, two mixed-precision NVIDIA Tensor cores for deep learning matrix arithmetic, a level zero (“L0”) instruction cache, a scheduler (e.g., warp scheduler) or sequencer, a dispatch unit, and/or a 64 KB register file. In at least one embodiment, streaming microprocessors may include independent parallel integer and floating-point data paths to provide for efficient execution of workloads with a mix of computation and addressing calculations. In at least one embodiment, streaming microprocessors may include independent thread scheduling capability to enable finer-grain synchronization and cooperation between parallel threads. In at least one embodiment, streaming microprocessors may include a combined L1 data cache and shared memory unit in order to improve performance while simplifying programming.

In at least one embodiment, one or more of GPU(s) 1608 may include a high bandwidth memory (“HBM”) and/or a 16 GB HBM2 memory subsystem to provide, in some examples, about 900 GB/second peak memory bandwidth. In at least one embodiment, in addition to, or alternatively from, HBM memory, a synchronous graphics random-access memory (“SGRAM”) may be used, such as a graphics double data rate type five synchronous random-access memory (“GDDR5”).

In at least one embodiment, GPU(s) 1608 may include unified memory technology. In at least one embodiment, address translation services (“ATS”) support may be used to allow GPU(s) 1608 to access CPU(s) 1606 page tables directly. In at least one embodiment, embodiment, when a GPU of GPU(s) 1608 memory management unit (“MMU”) experiences a miss, an address translation request may be transmitted to CPU(s) 1606. In response, 2 CPU of CPU(s) 1606 may look in its page tables for a virtual-to-physical mapping for an address and transmit translation back to GPU(s) 1608, in at least one embodiment. In at least one embodiment, unified memory technology may allow a single unified virtual address space for memory of both CPU(s) 1606 and GPU(s) 1608, thereby simplifying GPU(s) 1608 programming and porting of applications to GPU(s) 1608.

In at least one embodiment, GPU(s) 1608 may include any number of access counters that may keep track of frequency of access of GPU(s) 1608 to memory of other processors. In at least one embodiment, access counter(s) may help ensure that memory pages are moved to physical memory of a processor that is accessing pages most frequently, thereby improving efficiency for memory ranges shared between processors.

In at least one embodiment, one or more of SoC(s) 1604 may include any number of cache(s) 1612, including those described herein. For example, in at least one embodiment, cache(s) 1612 could include a level three (“L3”) cache that is available to both CPU(s) 1606 and GPU(s) 1608 (e.g., that is connected to CPU(s) 1606 and GPU(s) 1608). In at least one embodiment, cache(s) 1612 may include a write-back cache that may keep track of states of lines, such as by using a cache coherence protocol (e.g., MEI, MESI, MSI, etc.). In at least one embodiment, a L3 cache may include 4 MB of memory or more, depending on embodiment, although smaller cache sizes may be used.

In at least one embodiment, one or more of SoC(s) 1604 may include one or more accelerator(s) 1614 (e.g., hardware accelerators, software accelerators, or a combination thereof). In at least one embodiment, SoC(s) 1604 may include a hardware acceleration cluster that may include optimized hardware accelerators and/or large on-chip memory. In at least one embodiment, large on-chip memory (e.g., 4 MB of SRAM), may enable a hardware acceleration cluster to accelerate neural networks and other calculations. In at least one embodiment, a hardware acceleration cluster may be used to complement GPU(s) 1608 and to off-load some of tasks of GPU(s) 1608 (e.g., to free up more cycles of GPU(s) 1608 for performing other tasks). In at least one embodiment, accelerator(s) 1614 could be used for targeted workloads (e.g., perception, convolutional neural networks (“CNNs”), recurrent neural networks (“RNNs”), etc.) that are stable enough to be amenable to acceleration. In at least one embodiment, a CNN may include a region-based or regional convolutional neural networks (“RCNNs”) and Fast RCNNs (e.g., as used for object detection) or other type of CNN.

In at least one embodiment, accelerator(s) 1614 (e.g., hardware acceleration cluster) may include one or more deep learning accelerator (“DLA”). In at least one embodiment, DLA(s) may include, without limitation, one or more Tensor processing units (“TPUs”) that may be configured to provide an additional ten trillion operations per second for deep learning applications and inferencing. In at least one embodiment, TPUs may be accelerators configured to, and optimized for, performing image processing functions (e.g., for CNNs, RCNNs, etc.). In at least one embodiment, DLA(s) may further be optimized for a specific set of neural network types and floating point operations, as well as inferencing. In at least one embodiment, design of DLA(s) may provide more performance per millimeter than a typical general-purpose GPU, and typically vastly exceeds performance of a CPU. In at least one embodiment, TPU(s) may perform several functions, including a single-instance convolution function, supporting, for example, INT8, INT16, and FP16 data types for both features and weights, as well as post-processor functions. In at least one embodiment, DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

In at least one embodiment, DLA(s) may perform any function of GPU(s) 1608, and by using an inference accelerator, for example, a designer may target either DLA(s) or GPU(s) 1608 for any function. For example, in at least one embodiment, a designer may focus processing of CNNs and floating point operations on DLA(s) and leave other functions to GPU(s) 1608 and/or accelerator(s) 1614.

In at least one embodiment, accelerator(s) 1614 may include programmable vision accelerator (“PVA”), which may alternatively be referred to herein as a computer vision accelerator. In at least one embodiment, PVA may be designed and configured to accelerate computer vision algorithms for advanced driver assistance system (“ADAS”) 1638, autonomous driving, augmented reality (“AR”) applications, and/or virtual reality (“VR”) applications. In at least one embodiment, PVA may provide a balance between performance and flexibility. For example, in at least one embodiment, each PVA may include, for example and without limitation, any number of reduced instruction set computer (“RISC”) cores, direct memory access (“DMA”), and/or any number of vector processors.

In at least one embodiment, RISC cores may interact with image sensors (e.g., image sensors of any cameras described herein), image signal processor(s), etc. In at least one embodiment, each RISC core may include any amount of memory. In at least one embodiment, RISC cores may use any of a number of protocols, depending on embodiment. In at least one embodiment, RISC cores may execute a real-time operating system (“RTOS”). In at least one embodiment, RISC cores may be implemented using one or more integrated circuit devices, application specific integrated circuits (“ASICs”), and/or memory devices. For example, in at least one embodiment, RISC cores could include an instruction cache and/or a tightly coupled RAM.

In at least one embodiment, DMA may enable components of PVA to access system memory independently of CPU(s) 1606. In at least one embodiment, DMA may support any number of features used to provide optimization to a PVA including, but not limited to, supporting multi-dimensional addressing and/or circular addressing. In at least one embodiment, DMA may support up to six or more dimensions of addressing, which may include, without limitation, block width, block height, block depth, horizontal block stepping, vertical block stepping, and/or depth stepping.

In at least one embodiment, vector processors may be programmable processors that may be designed to efficiently and flexibly execute programming for computer vision algorithms and provide signal processing capabilities. In at least one embodiment, a PVA may include a PVA core and two vector processing subsystem partitions. In at least one embodiment, a PVA core may include a processor subsystem, DMA engine(s) (e.g., two DMA engines), and/or other peripherals. In at least one embodiment, a vector processing subsystem may operate as a primary processing engine of a PVA, and may include a vector processing unit (“VPU”), an instruction cache, and/or vector memory (e.g., “VMEM”). In at least one embodiment, VPU core may include a digital signal processor such as, for example, a single instruction, multiple data (“SIMD”), very long instruction word (“VLIW”) digital signal processor. In at least one embodiment, a combination of SIMD and VLIW may enhance throughput and speed.

In at least one embodiment, each of vector processors may include an instruction cache and may be coupled to dedicated memory. As a result, in at least one embodiment, each of vector processors may be configured to execute independently of other vector processors. In at least one embodiment, vector processors that are included in a particular PVA may be configured to employ data parallelism. For instance, in at least one embodiment, plurality of vector processors included in a single PVA may execute a common computer vision algorithm, but on different regions of an image. In at least one embodiment, vector processors included in a particular PVA may simultaneously execute different computer vision algorithms, on one image, or even execute different algorithms on sequential images or portions of an image. In at least one embodiment, among other things, any number of PVAs may be included in hardware acceleration cluster and any number of vector processors may be included in each PVA. In at least one embodiment, PVA may include additional error correcting code (“ECC”) memory, to enhance overall system safety.

In at least one embodiment, accelerator(s) 1614 may include a computer vision network on-chip and static random-access memory (“SRAM”), for providing a high-bandwidth, low latency SRAM for accelerator(s) 1614. In at least one embodiment, on-chip memory may include at least 4 MB SRAM, comprising, for example and without limitation, eight field-configurable memory blocks, that may be accessible by both a PVA and a DLA. In at least one embodiment, each pair of memory blocks may include an advanced peripheral bus (“APB”) interface, configuration circuitry, a controller, and a multiplexer. In at least one embodiment, any type of memory may be used. In at least one embodiment, a PVA and a DLA may access memory via a backbone that provides a PVA and a DLA with high-speed access to memory. In at least one embodiment, a backbone may include a computer vision network on-chip that interconnects a PVA and a DLA to memory (e.g., using APB).

In at least one embodiment, a computer vision network on-chip may include an interface that determines, before transmission of any control signal/address/data, that both a PVA and a DLA provide ready and valid signals. In at least one embodiment, an interface may provide for separate phases and separate channels for transmitting control signals/addresses/data, as well as burst-type communications for continuous data transfer. In at least one embodiment, an interface may comply with International Organization for Standardization (“ISO”) 26262 or International Electrotechnical Commission (“IEC”) 61508 standards, although other standards and protocols may be used.

In at least one embodiment, one or more of SoC(s) 1604 may include a real-time ray-tracing hardware accelerator. In at least one embodiment, real-time ray-tracing hardware accelerator may be used to quickly and efficiently determine positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses.

In at least one embodiment, accelerator(s) 1614 can have a wide array of uses for autonomous driving. In at least one embodiment, a PVA may be used for key processing stages in ADAS and autonomous vehicles. In at least one embodiment, a PVA's capabilities are a good match for algorithmic domains needing predictable processing, at low power and low latency. In other words, a PVA performs well on semi-dense or dense regular computation, even on small data sets, which might require predictable run-times with low latency and low power. In at least one embodiment, such as in vehicle 1600, PVAs might be designed to run classic computer vision algorithms, as they can be efficient at object detection and operating on integer math.

For example, according to at least one embodiment of technology, a PVA is used to perform computer stereo vision. In at least one embodiment, a semi-global matching-based algorithm may be used in some examples, although this is not intended to be limiting. In at least one embodiment, applications for Level 3-5 autonomous driving use motion estimation/stereo matching on-the-fly (e.g., structure from motion, pedestrian recognition, lane detection, etc.). In at least one embodiment, a PVA may perform computer stereo vision functions on inputs from two monocular cameras.

In at least one embodiment, a PVA may be used to perform dense optical flow. For example, in at least one embodiment, a PVA could process raw RADAR data (e.g., using a 4D Fast Fourier Transform) to provide processed RADAR data. In at least one embodiment, a PVA is used for time of flight depth processing, by processing raw time of flight data to provide processed time of flight data, for example.

In at least one embodiment, a DLA may be used to run any type of network to enhance control and driving safety, including for example and without limitation, a neural network that outputs a measure of confidence for each object detection. In at least one embodiment, confidence may be represented or interpreted as a probability, or as providing a relative “weight” of each detection compared to other detections. In at least one embodiment, a confidence measure enables a system to make further decisions regarding which detections should be considered as true positive detections rather than false positive detections. In at least one embodiment, a system may set a threshold value for confidence and consider only detections exceeding threshold value as true positive detections. In an embodiment in which an automatic emergency braking (“AEB”) system is used, false positive detections would cause vehicle to automatically perform emergency braking, which is obviously undesirable. In at least one embodiment, highly confident detections may be considered as triggers for AEB. In at least one embodiment, a DLA may run a neural network for regressing confidence value. In at least one embodiment, neural network may take as its input at least some subset of parameters, such as bounding box dimensions, ground plane estimate obtained (e.g., from another subsystem), output from IMU sensor(s) 1666 that correlates with vehicle 1600 orientation, distance, 3D location estimates of object obtained from neural network and/or other sensors (e.g., LIDAR sensor(s) 1664 or RADAR sensor(s) 1660), among others.

In at least one embodiment, one or more of SoC(s) 1604 may include data store(s) 1616 (e.g., memory). In at least one embodiment, data store(s) 1616 may be on-chip memory of SoC(s) 1604, which may store neural networks to be executed on GPU(s) 1608 and/or a DLA. In at least one embodiment, data store(s) 1616 may be large enough in capacity to store multiple instances of neural networks for redundancy and safety. In at least one embodiment, data store(s) 1616 may comprise L2 or L3 cache(s).

In at least one embodiment, one or more of SoC(s) 1604 may include any number of processor(s) 1610 (e.g., embedded processors). In at least one embodiment, processor(s) 1610 may include a boot and power management processor that may be a dedicated processor and subsystem to handle boot power and management functions and related security enforcement. In at least one embodiment, a boot and power management processor may be a part of a boot sequence of SoC(s) 1604 and may provide runtime power management services. In at least one embodiment, a boot power and management processor may provide clock and voltage programming, assistance in system low power state transitions, management of SoC(s) 1604 thermals and temperature sensors, and/or management of SoC(s) 1604 power states. In at least one embodiment, each temperature sensor may be implemented as a ring-oscillator whose output frequency is proportional to temperature, and SoC(s) 1604 may use ring-oscillators to detect temperatures of CPU(s) 1606, GPU(s) 1608, and/or accelerator(s) 1614. In at least one embodiment, if temperatures are determined to exceed a threshold, then a boot and power management processor may enter a temperature fault routine and put SoC(s) 1604 into a lower power state and/or put vehicle 1600 into a chauffeur to safe stop mode (e.g., bring vehicle 1600 to a safe stop).

In at least one embodiment, processor(s) 1610 may further include a set of embedded processors that may serve as an audio processing engine which may be an audio subsystem that enables full hardware support for multi-channel audio over multiple interfaces, and a broad and flexible range of audio I/O interfaces. In at least one embodiment, an audio processing engine is a dedicated processor core with a digital signal processor with dedicated RAM.

In at least one embodiment, processor(s) 1610 may further include an alwayson processor engine that may provide necessary hardware features to support low power sensor management and wake use cases. In at least one embodiment, an alwayson processor engine may include, without limitation, a processor core, a tightly coupled RAM, supporting peripherals (e.g., timers and interrupt controllers), various I/O controller peripherals, and routing logic.

In at least one embodiment, processor(s) 1610 may further include a safety cluster engine that includes, without limitation, a dedicated processor subsystem to handle safety management for automotive applications. In at least one embodiment, a safety cluster engine may include, without limitation, two or more processor cores, a tightly coupled RAM, support peripherals (e.g., timers, an interrupt controller, etc.), and/or routing logic. In a safety mode, two or more cores may operate, in at least one embodiment, in a lockstep mode and function as a single core with comparison logic to detect any differences between their operations. In at least one embodiment, processor(s) 1610 may further include a real-time camera engine that may include, without limitation, a dedicated processor subsystem for handling real-time camera management. In at least one embodiment, processor(s) 1610 may further include a high-dynamic range signal processor that may include, without limitation, an image signal processor that is a hardware engine that is part of a camera processing pipeline.

In at least one embodiment, processor(s) 1610 may include a video image compositor that may be a processing block (e.g., implemented on a microprocessor) that implements video post-processing functions needed by a video playback application to produce a final image for a player window. In at least one embodiment, a video image compositor may perform lens distortion correction on wide-view camera(s) 1670, surround camera(s) 1674, and/or on in-cabin monitoring camera sensor(s). In at least one embodiment, in-cabin monitoring camera sensor(s) are preferably monitored by a neural network running on another instance of SoC 1604, configured to identify in cabin events and respond accordingly. In at least one embodiment, an in-cabin system may perform, without limitation, lip reading to activate cellular service and place a phone call, dictate emails, change a vehicle's destination, activate or change a vehicle's infotainment system and settings, or provide voice-activated web surfing. In at least one embodiment, certain functions are available to a driver when a vehicle is operating in an autonomous mode and are disabled otherwise.

In at least one embodiment, a video image compositor may include enhanced temporal noise reduction for both spatial and temporal noise reduction. For example, in at least one embodiment, where motion occurs in a video, noise reduction weights spatial information appropriately, decreasing weights of information provided by adjacent frames. In at least one embodiment, where an image or portion of an image does not include motion, temporal noise reduction performed by video image compositor may use information from a previous image to reduce noise in a current image.

In at least one embodiment, a video image compositor may also be configured to perform stereo rectification on input stereo lens frames. In at least one embodiment, a video image compositor may further be used for user interface composition when an operating system desktop is in use, and GPU(s) 1608 are not required to continuously render new surfaces. In at least one embodiment, when GPU(s) 1608 are powered on and active doing 3D rendering, a video image compositor may be used to offload GPU(s) 1608 to improve performance and responsiveness.

In at least one embodiment, one or more SoC of SoC(s) 1604 may further include a mobile industry processor interface (“MIPI”) camera serial interface for receiving video and input from cameras, a high-speed interface, and/or a video input block that may be used for a camera and related pixel input functions. In at least one embodiment, one or more of SoC(s) 1604 may further include an input/output controller(s) that may be controlled by software and may be used for receiving I/O signals that are uncommitted to a specific role.

In at least one embodiment, one or more Soc of SoC(s) 1604 may further include a broad range of peripheral interfaces to enable communication with peripherals, audio encoders/decoders (“codecs”), power management, and/or other devices. In at least one embodiment, SoC(s) 1604 may be used to process data from cameras (e.g., connected over Gigabit Multimedia Serial Link and Ethernet channels), sensors (e.g., LIDAR sensor(s) 1664, RADAR sensor(s) 1660, etc. that may be connected over Ethernet channels), data from bus 1602 (e.g., speed of vehicle 1600, steering wheel position, etc.), data from GNSS sensor(s) 1658 (e.g., connected over a Ethernet bus or a CAN bus), etc. In at least one embodiment, one or more SoC of SoC(s) 1604 may further include dedicated high-performance mass storage controllers that may include their own DMA engines, and that may be used to free CPU(s) 1606 from routine data management tasks.

In at least one embodiment, SoC(s) 1604 may be an end-to-end platform with a flexible architecture that spans automation Levels 3-5, thereby providing a comprehensive functional safety architecture that leverages and makes efficient use of computer vision and ADAS techniques for diversity and redundancy, and provides a platform for a flexible, reliable driving software stack, along with deep learning tools. In at least one embodiment, SoC(s) 1604 may be faster, more reliable, and even more energy-efficient and space-efficient than conventional systems. For example, in at least one embodiment, accelerator(s) 1614, when combined with CPU(s) 1606, GPU(s) 1608, and data store(s) 1616, may provide for a fast, efficient platform for Level 3-5 autonomous vehicles.

In at least one embodiment, computer vision algorithms may be executed on CPUs, which may be configured using a high-level programming language, such as C, to execute a wide variety of processing algorithms across a wide variety of visual data. However, in at least one embodiment, CPUs are oftentimes unable to meet performance requirements of many computer vision applications, such as those related to execution time and power consumption, for example.

In at least one embodiment, many CPUs are unable to execute complex object detection algorithms in real-time, which is used in in-vehicle ADAS applications and in practical Level 3-5 autonomous vehicles.

Embodiments described herein allow for multiple neural networks to be performed simultaneously and/or sequentially, and for results to be combined together to enable Level 3-5 autonomous driving functionality. For example, in at least one embodiment, a CNN executing on a DLA or a discrete GPU (e.g., GPU(s) 1620) may include text and word recognition, allowing reading and understanding of traffic signs, including signs for which a neural network has not been specifically trained. In at least one embodiment, a DLA may further include a neural network that is able to identify, interpret, and provide semantic understanding of a sign, and to pass that semantic understanding to path planning modules running on a CPU Complex.

In at least one embodiment, multiple neural networks may be run simultaneously, as for Level 3, 4, or 5 driving. For example, in at least one embodiment, a warning sign stating “Caution: flashing lights indicate icy conditions,” along with an electric light, may be independently or collectively interpreted by several neural networks. In at least one embodiment, such warning sign itself may be identified as a traffic sign by a first deployed neural network (e.g., a neural network that has been trained), text “flashing lights indicate icy conditions” may be interpreted by a second deployed neural network, which informs a vehicle's path planning software (preferably executing on a CPU Complex) that when flashing lights are detected, icy conditions exist. In at least one embodiment, a flashing light may be identified by operating a third deployed neural network over multiple frames, informing a vehicle's path-planning software of a presence (or an absence) of flashing lights. In at least one embodiment, all three neural networks may run simultaneously, such as within a DLA and/or on GPU(s) 1608.

In at least one embodiment, a CNN for facial recognition and vehicle owner identification may use data from camera sensors to identify presence of an authorized driver and/or owner of vehicle 1600. In at least one embodiment, an always on sensor processing engine may be used to unlock a vehicle when an owner approaches a driver door and turns on lights, and, in a security mode, to disable such vehicle when an owner leaves such vehicle. In this way, SoC(s) 1604 provide for security against theft and/or carjacking.

In at least one embodiment, a CNN for emergency vehicle detection and identification may use data from microphones 1696 to detect and identify emergency vehicle sirens. In at least one embodiment, SoC(s) 1604 use a CNN for classifying environmental and urban sounds, as well as classifying visual data. In at least one embodiment, a CNN running on a DLA is trained to identify a relative closing speed of an emergency vehicle (e.g., by using a Doppler effect). In at least one embodiment, a CNN may also be trained to identify emergency vehicles specific to a local area in which a vehicle is operating, as identified by GNSS sensor(s) 1658. In at least one embodiment, when operating in Europe, a CNN will seek to detect European sirens, and when in North America, a CNN will seek to identify only North American sirens. In at least one embodiment, once an emergency vehicle is detected, a control program may be used to execute an emergency vehicle safety routine, slowing a vehicle, pulling over to a side of a road, parking a vehicle, and/or idling a vehicle, with assistance of ultrasonic sensor(s) 1662, until emergency vehicles pass.

In at least one embodiment, vehicle 1600 may include CPU(s) 1618 (e.g., discrete CPU(s), or dCPU(s)), that may be coupled to SoC(s) 1604 via a high-speed interconnect (e.g., PCIe). In at least one embodiment, CPU(s) 1618 may include an X86 processor, for example.

CPU(s) 1618 may be used to perform any of a variety of functions, including arbitrating potentially inconsistent results between ADAS sensors and SoC(s) 1604, and/or monitoring status and health of controller(s) 1636 and/or an infotainment system on a chip (“infotainment SoC”) 1630, for example. In at least one embodiment, SoC(s) 1604 includes one or more interconnects, and an interconnect can include a peripheral component interconnect express (PCIe).

In at least one embodiment, vehicle 1600 may include GPU(s) 1620 (e.g., discrete GPU(s), or dGPU(s)), that may be coupled to SoC(s) 1604 via a high-speed interconnect (e.g., NVIDIA's NVLINK channel). In at least one embodiment, GPU(s) 1620 may provide additional artificial intelligence functionality, such as by executing redundant and/or different neural networks, and may be used to train and/or update neural networks based at least in part on input (e.g., sensor data) from sensors of a vehicle 1600.

In at least one embodiment, vehicle 1600 may further include network interface 1624 which may include, without limitation, wireless antenna(s) 1626 (e.g., one or more wireless antennas for different communication protocols, such as a cellular antenna, a Bluetooth antenna, etc.). In at least one embodiment, network interface 1624 may be used to enable wireless connectivity to Internet cloud services (e.g., with server(s) and/or other network devices), with other vehicles, and/or with computing devices (e.g., client devices of passengers). In at least one embodiment, to communicate with other vehicles, a direct link may be established between vehicle 160 and another vehicle and/or an indirect link may be established (e.g., across networks and over the Internet). In at least one embodiment, direct links may be provided using a vehicle-to-vehicle communication link. In at least one embodiment, a vehicle-to-vehicle communication link may provide vehicle 1600 information about vehicles in proximity to vehicle 1600 (e.g., vehicles in front of, on a side of, and/or behind vehicle 1600). In at least one embodiment, such aforementioned functionality may be part of a cooperative adaptive cruise control functionality of vehicle 1600.

In at least one embodiment, network interface 1624 may include an SoC that provides modulation and demodulation functionality and enables controller(s) 1636 to communicate over wireless networks. In at least one embodiment, network interface 1624 may include a radio frequency front-end for up-conversion from baseband to radio frequency, and down conversion from radio frequency to baseband. In at least one embodiment, frequency conversions may be performed in any technically feasible fashion. For example, frequency conversions could be performed through well-known processes, and/or using super-heterodyne processes. In at least one embodiment, radio frequency front end functionality may be provided by a separate chip. In at least one embodiment, network interfaces may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

In at least one embodiment, vehicle 1600 may further include data store(s) 1628 which may include, without limitation, off-chip (e.g., off SoC(s) 1604) storage. In at least one embodiment, data store(s) 1628 may include, without limitation, one or more storage elements including RAM, SRAM, dynamic random-access memory (“DRAM”), video random-access memory (“VRAM”), flash memory, hard disks, and/or other components and/or devices that may store at least one bit of data.

In at least one embodiment, vehicle 1600 may further include GNSS sensor(s) 1658 (e.g., GPS and/or assisted GPS sensors), to assist in mapping, perception, occupancy grid generation, and/or path planning functions. In at least one embodiment, any number of GNSS sensor(s) 1658 may be used, including, for example and without limitation, a GPS using a USB connector with an Ethernet-to-Serial (e.g., RS-232) bridge.

In at least one embodiment, vehicle 1600 may further include RADAR sensor(s) 1660.

In at least one embodiment, RADAR sensor(s) 1660 may be used by vehicle 1600 for long-range vehicle detection, even in darkness and/or severe weather conditions. In at least one embodiment, RADAR functional safety levels may be ASIL B. In at least one embodiment, RADAR sensor(s) 1660 may use a CAN bus and/or bus 1602 (e.g., to transmit data generated by RADAR sensor(s) 1660) for control and to access object tracking data, with access to Ethernet channels to access raw data in some examples. In at least one embodiment, a wide variety of RADAR sensor types may be used. For example, and without limitation, RADAR sensor(s) 1660 may be suitable for front, rear, and side RADAR use. In at least one embodiment, one or more sensor of RADAR sensors(s) 1660 is a Pulse Doppler RADAR sensor.

In at least one embodiment, RADAR sensor(s) 1660 may include different configurations, such as long-range with narrow field of view, short-range with wide field of view, short-range side coverage, etc. In at least one embodiment, long-range RADAR may be used for adaptive cruise control functionality. In at least one embodiment, long-range RADAR systems may provide a broad field of view realized by two or more independent scans, such as within a 250 m (meter) range. In at least one embodiment, RADAR sensor(s) 1660 may help in distinguishing between static and moving objects, and may be used by ADAS system 1638 for emergency brake assist and forward collision warning. In at least one embodiment, sensors 1660(s) included in a long-range RADAR system may include, without limitation, monostatic multimodal RADAR with multiple (e.g., six or more) fixed RADAR antennae and a high-speed CAN and FlexRay interface. In at least one embodiment, with six antennae, a central four antennae may create a focused beam pattern, designed to record vehicle's 1600 surroundings at higher speeds with minimal interference from traffic in adjacent lanes. In at least one embodiment, another two antennae may expand field of view, making it possible to quickly detect vehicles entering or leaving a lane of vehicle 1600.

In at least one embodiment, mid-range RADAR systems may include, as an example, a range of up to 160 m (front) or 80 m (rear), and a field of view of up to 42 degrees (front) or 150 degrees (rear). In at least one embodiment, short-range RADAR systems may include, without limitation, any number of RADAR sensor(s) 1660 designed to be installed at both ends of a rear bumper. When installed at both ends of a rear bumper, in at least one embodiment, a RADAR sensor system may create two beams that constantly monitor blind spots in a rear direction and next to a vehicle. In at least one embodiment, short-range RADAR systems may be used in ADAS system 1638 for blind spot detection and/or lane change assist.

In at least one embodiment, vehicle 1600 may further include ultrasonic sensor(s) 1662. In at least one embodiment, ultrasonic sensor(s) 1662, which may be positioned at a front, a back, and/or side location of vehicle 1600, may be used for parking assist and/or to create and update an occupancy grid. In at least one embodiment, a wide variety of ultrasonic sensor(s) 1662 may be used, and different ultrasonic sensor(s) 1662 may be used for different ranges of detection (e.g., 2.5 m, 4 m). In at least one embodiment, ultrasonic sensor(s) 1662 may operate at functional safety levels of ASIL B.

In at least one embodiment, vehicle 1600 may include LIDAR sensor(s) 1664. In at least one embodiment, LIDAR sensor(s) 1664 may be used for object and pedestrian detection, emergency braking, collision avoidance, and/or other functions. In at least one embodiment, LIDAR sensor(s) 1664 may operate at functional safety level ASIL B. In at least one embodiment, vehicle 1600 may include multiple LIDAR sensors 1664 (e.g., two, four, six, etc.) that may use an Ethernet channel (e.g., to provide data to a Gigabit Ethernet switch).

In at least one embodiment, LIDAR sensor(s) 1664 may be capable of providing a list of objects and their distances for a 360-degree field of view. In at least one embodiment, commercially available LIDAR sensor(s) 1664 may have an advertised range of approximately 100 m, with an accuracy of 2 cm to 3 cm, and with support for a 100 Mbps Ethernet connection, for example. In at least one embodiment, one or more non-protruding LIDAR sensors may be used. In such an embodiment, LIDAR sensor(s) 1664 may include a small device that may be embedded into a front, a rear, a side, and/or a corner location of vehicle 1600. In at least one embodiment, LIDAR sensor(s) 1664, in such an embodiment, may provide up to a 120-degree horizontal and 35-degree vertical field-of-view, with a 200 m range even for low-reflectivity objects. In at least one embodiment, front-mounted LIDAR sensor(s) 1664 may be configured for a horizontal field of view between 45 degrees and 135 degrees.

In at least one embodiment, LIDAR technologies, such as 3D flash LIDAR, may also be used. In at least one embodiment, 3D flash LIDAR uses a flash of a laser as a transmission source, to illuminate surroundings of vehicle 1600 up to approximately 200 m. In at least one embodiment, a flash LIDAR unit includes, without limitation, a receptor, which records laser pulse transit time and reflected light on each pixel, which in turn corresponds to a range from vehicle 1600 to objects. In at least one embodiment, flash LIDAR may allow for highly accurate and distortion-free images of surroundings to be generated with every laser flash. In at least one embodiment, four flash LIDAR sensors may be deployed, one at each side of vehicle 1600. In at least one embodiment, 3D flash LIDAR systems include, without limitation, a solid-state 3D staring array LIDAR camera with no moving parts other than a fan (e.g., a non-scanning LIDAR device). In at least one embodiment, flash LIDAR device may use a 5 nanosecond class I (eye-safe) laser pulse per frame and may capture reflected laser light as a 3D range point cloud and co-registered intensity data.

In at least one embodiment, vehicle 1600 may further include IMU sensor(s) 1666. In at least one embodiment, IMU sensor(s) 1666 may be located at a center of a rear axle of vehicle 1600. In at least one embodiment, IMU sensor(s) 1666 may include, for example and without limitation, accelerometer(s), magnetometer(s), gyroscope(s), a magnetic compass, magnetic compasses, and/or other sensor types. In at least one embodiment, such as in six-axis applications, IMU sensor(s) 1666 may include, without limitation, accelerometers and gyroscopes. In at least one embodiment, such as in nine-axis applications, IMU sensor(s) 1666 may include, without limitation, accelerometers, gyroscopes, and magnetometers.

In at least one embodiment, IMU sensor(s) 1666 may be implemented as a miniature, high performance GPS-Aided Inertial Navigation System (“GPS/INS”) that combines micro-electro-mechanical systems (“MEMS”) inertial sensors, a high-sensitivity GPS receiver, and advanced Kalman filtering algorithms to provide estimates of position, velocity, and attitude. In at least one embodiment, IMU sensor(s) 1666 may enable vehicle 1600 to estimate its heading without requiring input from a magnetic sensor by directly observing and correlating changes in velocity from a GPS to IMU sensor(s) 1666. In at least one embodiment, IMU sensor(s) 1666 and GNSS sensor(s) 1658 may be combined in a single integrated unit.

In at least one embodiment, vehicle 1600 may include microphone(s) 1696 placed in and/or around vehicle 1600. In at least one embodiment, microphone(s) 1696 may be used for emergency vehicle detection and identification, among other things.

In at least one embodiment, vehicle 1600 may further include any number of camera types, including stereo camera(s) 1668, wide-view camera(s) 1670, infrared camera(s) 1672, surround camera(s) 1674, long-range camera(s) 1698, mid-range camera(s) 1676, and/or other camera types. In at least one embodiment, cameras may be used to capture image data around an entire periphery of vehicle 1600. In at least one embodiment, which types of cameras used depends on vehicle 1600. In at least one embodiment, any combination of camera types may be used to provide necessary coverage around vehicle 1600. In at least one embodiment, a number of cameras deployed may differ depending on embodiment. For example, in at least one embodiment, vehicle 1600 could include six cameras, seven cameras, ten cameras, twelve cameras, or another number of cameras. In at least one embodiment, cameras may support, as an example and without limitation, Gigabit Multimedia Serial Link (“GMSL”) and/or Gigabit Ethernet communications. In at least one embodiment, each camera might be as described with more detail previously herein with respect to FIG. 16A and FIG. 16B.

In at least one embodiment, vehicle 1600 may further include vibration sensor(s) 1642. In at least one embodiment, vibration sensor(s) 1642 may measure vibrations of components of vehicle 1600, such as axle(s). For example, in at least one embodiment, changes in vibrations may indicate a change in road surfaces. In at least one embodiment, when two or more vibration sensors 1642 are used, differences between vibrations may be used to determine friction or slippage of road surface (e.g., when a difference in vibration is between a power-driven axle and a freely rotating axle).

In at least one embodiment, vehicle 1600 may include ADAS system 1638. In at least one embodiment, ADAS system 1638 may include, without limitation, an SoC, in some examples. In at least one embodiment, ADAS system 1638 may include, without limitation, any number and combination of an autonomous/adaptive/automatic cruise control (“ACC”) system, a cooperative adaptive cruise control (“CACC”) system, a forward crash warning (“FCW”) system, an automatic emergency braking (“AEB”) system, a lane departure warning (“LDW)” system, a lane keep assist (“LKA”) system, a blind spot warning (“BSW”) system, a rear cross-traffic warning (“RCTW”) system, a collision warning (“CW”) system, a lane centering (“LC”) system, and/or other systems, features, and/or functionality.

In at least one embodiment, ACC system may use RADAR sensor(s) 1660, LIDAR sensor(s) 1664, and/or any number of camera(s). In at least one embodiment, ACC system may include a longitudinal ACC system and/or a lateral ACC system. In at least one embodiment, a longitudinal ACC system monitors and controls distance to another vehicle immediately ahead of vehicle 1600 and automatically adjusts speed of vehicle 1600 to maintain a safe distance from vehicles ahead. In at least one embodiment, a lateral ACC system performs distance keeping, and advises vehicle 1600 to change lanes when necessary. In at least one embodiment, a lateral ACC is related to other ADAS applications, such as LC and CW.

In at least one embodiment, a CACC system uses information from other vehicles that may be received via network interface 1624 and/or wireless antenna(s) 1626 from other vehicles via a wireless link, or indirectly, over a network connection (e.g., over the Internet). In at least one embodiment, direct links may be provided by a vehicle-to-vehicle (“V2V”) communication link, while indirect links may be provided by an infrastructure-to-vehicle (“12V”) communication link. In general, V2V communication provides information about immediately preceding vehicles (e.g., vehicles immediately ahead of and in same lane as vehicle 1600), while I2V communication provides information about traffic further ahead. In at least one embodiment, a CACC system may include either or both I2V and V2V information sources. In at least one embodiment, given information of vehicles ahead of vehicle 1600, a CACC system may be more reliable and it has potential to improve traffic flow smoothness and reduce congestion on road.

In at least one embodiment, an FCW system is designed to alert a driver to a hazard, so that such driver may take corrective action. In at least one embodiment, an FCW system uses a front-facing camera and/or RADAR sensor(s) 1660, coupled to a dedicated processor, DSP, FPGA, and/or ASIC, that is electrically coupled to provide driver feedback, such as a display, speaker, and/or vibrating component. In at least one embodiment, an FCW system may provide a warning, such as in form of a sound, visual warning, vibration and/or a quick brake pulse.

In at least one embodiment, an AEB system detects an impending forward collision with another vehicle or other object, and may automatically apply brakes if a driver does not take corrective action within a specified time or distance parameter. In at least one embodiment, AEB system may use front-facing camera(s) and/or RADAR sensor(s) 1660, coupled to a dedicated processor, DSP, FPGA, and/or ASIC. In at least one embodiment, when an AEB system detects a hazard, it will typically first alert a driver to take corrective action to avoid collision and, if that driver does not take corrective action, that AEB system may automatically apply brakes in an effort to prevent, or at least mitigate, an impact of a predicted collision. In at least one embodiment, an AEB system may include techniques such as dynamic brake support and/or crash imminent braking.

In at least one embodiment, an LDW system provides visual, audible, and/or tactile warnings, such as steering wheel or seat vibrations, to alert driver when vehicle 1600 crosses lane markings. In at least one embodiment, an LDW system does not activate when a driver indicates an intentional lane departure, such as by activating a turn signal. In at least one embodiment, an LDW system may use front-side facing cameras, coupled to a dedicated processor, DSP, FPGA, and/or ASIC, that is electrically coupled to provide driver feedback, such as a display, speaker, and/or vibrating component. In at least one embodiment, an LKA system is a variation of an LDW system. In at least one embodiment, an LKA system provides steering input or braking to correct vehicle 1600 if vehicle 1600 starts to exit its lane.

In at least one embodiment, a BSW system detects and warns a driver of vehicles in an automobile's blind spot. In at least one embodiment, a BSW system may provide a visual, audible, and/or tactile alert to indicate that merging or changing lanes is unsafe. In at least one embodiment, a BSW system may provide an additional warning when a driver uses a turn signal. In at least one embodiment, a BSW system may use rear-side facing camera(s) and/or RADAR sensor(s) 1660, coupled to a dedicated processor, DSP, FPGA, and/or ASIC, that is electrically coupled to driver feedback, such as a display, speaker, and/or vibrating component.

In at least one embodiment, an RCTW system may provide visual, audible, and/or tactile notification when an object is detected outside a rear-camera range when vehicle 1600 is backing up. In at least one embodiment, an RCTW system includes an AEB system to ensure that vehicle brakes are applied to avoid a crash. In at least one embodiment, an RCTW system may use one or more rear-facing RADAR sensor(s) 1660, coupled to a dedicated processor, DSP, FPGA, and/or ASIC, that is electrically coupled to provide driver feedback, such as a display, speaker, and/or vibrating component.

In at least one embodiment, conventional ADAS systems may be prone to false positive results which may be annoying and distracting to a driver, but typically are not catastrophic, because conventional ADAS systems alert a driver and allow that driver to decide whether a safety condition truly exists and act accordingly. In at least one embodiment, vehicle 1600 itself decides, in case of conflicting results, whether to heed result from a primary computer or a secondary computer (e.g., a first controller or a second controller of controllers 1636). For example, in at least one embodiment, ADAS system 1638 may be a backup and/or secondary computer for providing perception information to a backup computer rationality module. In at least one embodiment, a backup computer rationality monitor may run redundant diverse software on hardware components to detect faults in perception and dynamic driving tasks. In at least one embodiment, outputs from ADAS system 1638 may be provided to a supervisory MCU. In at least one embodiment, if outputs from a primary computer and outputs from a secondary computer conflict, a supervisory MCU determines how to reconcile conflict to ensure safe operation.

In at least one embodiment, a primary computer may be configured to provide a supervisory MCU with a confidence score, indicating that primary computer's confidence in a chosen result. In at least one embodiment, if that confidence score exceeds a threshold, that supervisory MCU may follow that primary computer's direction, regardless of whether that secondary computer provides a conflicting or inconsistent result. In at least one embodiment, where a confidence score does not meet a threshold, and where primary and secondary computers indicate different results (e.g., a conflict), a supervisory MCU may arbitrate between computers to determine an appropriate outcome.

In at least one embodiment, a supervisory MCU may be configured to run a neural network(s) that is trained and configured to determine, based at least in part on outputs from a primary computer and outputs from a secondary computer, conditions under which that secondary computer provides false alarms. In at least one embodiment, neural network(s) in a supervisory MCU may learn when a secondary computer's output may be trusted, and when it cannot. For example, in at least one embodiment, when that secondary computer is a RADAR-based FCW system, a neural network(s) in that supervisory MCU may learn when an FCW system is identifying metallic objects that are not, in fact, hazards, such as a drainage grate or manhole cover that triggers an alarm. In at least one embodiment, when a secondary computer is a camera-based LDW system, a neural network in a supervisory MCU may learn to override LDW when bicyclists or pedestrians are present and a lane departure is, in fact, a safest maneuver. In at least one embodiment, a supervisory MCU may include at least one of a DLA or a GPU suitable for running neural network(s) with associated memory. In at least one embodiment, a supervisory MCU may comprise and/or be included as a component of SoC(s) 1604.

In at least one embodiment, ADAS system 1638 may include a secondary computer that performs ADAS functionality using traditional rules of computer vision. In at least one embodiment, that secondary computer may use classic computer vision rules (if-then), and presence of a neural network(s) in a supervisory MCU may improve reliability, safety and performance. For example, in at least one embodiment, diverse implementation and intentional non-identity makes an overall system more fault-tolerant, especially to faults caused by software (or software-hardware interface) functionality. For example, in at least one embodiment, if there is a software bug or error in software running on a primary computer, and non-identical software code running on a secondary computer provides a consistent overall result, then a supervisory MCU may have greater confidence that an overall result is correct, and a bug in software or hardware on that primary computer is not causing a material error.

In at least one embodiment, an output of ADAS system 1638 may be fed into a primary computer's perception block and/or a primary computer's dynamic driving task block. For example, in at least one embodiment, if ADAS system 1638 indicates a forward crash warning due to an object immediately ahead, a perception block may use this information when identifying objects. In at least one embodiment, a secondary computer may have its own neural network that is trained and thus reduces a risk of false positives, as described herein.

In at least one embodiment, vehicle 1600 may further include infotainment SoC 1630 (e.g., an in-vehicle infotainment system (IVI)). Although illustrated and described as an SoC, infotainment system SoC 1630, in at least one embodiment, may not be an SoC, and may include, without limitation, two or more discrete components. In at least one embodiment, infotainment SoC 1630 may include, without limitation, a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, WiFi, etc.), and/or information services (e.g., navigation systems, rear-parking assistance, a radio data system, vehicle related information such as fuel level, total distance covered, brake fuel level, oil level, door open/close, air filter information, etc.) to vehicle 1600. For example, infotainment SoC 1630 could include radios, disk players, navigation systems, video players, USB and Bluetooth connectivity, carputers, in-car entertainment, WiFi, steering wheel audio controls, hands free voice control, a heads-up display (“HUD”), IHMI display 1634, a telematics device, a control panel (e.g., for controlling and/or interacting with various components, features, and/or systems), and/or other components. In at least one embodiment, infotainment SoC 1630 may further be used to provide information (e.g., visual and/or audible) to user(s) of vehicle 1600, such as information from ADAS system 1638, autonomous driving information such as planned vehicle maneuvers, trajectories, surrounding environment information (e.g., intersection information, vehicle information, road information, etc.), and/or other information.

In at least one embodiment, infotainment SoC 1630 may include any amount and type of GPU functionality. In at least one embodiment, infotainment SoC 1630 may communicate over bus 1602 with other devices, systems, and/or components of vehicle 1600. In at least one embodiment, infotainment SoC 1630 may be coupled to a supervisory MCU such that a GPU of an infotainment system may perform some self-driving functions in event that primary controller(s) 1636 (e.g., primary and/or backup computers of vehicle 1600) fail. In at least one embodiment, infotainment SoC 1630 may put vehicle 1600 into a chauffeur to safe stop mode, as described herein.

In at least one embodiment, vehicle 1600 may further include instrument cluster 1632 (e.g., a digital dash, an electronic instrument cluster, a digital instrument panel, etc.). In at least one embodiment, instrument cluster 1632 may include, without limitation, a controller and/or supercomputer (e.g., a discrete controller or supercomputer). In at least one embodiment, instrument cluster 1632 may include, without limitation, any number and combination of a set of instrumentation such as a speedometer, fuel level, oil pressure, tachometer, odometer, turn indicators, gearshift position indicator, seat belt warning light(s), parking-brake warning light(s), engine-malfunction light(s), supplemental restraint system (e.g., airbag) information, lighting controls, safety system controls, navigation information, etc. In some examples, information may be displayed and/or shared among infotainment SoC 1630 and instrument cluster 1632. In at least one embodiment, instrument cluster 1632 may be included as part of infotainment SoC 1630, or vice versa.

Inference and/or training logic 715 are used to perform inferencing and/or training operations associated with one or more embodiments. Details regarding inference and/or training logic 715 are provided herein in conjunction with FIGS. 7A and/or 7B. In at least one embodiment, inference and/or training logic 715 may be used in system FIG. 16C for inferencing or predicting operations based, at least in part, on weight parameters calculated using neural network training operations, neural network functions and/or architectures, or neural network use cases described herein.

Such components can be used to identify differences between local map data and live perception or observation data, and determine whether to update the local map data for at least the relevant region of a physical environment.

FIG. 16D is a diagram of a system for communication between cloud-based server(s) and autonomous vehicle 1600 of FIG. 16A, according to at least one embodiment. In at least one embodiment, system may include, without limitation, server(s) 1678, network(s) 1690, and any number and type of vehicles, including vehicle 1600. In at least one embodiment, server(s) 1678 may include, without limitation, a plurality of GPUs 1684(A)-1684(H) (collectively referred to herein as GPUs 1684), PCIe switches 1682(A)-1682(D) (collectively referred to herein as PCIe switches 1682), and/or CPUs 1680(A)-1680(B) (collectively referred to herein as CPUs 1680).

In at least one embodiment, GPUs 1684, CPUs 1680, and PCIe switches 1682 may be interconnected with high-speed interconnects such as, for example and without limitation, NVLink interfaces 1688 developed by NVIDIA and/or PCIe connections 1686. In at least one embodiment, GPUs 1684 are connected via an NVLink and/or NVSwitch SoC and GPUs 1684 and PCIe switches 1682 are connected via PCIe interconnects. Although eight GPUs 1684, two CPUs 1680, and four PCIe switches 1682 are illustrated, this is not intended to be limiting. In at least one embodiment, each of server(s) 1678 may include, without limitation, any number of GPUs 1684, CPUs 1680, and/or PCIe switches 1682, in any combination. For example, in at least one embodiment, server(s) 1678 could each include eight, sixteen, thirty-two, and/or more GPUs 1684.

In at least one embodiment, server(s) 1678 may receive, over network(s) 1690 and from vehicles, image data representative of images showing unexpected or changed road conditions, such as recently commenced road-work. In at least one embodiment, server(s) 1678 may transmit, over network(s) 1690 and to vehicles, neural networks 1692, updated or otherwise, and/or map information 1694, including, without limitation, information regarding traffic and road conditions. In at least one embodiment, updates to map information 1694 may include, without limitation, updates for HD map 1622, such as information regarding construction sites, potholes, detours, flooding, and/or other obstructions. In at least one embodiment, neural networks 1692, and/or map information 1694 may have resulted from new training and/or experiences represented in data received from any number of vehicles in an environment, and/or based at least in part on training performed at a data center (e.g., using server(s) 1678 and/or other servers).

In at least one embodiment, server(s) 1678 may be used to train machine learning models (e.g., neural networks) based at least in part on training data. In at least one embodiment, training data may be generated by vehicles, and/or may be generated in a simulation (e.g., using a game engine). In at least one embodiment, any amount of training data is tagged (e.g., where associated neural network benefits from supervised learning) and/or undergoes other pre-processing. In at least one embodiment, any amount of training data is not tagged and/or pre-processed (e.g., where associated neural network does not require supervised learning). In at least one embodiment, once machine learning models are trained, machine learning models may be used by vehicles (e.g., transmitted to vehicles over network(s) 1690), and/or machine learning models may be used by server(s) 1678 to remotely monitor vehicles.

In at least one embodiment, server(s) 1678 may receive data from vehicles and apply data to up-to-date real-time neural networks for real-time intelligent inferencing. In at least one embodiment, server(s) 1678 may include deep-learning supercomputers and/or dedicated Al computers powered by GPU(s) 1684, such as a DGX and DGX Station machines developed by NVIDIA. However, in at least one embodiment, server(s) 1678 may include deep learning infrastructure that uses CPU-powered data centers.

In at least one embodiment, deep-learning infrastructure of server(s) 1678 may be capable of fast, real-time inferencing, and may use that capability to evaluate and verify health of processors, software, and/or associated hardware in vehicle 1600. For example, in at least one embodiment, deep-learning infrastructure may receive periodic updates from vehicle 1600, such as a sequence of images and/or objects that vehicle 1600 has located in that sequence of images (e.g., via computer vision and/or other machine learning object classification techniques). In at least one embodiment, deep-learning infrastructure may run its own neural network to identify objects and compare them with objects identified by vehicle 1600 and, if results do not match and deep-learning infrastructure concludes that Al in vehicle 1600 is malfunctioning, then server(s) 1678 may transmit a signal to vehicle 1600 instructing a fail-safe computer of vehicle 1600 to assume control, notify passengers, and complete a safe parking maneuver.

In at least one embodiment, server(s) 1678 may include GPU(s) 1684 and one or more programmable inference accelerators (e.g., NVIDIA's TensorRT 3 devices). In at least one embodiment, a combination of GPU-powered servers and inference acceleration may make real-time responsiveness possible. In at least one embodiment, such as where performance is less critical, servers powered by CPUs, FPGAs, and other processors may be used for inferencing.

Various embodiments can be described by the following clauses:

1. A method, comprising:
obtaining a set of observations corresponding to a region of a physical environment; identifying local map data corresponding to the region;
generating, based at least on a trained language model processing data representative of the local map data and at least a subset of the set of observations, a tokenized description indicating one or more differences between the local map data and the set of observations; and
determining, based at least on the tokenized description, whether one or more updates are to be performed with respect to the local map data based on the one or more differences.

2. The method of clause 1, wherein the set of observations includes at least one of sensor data, captured using one or more sensors in the region, or perception data generated using at least the sensor data.

3. The method of clause 1, wherein the tokenized description is compared with additional tokenized descriptions received that correspond to the region in order to determine, with at least a minimum level of confidence, whether to perform the one or more updates with respect to the local map data.

4. The method of clause 1, wherein the tokenized description includes one or more text-based tokens specific to the one or more differences, the one or more text-based tokens including at least one of a type of difference, a delta indicating an extent of a difference, or a confidence value in a difference determination.

5. The method of clause 1, wherein the set of observations are determined using an ego machine operating in, or proximate to, the region of the physical environment, and wherein the trained language model is located on the ego machine, the ego machine to transmit the tokenized description across at least one network to a system to determine whether to perform the one or more updates.

6. The method of clause 1, wherein potential differences are analyzed for at least two levels of granularity, starting at a higher level of granularity.

7. The method of clause 1, wherein the tokenized description further includes one or more recommended changes to the map data.

8. The method of clause 1, further comprising:
receiving information for one or more updates to the local map data; and storing the updated map data for use in at least one of future operation or future difference determinations.

9. The method of clause 1, wherein the tokenized description is written in a road topology language (RTL) or other domain specific language (DSL).

10. The method of clause 1, wherein the tokenized description is determined based at least on at least one of semantic, topological, geometric, kinematic, or relational information of features in the set of observations.

11. A processor, including one or more logical units to:
generate a set of observations corresponding to a region of a physical environment;
identify local map data corresponding to the region; and
generate, based at least on a large language model (LLM) processing data corresponding to the local map data and at least a subset of the set of observations, a tokenized description indicating one or more differences identified between the local map data and the set of observations, wherein the tokenized description is used to determine whether to perform one or more updates to the local map data.

12. The processor of clause 11, wherein the set of observations includes at least one of sensor data, captured using one or more sensors in the region, or perception data generated using at least the sensor data.

13. The processor of clause 11, wherein the tokenized description is compared with additional tokenized descriptions received that correspond to the region in order to determine, with at least a minimum level of confidence, whether to perform the one or more updates with respect to the local map data.

14. The processor of clause 11, wherein the tokenized description includes one or more text-based tokens specific to the one or more differences, the one or more text-based tokens including at least one of a type of difference, a delta indicating an extent of a difference, or a confidence value in a difference determination.

15. The processor of clause 11, wherein the set of observations are determined on an ego machine operating in, or proximate to, the region of the physical environment, and wherein the LLM is located on the ego machine, the ego machine to transmit the tokenized description across at least one network to a system to determine whether to perform the one or more updates.

16. The processor of clause 11, wherein the processor is comprised in at least one of: a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative Al operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or
a system implemented at least partially using cloud computing resources.

17. A system comprising:
one or more processors to determine one or more updates to map data based at least on one or more differences between the map data and a set of observations for the region, the one or more differences being identified based at least on a language model processing the map data and data corresponding to the set of observations.

18. The system of clause 17, wherein the set of observations includes at least one of sensor data, captured using one or more sensors in the region, or perception data generated using at least the sensor data.

19. The system of clause 17, wherein the map data, the set of observations, and the one or more differences are represented in a domain specific language (DSL) corresponding to a mapping domain.

20. The system of clause 17, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative Al operations using a large language model (LLM); a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or a system implemented at least partially using cloud computing resources.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably as far as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although the discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method, comprising:
obtaining a set of observations corresponding to a region of a physical environment;
identifying local map data corresponding to the region;
generating, based at least on a trained language model processing data representative of the local map data and at least a subset of the set of observations, a tokenized description indicating one or more differences between the local map data and the set of observations; and
determining, based at least on the tokenized description, whether one or more updates are to be performed with respect to the local map data based on the one or more differences.

2. The method of claim 1, wherein the set of observations includes at least one of sensor data, captured using one or more sensors in the region, or perception data generated using at least the sensor data.

3. The method of claim 1, wherein the tokenized description is compared with additional tokenized descriptions received that correspond to the region in order to determine, with at least a minimum level of confidence, whether to perform the one or more updates with respect to the local map data.

4. The method of claim 1, wherein the tokenized description includes one or more text-based tokens specific to the one or more differences, the one or more text-based tokens including at least one of a type of difference, a delta indicating an extent of a difference, or a confidence value in a difference determination.

5. The method of claim 1, wherein the set of observations are determined using an ego machine operating in, or proximate to, the region of the physical environment, and wherein the trained language model is located on the ego machine, the ego machine to transmit the tokenized description across at least one network to a system to determine whether to perform the one or more updates.

6. The method of claim 1, wherein potential differences are analyzed for at least two levels of granularity, starting at a higher level of granularity.

7. The method of claim 1, wherein the tokenized description further includes one or more recommended changes to the map data.

8. The method of claim 1, further comprising:
receiving information for one or more updates to the local map data; and
storing the updated map data for use in at least one of future operation or future difference determinations.

9. The method of claim 1, wherein the tokenized description is written in a road topology language (RTL) or other domain specific language (DSL).

10. The method of claim 1, wherein the tokenized description is determined based at least on at least one of semantic, topological, geometric, kinematic, or relational information of features in the set of observations.

11. A processor, including one or more logical units to:
generate a set of observations corresponding to a region of a physical environment;
identify local map data corresponding to the region; and
generate, based at least on a large language model (LLM) processing data corresponding to the local map data and at least a subset of the set of observations, a tokenized description indicating one or more differences identified between the local map data and the set of observations, wherein the tokenized description is used to determine whether to perform one or more updates to the local map data.

12. The processor of claim 11, wherein the set of observations includes at least one of sensor data, captured using one or more sensors in the region, or perception data generated using at least the sensor data.

13. The processor of claim 11, wherein the tokenized description is compared with additional tokenized descriptions received that correspond to the region in order to determine, with at least a minimum level of confidence, whether to perform the one or more updates with respect to the local map data.

14. The processor of claim 11, wherein the tokenized description includes one or more text-based tokens specific to the one or more differences, the one or more text-based tokens including at least one of a type of difference, a delta indicating an extent of a difference, or a confidence value in a difference determination.

15. The processor of claim 11, wherein the set of observations are determined on an ego machine operating in, or proximate to, the region of the physical environment, and wherein the LLM is located on the ego machine, the ego machine to transmit the tokenized description across at least one network to a system to determine whether to perform the one or more updates.

16. The processor of claim 11, wherein the processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative Al operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or
a system implemented at least partially using cloud computing resources.

17. A system comprising:
one or more processors to determine one or more updates to map data based at least on one or more differences between the map data and a set of observations for the region, the one or more differences being identified based at least on a language model processing the map data and data corresponding to the set of observations.

18. The system of claim 17, wherein the set of observations includes at least one of sensor data, captured using one or more sensors in the region, or perception data generated using at least the sensor data.

19. The system of claim 17, wherein the map data, the set of observations, and the one or more differences are represented in a domain specific language (DSL) corresponding to a mapping domain.

20. The system of claim 17, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative Al operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or
a system implemented at least partially using cloud computing resources.
